(19) United States
(12) Patent Application Publication
(10) Pub. No.: US 2015/0181546 A1
(43) Pub. Date: Jun. 25, 2015

(54) METHODS AND APPARATUS FOR FREQUENCY SYNCHRONIZATION, POWER CONTROL, AND CELL CONFIGURATION FOR UL-ONLY OPERATION IN DSS BANDS

(71) Applicant: INTERDIGITAL PATENT HOLDINGS, INC., Wilmington, DE (US)

(72) Inventors: Martino Freda, Laval (CA); Jean-Louis Gauvreau, La Prairie (CA); Scott Laughlin, Montreal (CA); Rocco Di Girolamo, Laval (CA); Athmane Touag, Laval (CA); Alexander Reznik, Titusville, NJ (US); Ghyslain Pelletier, Laval (CA); Benoit Pelletier, Roxboro (CA)

(21) Appl. No.: 14/414,907

(22) PCT Filed: Jul. 17, 2013
(86) PCT No.: PCT/US2013/050855

§ 371 Date: Jan. 15, 2015

Related U.S. Application Data
(60) Provisional application No. 61/828,484, filed on May 29, 2013.
(60) Provisional application No. 61/674,653, filed on Jul. 23, 2012.

(51) Int. Cl. H04W 56/00; H04W 72/04; H04W 16/14; H04W 74/08

(52) U.S. Cl. CPC H04W 56/0005; H04W 74/0833; H04W 72/042; H04W 16/14

(57) ABSTRACT

Methods and apparatus for effecting power control as well as frequency and timing synchronization in an LTE component carrier functioning in UL-only mode or device-to-device mode, including a UL-only cell in LTE, as well as an new enabling Special Uplink Reference Signal (SURS) that is used to determine the UEs that can take advantage of a UL-only cell. One approach includes interrupting the UL-only operation in a periodic fashion to send a sync signal by the eNB. Another approach includes sending a well know synchronization sequence by the UEs in a periodic fashion, which the eNB compares with its own local frequency reference and sends feedback to the UE to readjust the frequency. Another approach uses dedicated subcarriers where the eNB can send synchronization symbols on the same channel and simultaneously with data being transmitted in the uplink. The UEs transmitting in the UL direction are equipped to receive simultaneously the synchronization symbols on these dedicated subcarriers.

### RELATED APPLICATIONS

This application is a non-provisional of U.S. Provisional Patent Application No. 61/674,653 filed Jul. 23, 2012 and U.S. Provisional Patent Application No. 61/828,484 filed May 29, 2013, both of which are incorporated herein fully by reference.

### FIELD OF THE INVENTION

The field of this invention is LTE (Long Term Evolution) DSM (Dynamic Spectrum Management). In particular, the invention presents methods for providing frequency and timing synchronization and power control in uplink-only cells.

### BACKGROUND

Some of the functions that commonly are performed when a cellular telephone or other device, hereinafter User Equipment (UE), is to be used on a wireless network include frequency and time synchronization of the device to the network. The network typically transmits to the device appropriate synchronization information that allows the device to synchronize to the network timing and frequency. In many wireless networks, including LTE-based networks, the base stations also transmit to the UEs power control information so that the UEs can configure themselves to transmit with an appropriate transmit power for the given situation. Typically, both the power control data and timing and frequency synchronization signals are transmitted to the UE on a wireless downlink channel of the wireless network.

However, in wireless networks utilizing uplink-only (UL-only) cells, the frequency and timing synchronization signals as well as the power control signals cannot be sent to the UEs deployed in a UL-only cell on a downlink channel of that cell because, by definition, there are no downlink (DL) channels in such a cell.

### SUMMARY

The present application pertains to methods and apparatus for implementing power control and synchronization in an LTE component carrier functioning in UL-only mode or device-to-device (D2D) mode, including a UL-only cell in LTE. In some embodiments, a new Special Uplink Reference Signal (SURS) is used to determine the UEs that can take advantage of a UL-only cell. One approach includes the eNB interrupting the UL-only operation in a periodic fashion to send a sync signal, which will be received and processed by the UE to initially acquire and maintain frequency synchronization. This feature may be enhanced by introducing periodic gaps after each sync signal.

Another approach includes establishing device-to-device (D2D) communications between first and second UEs in a wireless network entailing the base station determining to initiate D2D communications between the first UE and the second UE on an uplink-only channel; the base station transmitting on a duplex channel to each of the first and second UEs a configuration message informing the first and second UEs to each transmit to the base station a synchronization signal on the uplink-only channel; responsive to the configuration messages, each UE transmitting a synchronization signal to the base station on the uplink-only channel; the base station determining a frequency offset for each of the first and second UEs based on the respective UE's synchronization signal; the base station transmitting a frequency adjustment command to each of the first and second UEs in the duplex band; and, upon attaining synchronization, the first and second UEs commencing communication with each other on the uplink-only channel.

Another approach includes establishing D2D communications between first and second UEs in a wireless network, including: the base station determining to initiate D2D communications between the first UE and the second UE on an uplink-only channel; the base station transmitting on a duplex channel to the first UE a configuration message informing the first UE to transmit to the base station a synchronization signal on the uplink-only channel; responsive to the configuration message from the base station, the first UE transmitting a synchronization signal; responsive to receipt of the synchronization signal by the second UE, the second UE calculating a frequency offset and a timing offset relative to the first UE based on the synchronization signal transmitted by the first UE; the second UE transmitting a first adjustment signal indicating the calculated frequency offset and timing offset relative to the first UE; the base station receiving the first adjustment signal transmitted by the second UE; responsive to receipt of the first adjustment signal from the second UE, the base station transmitting to the first UE a second adjustment signal indicating the calculated frequency offset and timing offset received from the second UE in the first adjustment signal; and responsive to receipt of the second adjustment signal, the first UE adjusting its frequency and timing on the uplink-only channel.

Another approach includes establishing D2D communications between first and second UEs in a wireless network, including: the first UE transmitting a synchronization signal to the second UE; responsive to receipt of the synchronization signal from the first UE, the second UE, computing at least one of frequency offset information and timing offset information of the second UE relative to the first UE; and the second UE transmitting an adjustment signal to the first UE on the uplink-only channel, the adjustment signal comprising the frequency offset information and/or timing offset information.

In accordance with yet another aspect, a method of frequency synchronizing a UE to a network in an uplink-only cell involves a base station transmitting a frequency adjustment command to the UE in a grant used for uplink carriers comprising DCI format 0 or 4 including a Frequency Shift Control field ordering the UE to increase or decrease its operating frequency a fixed amount.

In accordance with yet another aspect, a method of frequency synchronizing a User Equipment (UE) to a network in an uplink-only cell involves a base station transmitting a frequency adjustment command to the UE in a Physical Downlink Control channel (PDCCH).

### BRIEF DESCRIPTION OF THE DRAWINGS

A more detailed understanding may be had from the following description, given by way of example in conjunction with the accompanying drawings, wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIGS. 1C, 1D, and 1E are system diagrams of example radio access networks and example core networks that may be used within the communications system illustrated in FIG. 1A;

FIGS. 2A, 2B, and 2C illustrate three frequency spectrum arrangements for carrier aggregation in LTE;

FIG. 3 is a timing diagram illustrating an LTE frame and the positions of synchronization signals according to LTE Release 10;

FIG. 4 is a signaling diagram illustrating a contention-based random access procedure in LTE used to connect a UE to a cell;

FIG. 5 is a signaling diagram illustrating a contention-free random access procedure in LTE used to connect a UE to a cell;

FIG. 6A is a block diagram illustrating an exemplary UL-only DSS traffic scenario for online backup;

FIG. 6B is a block diagram illustrating an exemplary UL-only DSS traffic scenario for cable replacement;

FIG. 6C illustrates D2D communication in LTE;

FIG. 7 is a block diagram illustrating exemplary UL-only Transmission for LTE Systems in the European Regulatory Context;

FIG. 8 is a block diagram illustrating exemplary UL-only Transmission for LTE Systems in the FCC Regulatory Context;

FIGS. 9A and 9B collectively comprise a signaling diagram illustrating information flow for UL-only establishment using SURS in accordance with a first embodiment;

FIG. 10 is a block diagram illustrating an exemplary scenario in which local interference exists between Wi-Fi and LTE;

FIG. 11 is a block diagram illustrating an exemplary scenario in which local interference exists between two LTE systems;

FIG. 12 is a combined block diagram and timing diagram illustrating a TDD UL-only cell in a DSS band and a corresponding TDD frame;

FIG. 13 is a diagram showing the composition of a SURS message in accordance with one embodiment;

FIG. 14 is a signaling diagram illustrating information flow for UL synchronization and feedback in a non-co-channel scenario in accordance with a second embodiment;

FIG. 15A is a diagram illustrating the event sequence for an embodiment for D2D operation in which the eNB serves as the synchronization reference;

FIG. 15B is a diagram illustrating the event sequence for an embodiment for D2D operation in which an eNB serves as a relay;

FIG. 15C is a diagram illustrating the event sequence for an embodiment for D2D operation in which a peer UE serves as a synchronization reference;

FIG. 16 is a timing diagram illustrating use of SRS symbols to send an uplink synchronization symbol using SRS in a non-co-channel scenario;

FIG. 17A is a signaling diagram illustrating information flow for UL synchronization and feedback using RACH in a non-co-channel scenario in accordance with one embodiment;

FIG. 17B is a signaling diagram illustrating information flow for UL timing synchronization and feedback using RACH in a non-co-channel scenario in accordance with another embodiment;

FIG. 18 is a signaling diagram illustrating information flow for UL frequency synchronization and feedback in accordance with an embodiment;

FIG. 19 is a timing diagram illustrating an exemplary synchronization schedule in a non-co-channel scenario with coexistence gaps in accordance with another embodiment;

FIG. 20 is a flow diagram illustrating operation for initial access of a UE to a uplink-only cell having no downlink transmission in the same band using only closed-loop operation in accordance with an embodiment;

FIG. 21 is a timing diagram illustrating frame structure achieving synchronization in an uplink-only cell permitting periodic downlink synchronization and having coexistence gaps;

FIG. 22 is a timing diagram illustrating frame structure achieving synchronization in an uplink-only cell permitting periodic downlink synchronization without coexistence gaps;

FIG. 23A is a timing diagram illustrating a synchronization signal for an uplink-only cell according to a first, slot-based embodiment;

FIG. 23B is a timing diagram illustrating a slot-based synchronization signal for an uplink-only cell according to a second, compressed embodiment;

FIG. 24 is a diagram illustrating the use of reserved subcarriers for sending reference and synchronization symbols in accordance with yet another embodiment.

### DETAILED DESCRIPTION

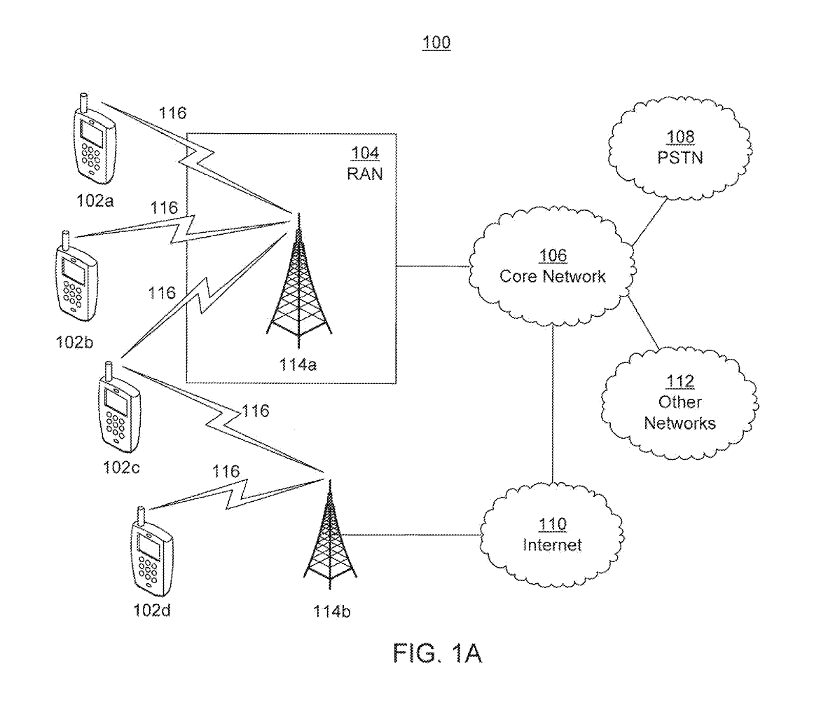

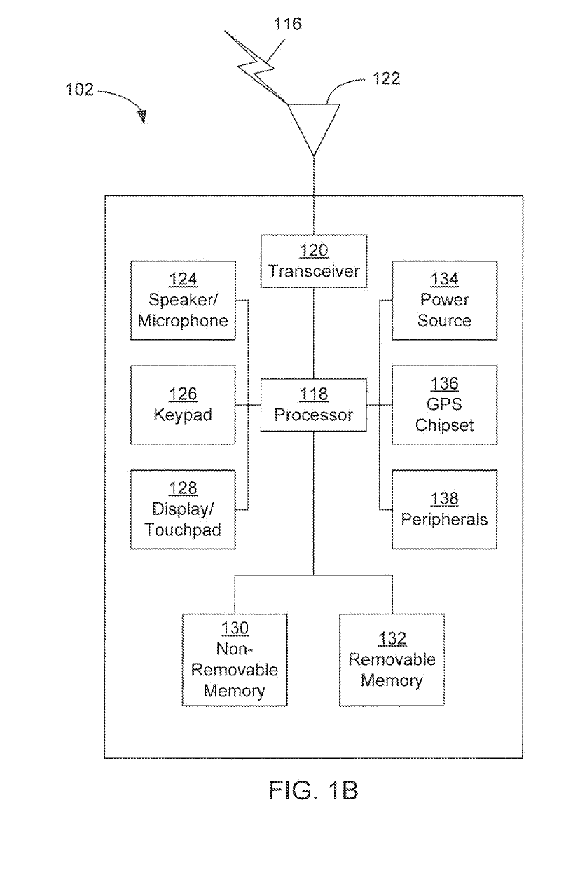

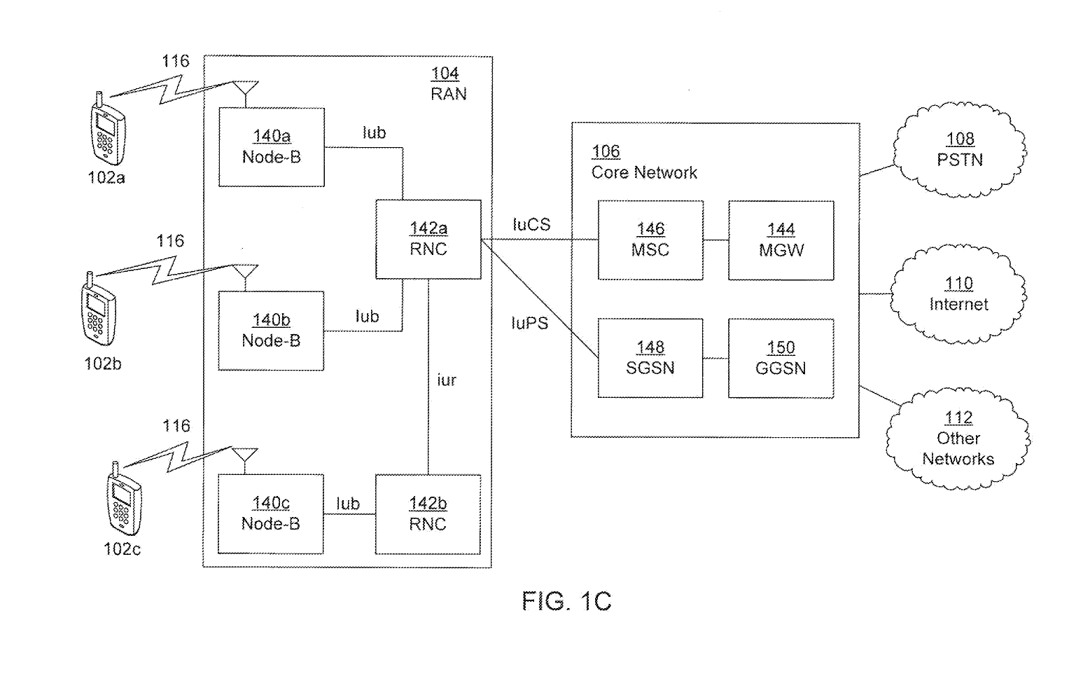

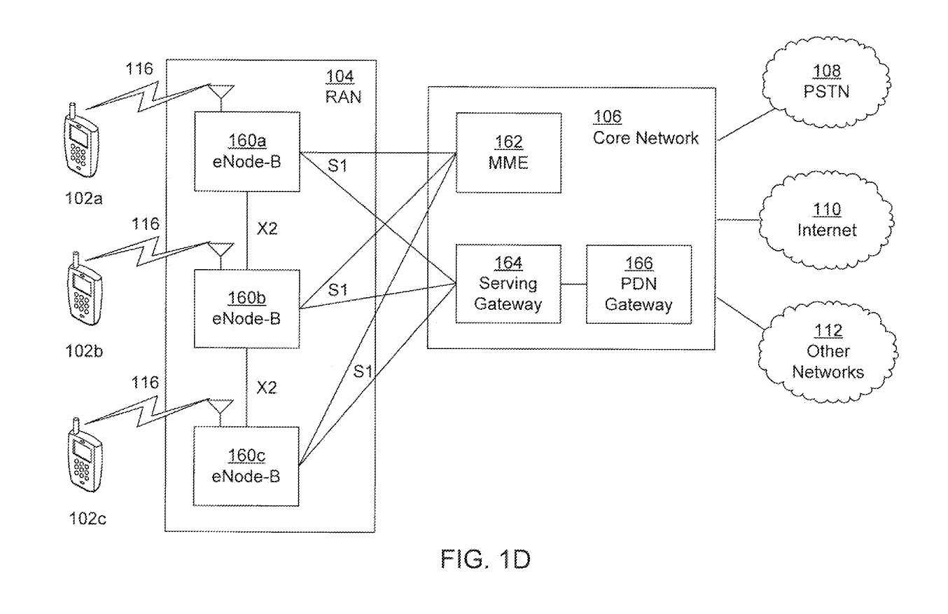

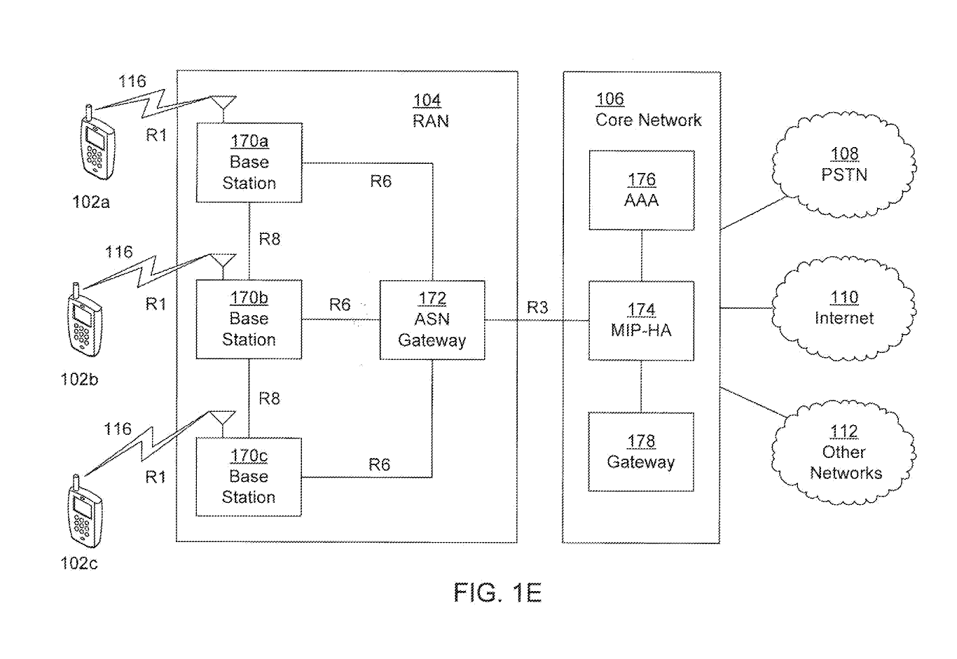

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality, and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ a UTRA radio technology to communicate with the WTRUs 102a, 102b, 102c over the air interface 116. The RAN 104 may also be in communication with the core network 106. As shown in FIG. 1C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. It will be appreciated that the RAN 104 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 106 according to another embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 106 shown in FIG. 1D may include a mobility management gateway (MME) 162, a serving gateway 164, and a packet data network (PDN) gateway 166. While each of the foregoing elements are depicted as part of the core network 106, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

FIG. 1E is a system diagram of the RAN 104 and the core network 106 according to another embodiment. The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 1E, the RAN 104 may include base stations 170a, 170b, 170c, and an ASN gateway 172, though it will be appreciated that the RAN 104 may include any number of base stations and ASN gateways while remaining consistent with an embodiment. The base stations 170a, 170b, 170c may each be associated with a particular cell (not shown) in the RAN 104 and may each include one or more transceivers for communicating with the WTRUs 102a, 102b, 102c over the air interface 116. In one embodiment, the base stations 170a, 170b, 170c may implement MIMO technology. Thus, the base station 170a, for example, may use multiple antennas to transmit wireless signals to, and receive wireless signals from, the WTRU 102a. The base stations 170a, 170b, 170c may also provide mobility management functions, such as handoff triggering, tunnel establishment, radio resource management, traffic classification, quality of service (QoS) policy enforcement, and the like. The ASN gateway 172 may serve as a traffic aggregation point and may be responsible for paging, caching of subscriber profiles, routing to the core network 106, and the like.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management.

The communication link between each of the base stations 170a, 170b, 170c may be defined as an R8 reference point that includes protocols for facilitating WTRU handovers and the transfer of data between base stations. The communication link between the base stations 170a, 170b, 170c and the ASN gateway 172 may be defined as an R6 reference point. The R6 reference point may include protocols for facilitating mobility management based on mobility events associated with each of the WTRUs 102a, 102b, 100c.

As shown in FIG. 1E, the RAN 104 may be connected to the core network 106. The communication link between the RAN 104 and the core network 106 may defined as an R3 reference point that includes protocols for facilitating data transfer and mobility management capabilities, for example. The core network 106 may include a mobile IP home agent (MIP-HA) 174, an authentication, authorization, accounting (AAA) server 176, and a gateway 178. While each of the foregoing elements are depicted as part of the core network 106, it will be appreciated that any one of these elements may be owned and/or operated by an entity other than the core network operator.

The MIP-HA 174 may be responsible for IP address management, and may enable the WTRUs 102a, 102b, 102c to roam between different ASNs and/or different core networks. The MIP-HA 174 may provide the WTRUs 102a, 102b, 102c with access to packet-switched networks, such as the Internet 110, to facilitate communications between the WTRUs 102a, 102b, 102c and IP-enabled devices. The AAA server 176 may be responsible for user authentication and for supporting user services. The gateway 178 may facilitate interworking with other networks. For example, the gateway 178 may provide the WTRUs 102a, 102b, 102c with access to circuit-switched networks, such as the PSTN 108, to facilitate communications between the WTRUs 102a, 102b, 102c and traditional land-line communications devices. In addition, the gateway 178 may provide the WTRUs 102a, 102b, 102c with access to the networks 112, which may include other wired or wireless networks that are owned and/or operated by other service providers.

Although not shown in FIG. 1E, it will be appreciated that the RAN 104 may be connected to other ASNs and the core network 106 may be connected to other core networks. The communication link between the RAN 104 the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

### 1. ADDITIONAL RELEVANT FEATURES OF LTE

1.1 Carrier Aggregation (CA) for LTE-Advanced

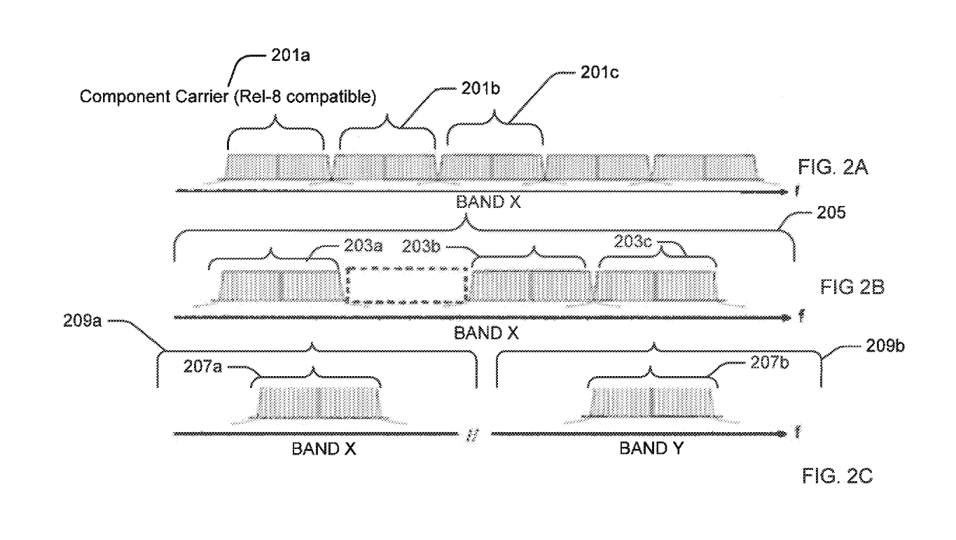

In LTE-Advanced, two or more (up to 5) component carriers (CCs) can be aggregated in order to support wider transmission bandwidths of up to 100 MHz. Depending on its capabilities, a UE can simultaneously receive or transmit on one or more CCs. It may also be capable of aggregating a different number of differently sized CCs in the uplink (UL) or the downlink (DL). CA is supported for both contiguous and non-contiguous CCs; 3GPP is considering three scenarios for standardization in LTE Release 10 as shown in FIGS. 2A, 2B, and 2C and described below.
a) Intra-band contiguous CA—multiple adjacent CCs, 201a, 201b, 201c are aggregated to produce contiguous bandwidth wider than 20 MHz as shown in FIG. 2A.
b) Intra-band non-contiguous CA—multiple CCs 203a, 203b, 203c that belong to the same band 205 (but are not adjacent to one another) are aggregated and used in a non-contiguous manner as shown in FIG. 2B.
c) Inter-band non-contiguous CA—multiple CC's 207a, 207b that belong to different bands 209a, 209b are aggregated as shown in FIG. 2C.

CA for LTE-A was first introduced in the Release 10 3GPP standards. It increases the data rate achieved by an LTE system by allowing a scalable expansion of the bandwidth delivered to a user by allowing simultaneous utilization of the radio resources in multiple carriers. It also allows backward compatibility of the system with Release 8/9 compliant UEs, so that these UEs can function within a system where Release 10 (with CA) is deployed.

1.2 Communication in TVWS and DSS Bands

As a result of the transition from analog to digital TV transmissions in the 470-862 MHz frequency band, certain portions of the spectrum are no longer used for TV transmissions, though the amount and exact frequency of unused spectrum varies from location to location. These unused portions of spectrum are referred to as TV White Space (TVWS). The FCC has opened up these TVWS frequencies for a variety of unlicensed uses. One TVWS band of particular interest for opportunistic use in UL-only mode is the White Space in the 470-790 MHz bands. These frequencies can be exploited by secondary users for any radio communication as long as it does not interfere with other incumbent/primary users. As a result, the use of LTE and other cellular technologies within the TVWS bands has recently been considered, notably in standards bodies such as ETSI RRS (FCC 10-174: Second Memorandum Opinion and Order, 2010). Use of LTE in other Dynamic Spectrum Sharing (DSS) bands such as ISM (Industrial, Scientific, and Medical) or bands used for Licensed Shared Access (LSA) is also possible.

In order to reliably use the DSS bands for CA, an LTE system will need to dynamically change the SuppCell from one DSS frequency channel to another. This requirement, which is not present in the case of LTE-A systems compliant with the Release 10 standard, is due to the presence of interference and potentially primary users in the unlicensed bands. For example, strong interference (such as from a microwave or cordless phone) may make a particular channel in the ISM band unusable for data transmission. In addition, when dealing with TVWS channels or LSA channels, a user of these channels may need to evacuate the channel upon the arrival of a system that has exclusive rights to use that channel (TV broadcast or wireless microphone in the case of the TVWS). Finally, the nature of DSS bands and the increase in the number of wireless systems that will make use of these bands will inherently result in the relative quality of channels within the bands changing dynamically. In order to adjust to this, an LTE system performing CA must be able to dynamically change from a SuppCell in a DSS channel to another SuppCell in the DSS channel, or to otherwise reconfigure itself in order to operate on a different frequency.

1.3 Synchronization in LTE

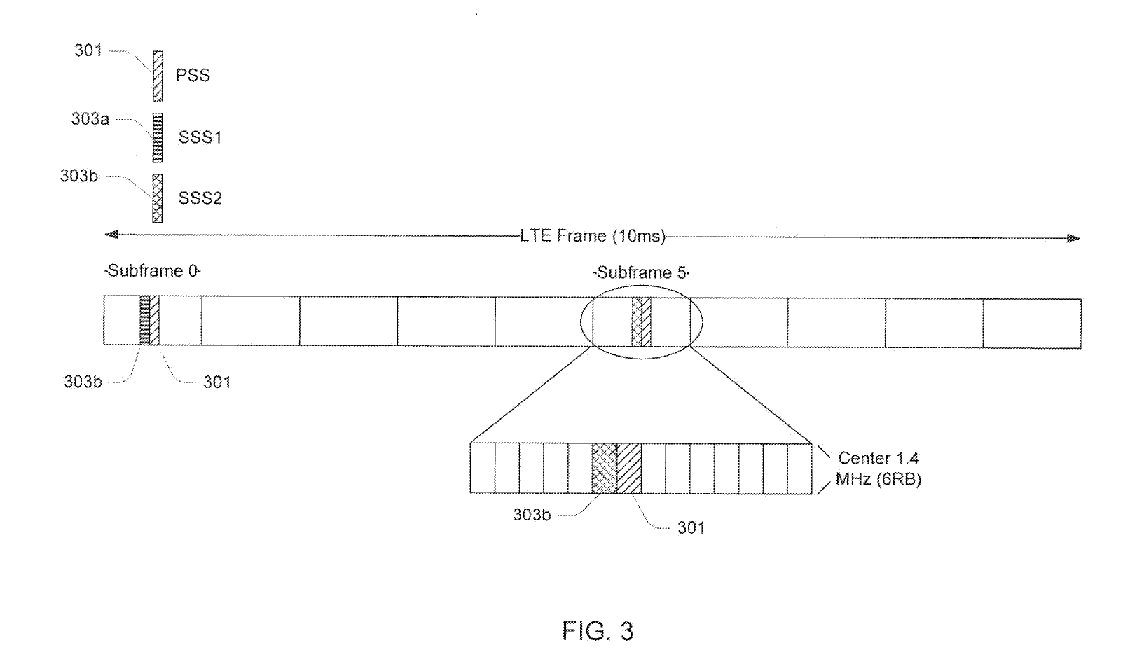

In LTE Release 8/10, Cell Search and timing/frequency synchronization rely on two signals called the PSS (Primary Synchronization Signal) and SSS (Secondary Synchronization Signal) as illustrated in FIG. 3. The PSS 301 and SSS 303 have similar properties and both are needed to identify the cell and achieve synchronization (timing and frequency). The relative location of these signals depends on whether the cell operates in FDD or TDD. Additionally, there are two variations of the SSS 303 (SSS1 303a and SSS2 303b) which are used to establish the frame timing. This is illustrated in FIG. 3.

In addition to the above synchronization signals, reference symbol also are transmitted in every resource block. These reference symbols also can be used to perform fine frequency synchronization.

1.4 Random Access in LTE

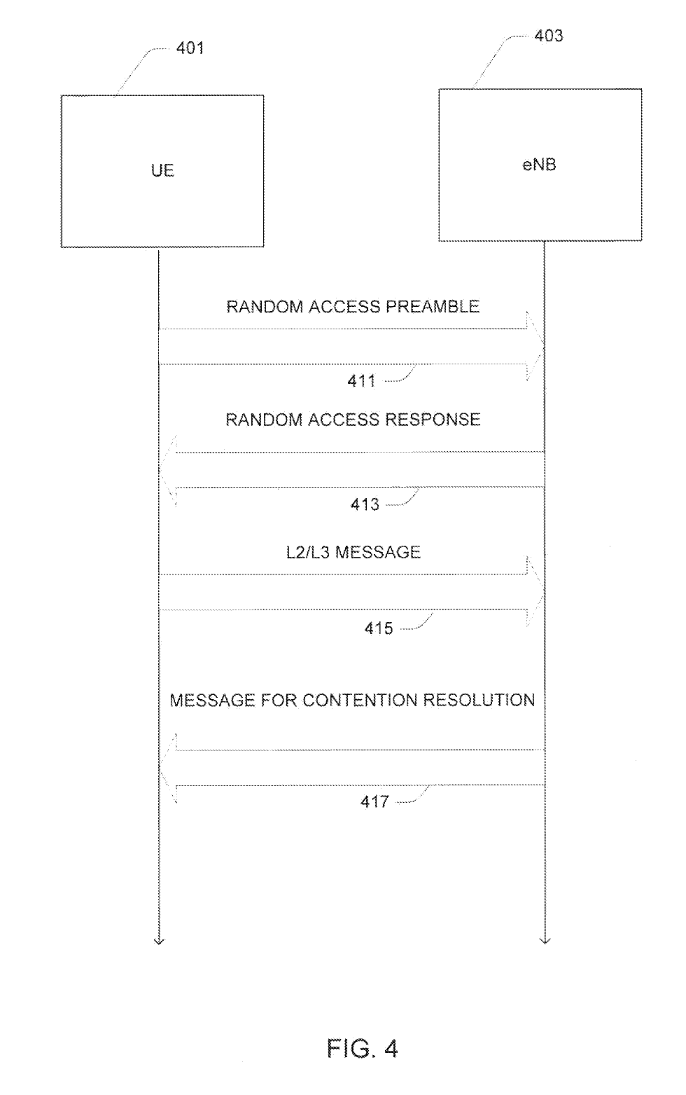

In LTE Release 8/10, the Random Access procedure is used to connect to a cell and adjust uplink timing. These methods can be re-used or modified to meet the needs of UL-only operation on DSS bands. The contention based Random Access Procedure is as described below and illustrated in FIG. 4:
1. The UE 401 sends a Random Access Preamble 411 over the Random Access Channel (RACH);
2. The eNB 403 sends the Random Access Response 413 including Timing Adjustment information, C-RNTI, UL grant for L2/L3 message, etc.;
3. The UE 401 sends the L2/L3 415 message, including RRC connection information;
4. The eNB 403 responds with a Message for early contention resolution 417.

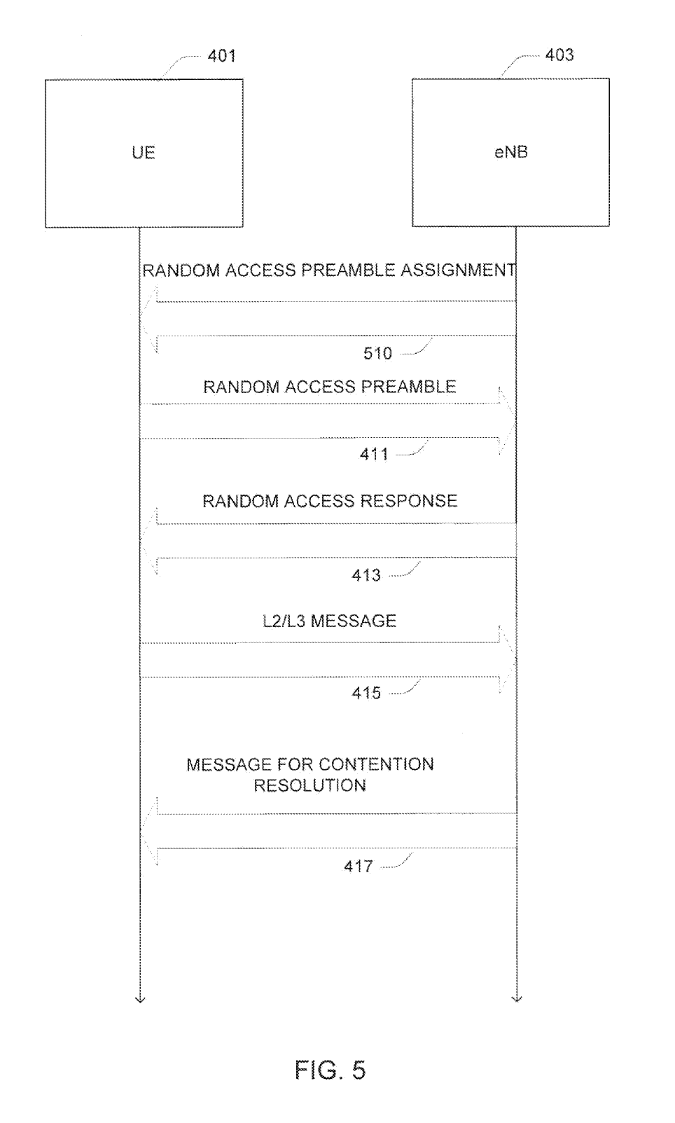

Additionally, there is a procedure called the Contention Free Random Access Procedure that can be used for handover and resumption of downlink traffic for a UE. This procedure is illustrated in FIG. 5 and is the same as the contention based procedure, except the eNB initiates it by sending a Random Access Preamble assignment 510. All other steps are as described in connection with the embodiment of FIG. 4.

1.5 Uplink Power Control in LTE

Uplink power control in LTE relies both on open loop and closed loop power control. The uplink transmit power is centered about the desired receive transmit power offset by the measured DL path loss (open loop component) and is further modified by the eNB through Transmit Power Control (TPC) commands (closed loop component) sent by the eNB.

If the UE transmits PUSCH without simultaneous PUCCH, the uplink transmit power for PUSCH on serving cell c is given by 3GPP TR 36.213: “Evolved Universal Terrestrial Radio Access (E-UTRA); Physical Layer Procedures”:

$${P}_{PUSCH , c} ( i ) = min \{ \begin{matrix} {P}_{CMAX , c} ( i ) , \\ 10 {log}_{10} ( {M}_{PUSCH , c} ( i ) ) + {P}_{O \_ PUSCH , c} ( j ) + {α}_{c} ( j ) \cdot {PL}_{c} + {Δ}_{TF , c} ( i ) + {f}_{c} ( i )\end{matrix} \}$$

where,
P_{CMAX,c}(i) is the configured UE transmit power defined in 3GPP TS 36.101: “Evolved Universal Terrestrial Radio Access (E-UTRA); User Equipment (UE) radio transmission and reception”, and depends on the UE class,
P_{O}_{_{—}}_{PUSCH,c}(j) is a value consisting of the desired received power at the eNB and is signalled by the eNB through RRC signalling,
PL_{c} is the measured DL path loss on a cell or component carrier that is designated as the reference linking cell by the eNB (the linking done through RRC signalling),
f_{c}(i) is the current PUSCH power control adjustment state for serving cell c and can consist of an accumulation of TPC commands sent by the eNB (if the upper layer configures TPC accumulation) or of the last TPC command addressing subframe i (if the upper layer does not configure TPC accumulation),
M_{PUSCH,c}(i) is the bandwidth of the PUSCH resource assignment expressed in number of resource blocks,
Δ_{TF,c}(i) is a correction factor that takes into account the transport format.

Similar equations can be found in 3GPP TR 36.213: “Evolved Universal Terrestrial Radio Access (E-UTRA); Physical Layer Procedures” for the transmit power of PUSCH when transmitted simultaneously with PUCCH, for the transmit power of PUCCH, and the transmit power of SRS by the UE.

TPC commands can be sent by the eNB through either DCI messages specifically used for this purpose (DCI format 3/3A), or by including the TPC command with the uplink grant whose power will be controlled by the command (DCI format 0/4). In either case, the TPC command modifies the uplink transmit power of the PUSCH, PUCCH, or SRS in the subframe it addresses.

To aid the eNB in making power allocation decisions and computing the optimal uplink transmit power, the UE will periodically send power headroom reports via MAC Control Elements (CE). The power headroom reports indicate the difference (positive or negative) between the nominal UE maximum transmit power and the estimated power for a serving cell. Power Headroom Reports (PHRs) are sent based on triggers specified in 3GPP TS36.321, “Evolved Universal Terrestrial Radio Access (E-UTRA); Medium Access Control (MAC) protocol specification”, which include the expiry of a timer set by the eNB, the change in the DL path loss by a certain amount, and the activation of an SCell or reconfiguration of the power headroom reporting itself.

1.6 Uplink-Only Cell Issues Relating to Synchronization and Power Control

In LTE, the uplink CC frequency used by a UE is derived from an absolute frequency offset of a downlink CC with which the UL CC is paired. In the case of LTE operation in DSS Bands, there may be scenarios in which a UE does not have a paired DL CC in the DSS Bands from which to derive frequency synchronization information for the UL CC. One example of such a scenario is the case in which a CC in a DSS Band is used only in the uplink direction to satisfy bandwidth needs. This can occur when the DSS bands are used only to extend traffic in the UL direction. It can also occur when the geolocation database gives access to a UE to transmit and not to the eNB. It can also occur when a TDD CC is used only during the UL subframes (DL subframes are DTXed) in order to ensure that it does not interfere with other eNBs using the same channel with different TDD configurations.

Finally, another scenario is the case in which two UEs communicate directly (through a form of device-to-device communication). Since this scenario can be realized by having each UE transmit to each other using only UL resources, this can be viewed as a case where the two UEs each have a UL-only connection with each other.

In this last case, although each UE involved in the device-to-device (D2D) communication can synchronize with the eNB using existing, already defined mechanisms, synchronization of the two UEs with each other may not rely on the eNB. For instance, although each UE is synchronized in time with the eNB's transmission, the timing of its transmission and reception with another UE will differ because of the difference in distance between each of the two peers UEs and the eNB. Furthermore, in the case where the D2D communication is on a different band than the eNB to UE communication (referred to herein as the inter-band D2D scenario), the UEs may have different oscillator characteristics (as would the eNB and UE) which would make precise synchronization based on a reference in another band quite difficult.

In LTE, inter-carrier interference is avoided through subcarrier orthogonality. This requires that transmitters and receiver oscillators have very tight tolerance in frequency in order to not destroy subcarrier orthogonality. Given a carrier frequency of 2.6 GHz, a typical frequency drift of 10 ppm of the local oscillator will result in an offset of 26 kHz. This corresponds to 1.73 sub-carrier spacings for LTE employed with a 15 KHz subcarrier spacing. In addition, the carrier frequency employed on different bands (by the eNB or the UE equipment) may be derived from different oscillators altogether. Due to this, and since DL CCs operating in other bands are too far apart in frequency to provide a good frequency reference, new mechanisms for providing this frequency reference are needed for the UL-only scenarios. Furthermore, the UL-only operation may need to be interrupted to provide coexistence gaps to allow secondary users to operate and ensure coexistence.

In addition to synchronization, existing UL power control procedures in LTE are inadequate for a UL-only cell operating in a separate band because such procedures depend on a DL path loss reference in the same band to manage the open-loop portion of the UL power control procedure. When this DL path loss reference is obtained from a different band, the calculated UL power may not be adequate for a UE. If the current procedures are used, this could result in the inability of a UE's transmission to reach the eNB or in the transmit power being larger than what is required resulting in increased levels of interference.

Similarly, in the case of D2D communication, the problem of inappropriate power control mechanisms could occur since the power to be used by each UE to communicate with another UE will depend on the distance between the two UEs. Each UL-only transmission made by the two UEs involved in the D2D communication will require some form of power control, which is currently not present for the case of transmission using only UL resources.

The subsections below present two different exemplary scenarios where DSS bands would be used in uplink-only mode in order to satisfy bandwidth needs for a system having a heavy amount of traffic in the uplink direction (the first scenario described above). In these cases, the uplink traffic could be entirely in the DSS bands, or DSS bands could be used to extend the uplink traffic also being transmitted in another band (through aggregation, for example).

1.6.1 Automatic Online Backup or iCloud

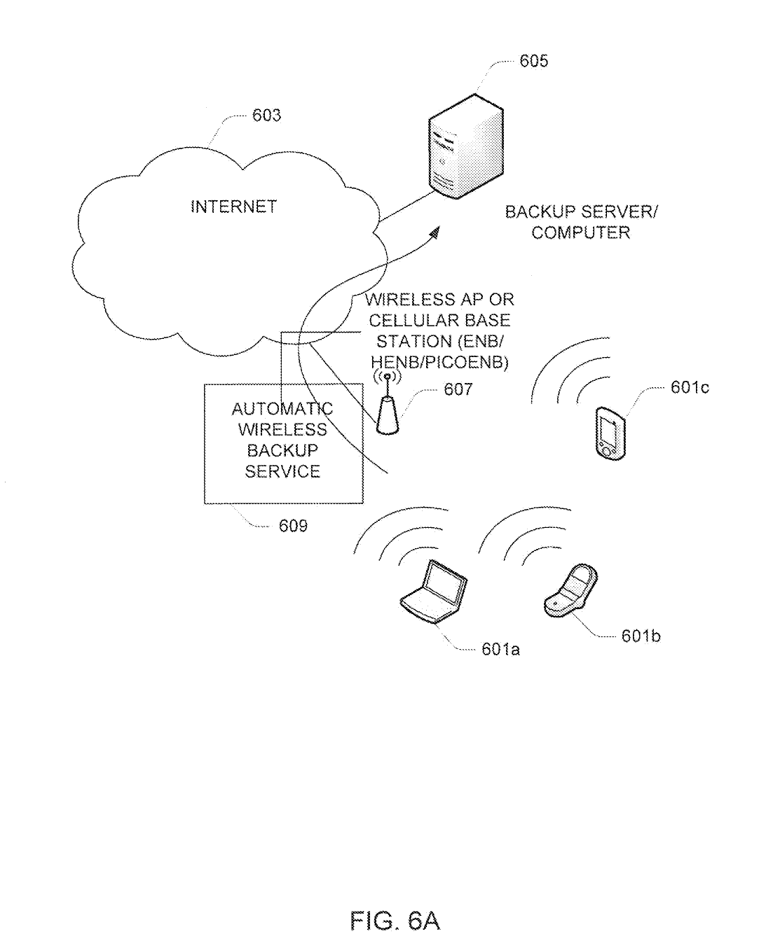

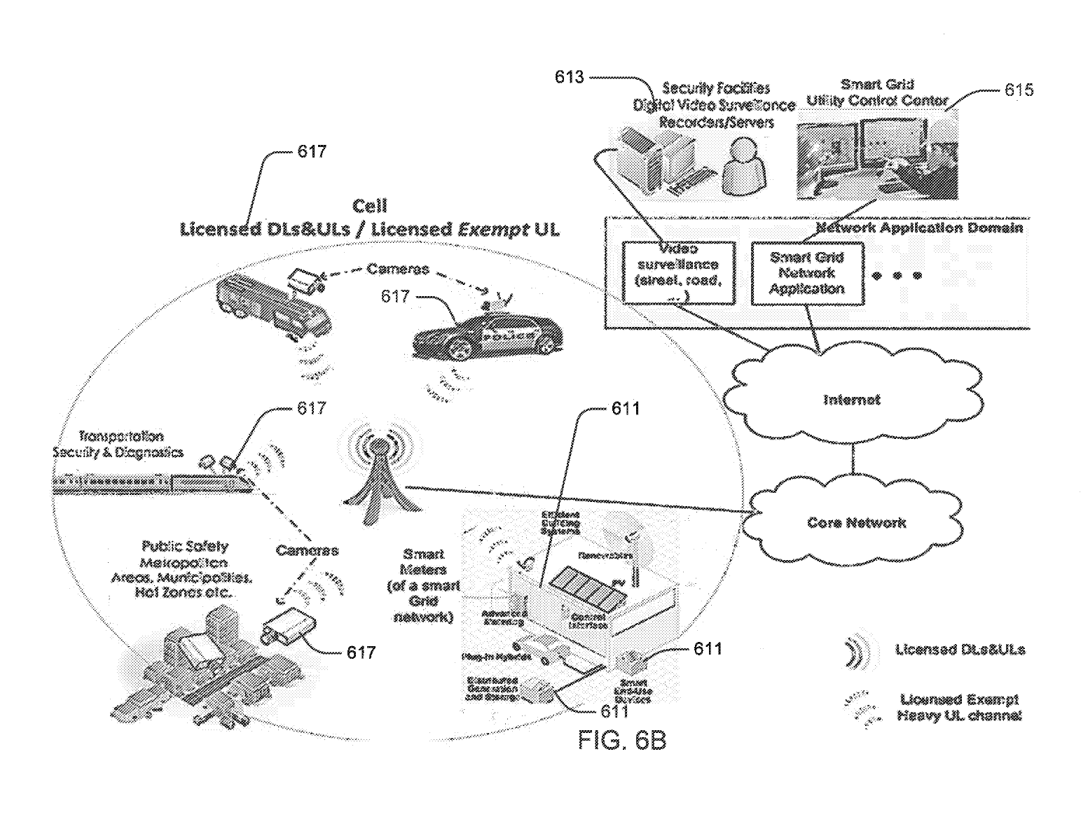

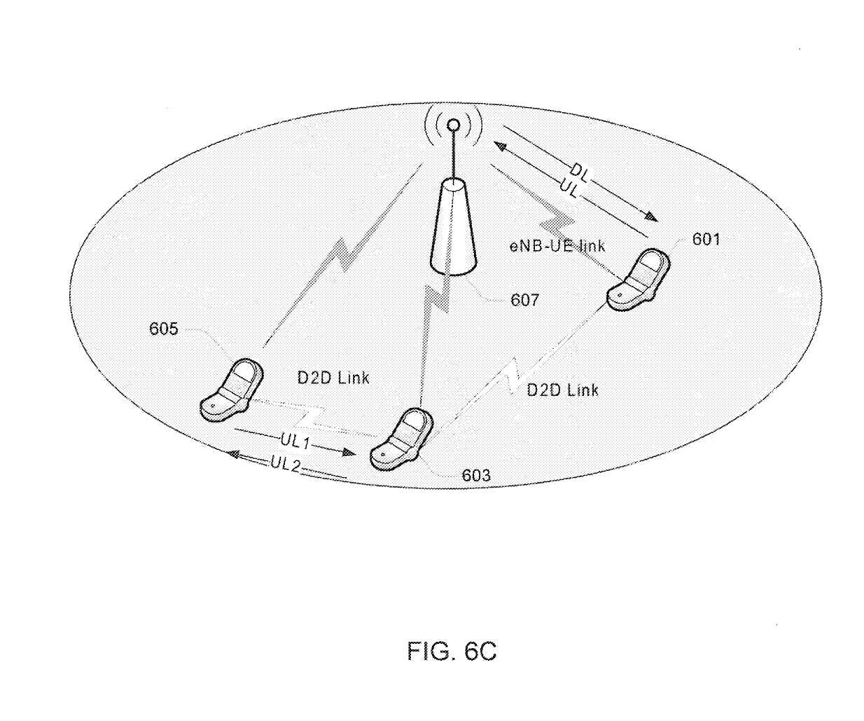

Several home and office solutions exist today that provide an automatic backup service for documents or large files such as videos. These software solutions allow backup of important files when these files are changed, or periodically (e.g., to reflect the changes in documents by employees over the course of a day). Referring to FIG. 6A, for example, when a backup is performed, the user's equipment 601a, 601b, 601c (mobile device or laptop) must send data over an internet 603 connection either to a backup data center 605 or to a cloud (such as the iCloud—not shown) where this data could be later retrieved if necessary. If the mobile device or laptop 601a, 601b, 601c has a wireless connection such as cellular, the backup will involve sending large amounts of information in the uplink direction from the user device to the base station 607 or access point of the network. In order to offload bandwidth used for normal data communication, automatic backup can be sent through DSS bands, in which case, uplink-only operation on the DSS bands would be required. During the backup time, the DSS channels would likely be used entirely for uplink traffic.

1.6.2 UL-Only for Cable Replacement

The need to enhance the uplink capacity comes from the incessant expansion in number of specific devices that require low control communication in downlink but are heavily communicating in the uplink. FIG. 6B is an illustration of heavy uplink devices communicating in the downlink over LTE licensed channels and in the uplink over a LTE licensed exempt channels. The deployment can be macro and/or small cells configuration. With reference to FIG. 6B, the following are some typical examples (but not limited to the list) of these uplink heavy devices:
Smart meters 611 performing regular sensing at home locations or over electricity network locations (smart grid, network for example) constantly sense results and continuously transmit the result data to a remote entity 615 in the network for analysis as illustrated in FIG. 6B;
Video surveillance devices 617, by nature, acquire a relatively huge amount of video (and audio) data and are also continuously transmitting that data to a remote entity 613 in the network for surveillance purpose and to be recorded on servers as illustrated in FIG. 6B. The video surveillance devices 617 can cover, but are not limited to, transportation (such as trains), vehicles (such as police cars and fire trucks), metropolitan areas, highways and roads, and hot spots (malls, parking lots, opportunistic public events requiring portable video surveillance).

For a traditional LTE system, the low downlink control communication of these types of devices can be handled with the usual LTE system capacity (primary and secondary channels). However, the continuous heavy uplink transmissions can cause uplink congestion. That is why the actual network deployment of these types of devices tends to be over wired networks. Using licensed exempt spectrum, which offers new spectrum at low cost, is an opportunity to enhance an LTE System with licensed exempt uplink channels to support these heavy uplink devices.

1.6.3 Device to Device Communications

The embodiments in this disclosure also apply to the use of device-to-device D2D communications as being studied in 3GPP Release 11. The main steps involved in D2D communication are 1) Discovery; 2) Initial Setup and; 3) Communication. The embodiments given apply both to Discovery (i.e., in order to achieve the correct initial frequency synchronization and transmit powers for each UE) and Communication (in order to track and correct frequency and timing errors and adjust the transmit power as the UEs move).

FIG. 6C illustrates the scenario of device-to-device communication in LTE. Two UEs 601, 603 in close enough proximity may enter into direct communication with each other without the need for communication through the network (via the eNB 607). The eNB 607 in the illustrated scenario may be on the same band as the D2D link (intra-band) or on a different band (inter-band). For the inter-band case, the frequency reference from the eNB-UE link may not be used to directly derive the operating frequency for the D2D link. In addition, for both the intra-band and inter-band cases, power control is required to maintain the correct transmit power for each UE (and this would be independent of each eNB-UE link transmit power).

In addition to the intra-band and inter-band D2D scenarios, a D2D link can also be established in an infrastructureless scenario. In this case, although the UE 605 may or may not still maintain a link to an eNB 607 (e.g. in IDLE mode), the D2D link is established and managed entirely by the two UEs 603, 605 without the intervention of an eNB 607. Multiple D2D links between several UEs is also possible in the case of a group D2D communication scenario, for example.

### 2. SOLUTIONS

In the remainder of this disclosure, UL-only operation refers to the transmission by a UE to another device, eNB, or similar infrastructure node where there is a lack of or limitation of adequate reference for timing, synchronization, and/or power control from the aforementioned eNB or similar infrastructure node that would normally be provided in the case of cellular operation such as LTE. Examples of UL-only operation that are specifically discussed in this disclosure include:
Operation by the UE on a UL component carrier when the frequency separation with the corresponding DL component carrier is too large to be used directly for frequency and power references in the normal fashion;
Operation by the UE in UL-only on a particular band or channel in order to exploit additional resources in the UL direction, where DL transmission is restricted due to interference with other systems (LTE, primary or priority systems in DSS bands, etc); and
Device to device communication (either in the intra-band, inter-band, or infrastructureless scenarios)

Other examples of UL-only operation (as defined here) are also possible and the solutions given in this disclosure also may apply to such examples.

This disclosure presents several methods for enabling an LTE component carrier to function in UL-only mode, including the signaling and changes to LTE required for these scenarios. This includes the concept of a UL-only cell in LTE as well as a new Special Uplink Reference Signal (SURS) that is used to determine the UEs that can take advantage of a UL-only cell.

Several methods to provide a frequency reference for UL-only cell operation are described herein.

In the context of frequency and time synchronization, one approach for UL-only operation comprises the UE sending a well know synchronization sequence in a one-shot or periodic fashion, which is then received by a peer UE or the eNB. The peer UE or the eNB compares the sync sequence received from the UE with its own local frequency reference and sends feedback to the UE (on a different channel or band) to readjust the frequency through a correction message. In this scenario, as discussed in more detail below, a synchronization sequence can be sent through modification of the SRS or RACH, as well as by inclusion of this sequence within the uplink data to provide fine synchronization updates during UL-only operation. In the context of RACH, in which a frequency synchronization message can be included in the RACH in other embodiments, the RACH can serve to perform all of frequency and timing synchronization as well as power control. In addition, this same approach can be used in the case of D2D communication. Options for the case of D2D communication include: 1) the eNB serves as the frequency reference, 2) the peer UE serves as the frequency reference but relays the information to the eNB, and 3) the peer UE serves as the frequency reference and transmits the correction directly.

One approach comprises an eNB interrupting the UL-only operation in a periodic fashion to send a sync signal that will be received and processed by the UE to initially acquire and maintain frequency synchronization. This approach may be enhanced by introducing periodic gaps after each sync channel.

Another approach comprises the UEs sending a well know synchronization sequence in a periodic fashion to the eNB. The eNB compares the sync channel received from the UE with its own local frequency reference and sends feedback to the UE to readjust the frequency.

Finally, a last approach comprises using dedicated or reserved subcarriers where the eNB can send synchronization symbols on the same channel simultaneously with data being transmitted in the uplink. Particularly, the UEs transmitting in the UL direction do not use the reserved subcarriers when transmitting data. Instead, they are equipped to receive simultaneously the synchronization symbols on these reserved subcarriers.

When coexistence gaps are present, some management mechanisms are introduced so that synchronization symbol timing is adjusted to take into account the presence of the gaps.

In addition to frequency and time synchronization, new methods to allow the UE to control its uplink power in the case of UL-only operation are disclosed. In particular, one approach for determining the DL path loss used for open-loop power control takes into account the difference in band. In addition, procedures for closed-loop power control in the scenario where the eNB cannot transmit in the DSS bands are described, which include the use of a specialized RACH procedure initiated by a PDCCH order, the use of timers to control the power control invalidity state and the use of power ramping applied to HARQ retransmissions. Other embodiments related to UL-only operation that are considered include:
A method for initial power control in UL-only operation where the RACH contains the power level used to transmit it, and where the RACH response uses the same power level; and
A method for close-loop only uplink power control where the data transmissions also contains the utilized power level, and the ACK/NACK is transmitted using that power level.

2.1 Use of UL-Only Cell in LTE

UL-only operation also can be achieved by the creation of a UL-only cell. In order for the eNB to establish a UL-only cell, it establishes certain conditions through specific procedures and signaling. This section describes specific scenarios where a UL-only cell would be established by the eNB, and the procedure for establishing it.

2.1.1 UL-Only Transmission Enforced by Geo-Location Database or Sensing

When operating in DSS bands such as TVWS, the availability of a channel (and whether a system can use the channel) is determined by information obtained from a geo-location database. In this section, we propose to define an uplink-only cell in LTE. Such an uplink-only cell may be in a DSS band such as TVWS.

When an LTE system operates in DSS bands, the eNB may be in a location where it does not have access to a channel (due to the presence of a DTV or other primary user), while the UE may be allowed to use the channel.

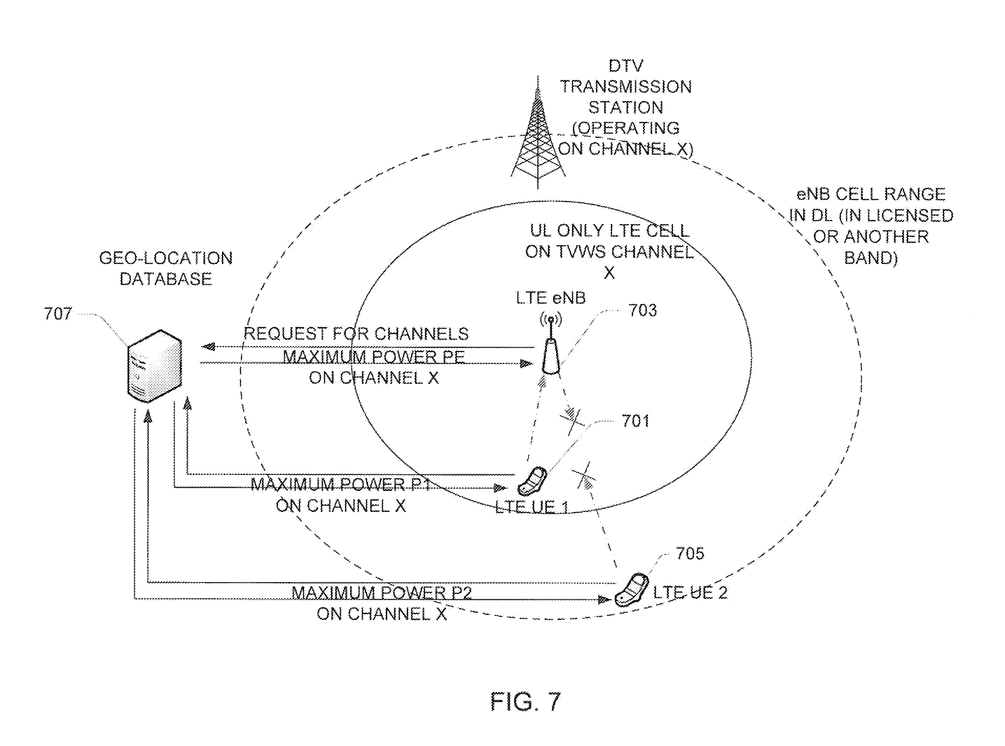

A scenario is shown in FIG. 7 in the European regulatory context, which is expected to follow the concept of location-specific output power defined in CEPT: ECC Report 159—Technical and Operation Requirements for the Possible Operation of Cognitive Radio Systems in the ‘White Spaces’ of the Frequency Band 470-790 MHz. In this scenario, a device operating in the DSS bands is allocated a certain maximum output transmission power based on its location and other parameters (e.g., Adjacent Channel Leakage Ratio). Depending on position and relative transmission power required by the UE and the eNB respectively, this regulatory framework may also lead to a situation where uplink transmission by the UE is possible, but downlink transmission by the eNB is not possible.

For instance, in the scenario shown in FIG. 7, UE1 701 is able to transmit with allocated maximum power P1 so that it can communicate with the eNB 703. However, UE2 705 transmission with allocated maximum power P2 is not feasible as the expected data rate on that channel would be too low. Transmission by the eNB 703 with allocated maximum power Pe is also not possible on the channel for the same reason (the required transmission power to communicate with UE1 701 or UE2 705 with the required data rate is above the maximum allowable transmit power allocated by the database 707). In this case, UE1 701 can transmit using a UL-only cell in DSS bands.

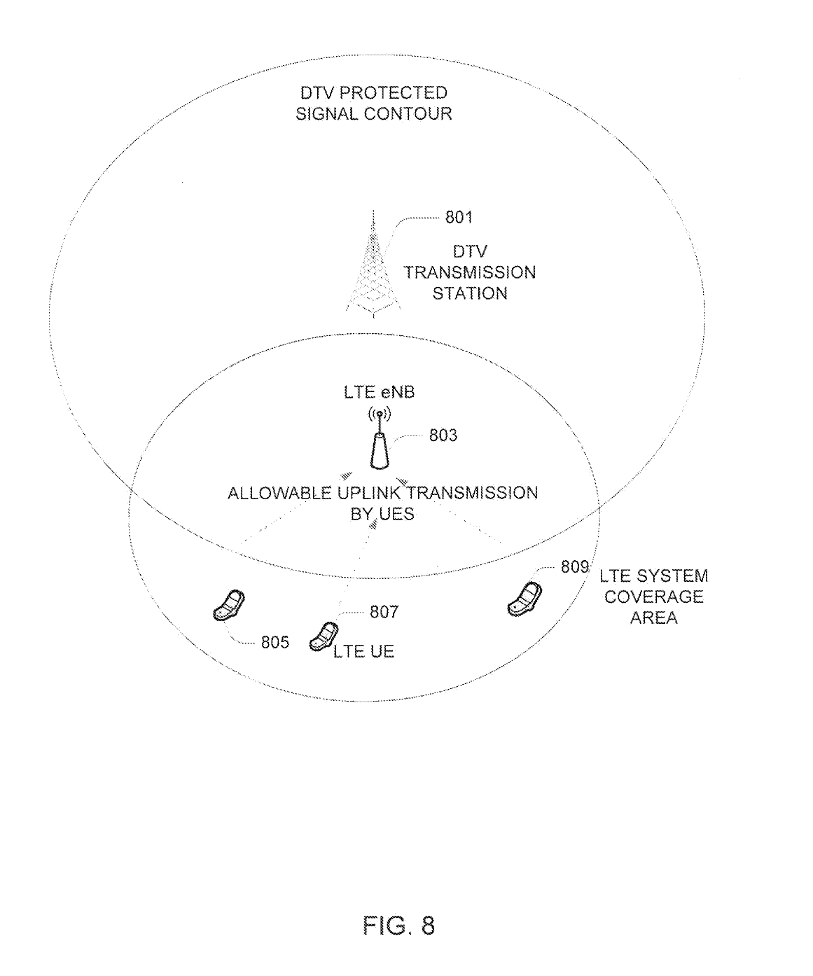

A similar situation may occur in the FCC regulatory framework. FIG. 8 illustrates this potential scenario in the case of a DTV transmission station 801 and the FCC regulatory framework described in FCC 10-174: Second Memorandum Opinion and Order, 2010 (protected signal contours). In FIG. 8, the LTE eNB 803 is in the protection contour of the DTV transmission station 801 and therefore cannot transmit. However, the LTE UEs 805 807 and 809 are not in this protection contour, and therefore may transmit in the UL to the eNB 803. The scenario could be similar for other primary users such as wireless microphones.

In both of the previous scenarios, the UE and the eNB both require geo-location capability so that each device can obtain its own channel availability information from the geo-location database. Each device may separately contact the geo-location database to obtain this information. Alternatively, the eNB can obtain geo-location information for each UE on behalf of the UE by communicating the position of each UE to the database and then forwarding this information to each UE.

An LTE-system operating in sensing-only mode (defined by the FCC) may also result in a scenario that motivates UL-only transmission. An LTE eNB 803 may detect the presence of a primary user 801 through sensing. However, sensing at one or more UEs 805, 807, 809 may not find such primary user due to the locations of the UEs. Based on the FCC rules for sensing-only devices (each device individually needs to determine the presence/absence of a primary user before transmitting), the UEs 805, 807, 809 in this case would be allowed to transmit, but the eNB 803 would not. This warrants the potential for UL-only transmission on that channel, and, if this is the only channel available for use by the LTE system, will require the use of a synchronization scheme such as described hereinbelow.

An uplink-only cell (either TDD or FDD) typically can be established only in the context of carrier aggregation, since a cell enabled with downlink transmission must be present. The downlink cell with which the uplink-only cell is aggregated could exist in the licensed band or in the DSS bands (e.g. TVWS). In order to establish an uplink-only cell in the DSS bands, the following procedure may be used (which is applicable for any of the mentioned regulatory contexts).
1) The eNB determines whether a frequency in the DSS bands may be used only for uplink transmission (i.e. downlink transmission in that frequency is not permitted or will not result in the desired data rates). The way this is done depends on the regulatory context or case mentioned above:
   a. If the eNB determines that it cannot transmit at all based on the information from the geo-location database or due to sensing, it has no more work to do. In this case, the DSS could potentially be used for UL-only transmission, depending on whether UEs exist that would benefit from the UL-only transmission, and would be allowed to transmit in UL to the eNB.
   b. If the eNB determines that transmission is possible based on the information from the geo-location database, it starts to transmit the LTE synchronization signal and cell specific reference signals in order to enable inter-frequency measurements by UEs that may use this frequency. Measurements are configured to a subset of UEs currently served by the eNB. Once the eNB receives measurement reports from the UEs (these can be received on the licensed band, for example), the eNB decides whether there are UEs that can use this frequency for effective downlink transmission and whether establishment of an uplink-only cell is warranted; The eNB will continue to transmit the synchronization and reference symbols on this frequency even when there are no UEs that can use this frequency for an uplink-only cell. This allows potential addition of UEs to an eventual UL-only cell in the future;
2) One or more UEs would be instructed by the eNB to attempt initiation of UL-only transmission in the DSS bands. In the case of 1a), the eNB would instruct the UE to transmit a special uplink reference signal (SURS) in the UL on one or more specific channels in the DSS bands. The UE could determine that it needs to transmit on the DSS bands using some specific control signalling sent from the eNB. For instance, the eNB could use a System Information Block (SIB) to signal the need to establish a UL-only cell and send the set of channels on which the UE should transmit the SURS. Upon receiving a SIB that indicates to a UE that it should attempt establishment of a UL-only cell, the UE would transmit the SURS on the instructed channel(s). The SIB in question could also indicate some timing details that would avoid collision of SURS from multiple UEs, for instance. Alternatively, UE specific RRC messages could be used to configure a UE to transmit the SURS, and the channels in the DSS on which to transmit the SURS. In either of the two cases, the SIB or RRC message would also indicate information related to the transmit power of the SURS. For instance, the initial power could be specified and determined by the eNB from known UL power in other bands, while the maximum transmit power could be specified by the maximum allowable power obtained from access by the eNB to the geolocation database;
   In the case of 1b), the UE would instead learn the DSS band channels on which to start performing measurements of the downlink reference signals. The UE would report these measurements (in the form of inter-frequency measurement reports, for example) to the eNB. As a result, the trigger for the UE to perform such measurements could be an inter-frequency (or inter-band) measurement configuration. The eNB could further limit the number of channels to be searched and measured by the UE based on the availability information in the geolocation database. As a result, the measurement configuration may contain a list or sub-band of channels on which the UE will perform measurements;
3) Based on measurements, the eNB decides if there are any UEs that can take advantage of a UL-only channel. For case 1b, the measurements may be standard LTE measurements of the synchronization or reference symbols that are sent by the UE (as described in 2 above). For case 1a, these measurements could be special measurements made by the eNB based on the SURS that the eNB requests the UE to transmit (through a command or configuration sent on another band or channel such as the licensed band). Alternatively, the decision could be made through results of sensing measurements whereby the UEs and the eNB performs sensing to detect the presence of a primary user in the vicinity (for example, in the context of sensing-only mode devices).
4) If the eNB selects a channel to be used for UL-only transmission, it activates a UL-only cell for the affected UEs on that channel;
5) In order for the affected UEs to maintain synchronization, the eNB will send synchronization information in one of the following fashions;
   a. If downlink transmission is not allowed by the eNB on the channel (e.g., an FCC regulatory environment in which the geolocation database does not allow any transmission on the frequency), the eNB sends synchronization information on a different channel or a different band. One of the non-co-channel synchronization schemes described below that uses synchronization schemes on a different channel or band is used;
   b. If downlink transmission is permitted on the channel by the eNB (perhaps with reduced power), the eNB sends the synchronization signal on the same channel as the uplink transmission using one of the co-channel synchronization schemes described below.

When selecting the synchronization scheme, the eNB may communicate to the UE which scheme will be used so that the UE knows from where to receive the synchronization information. This may be done through RRC signaling by the eNB to set up the UL-only cell, or as part of the MAC CE that is used to activate the UL-only cell.

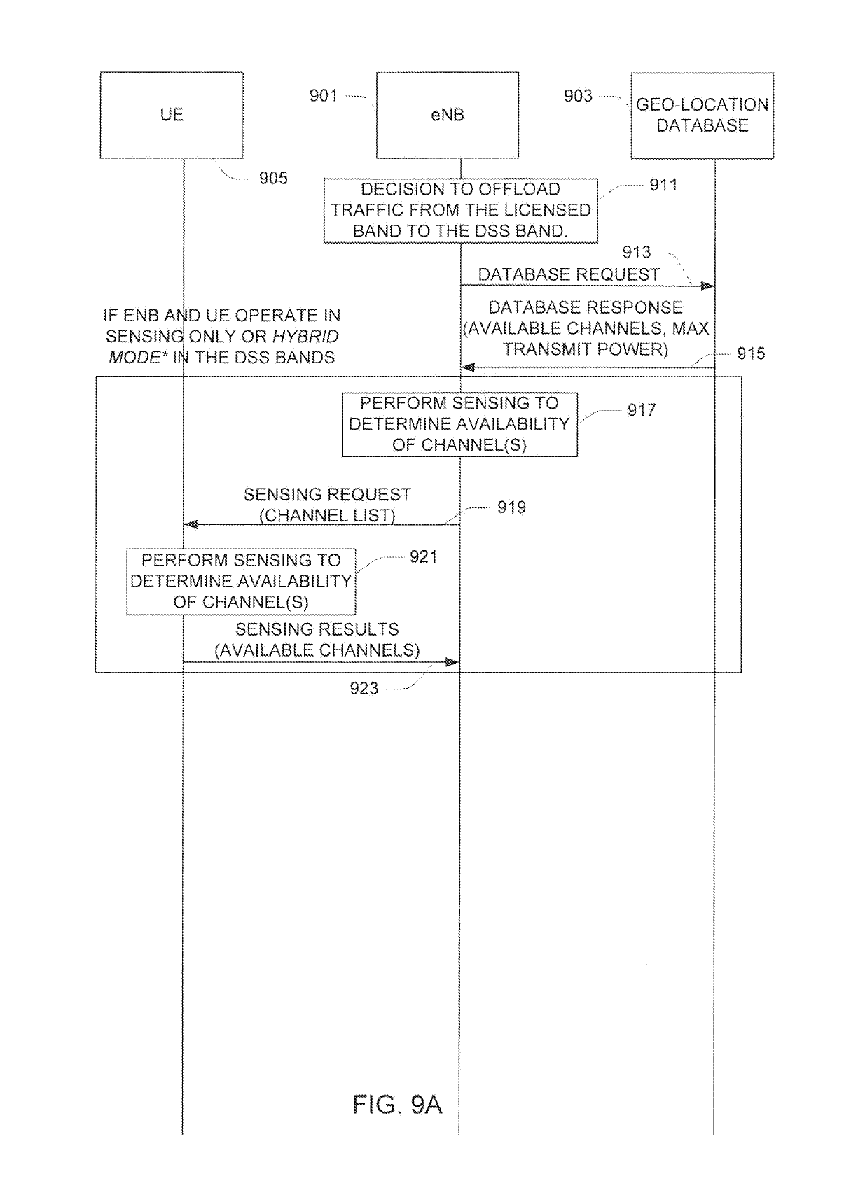

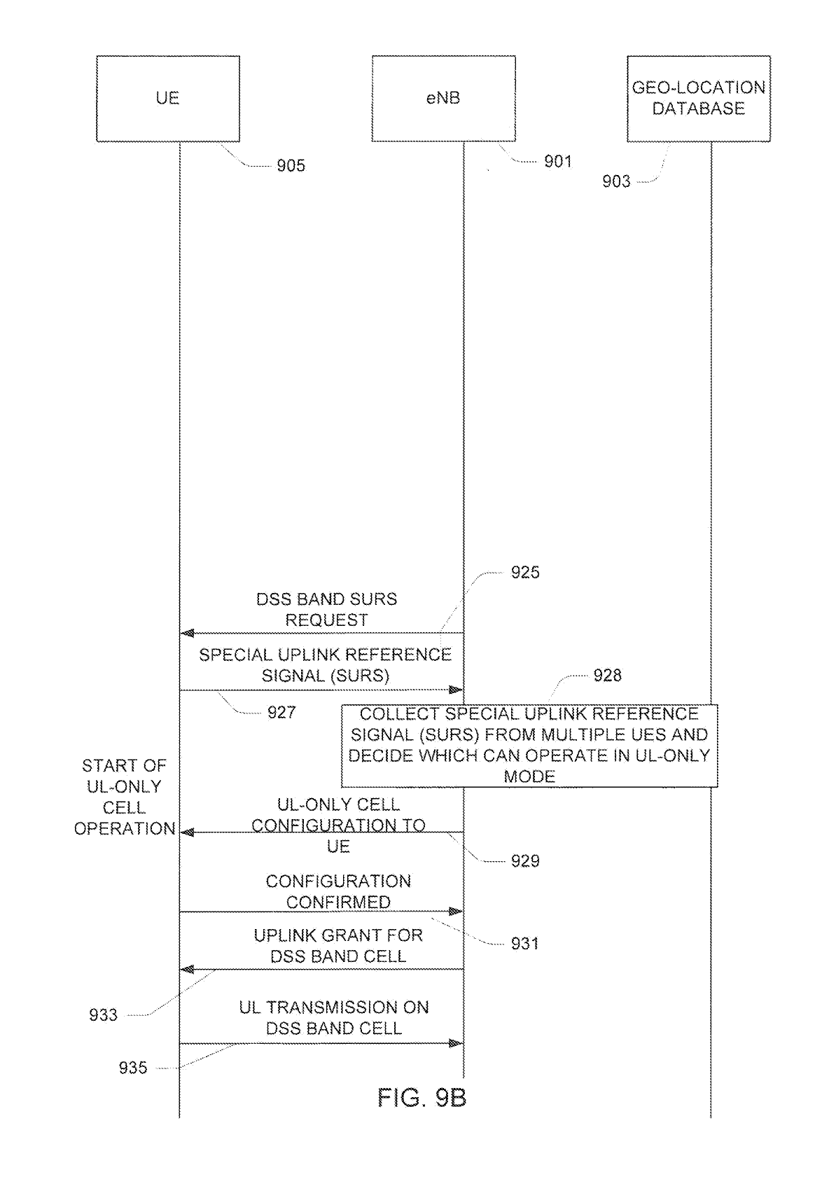

FIGS. 9A and 9B give an information flow for uplink-only establishment of LTE in DSS bands that depends on a new Special Uplink Reference Signal (SURS) for the eNB to determine which UEs can be served by an uplink-only cell in the DSS bands.

In the information flow, the eNB 901 decides at 911 to offload some of its traffic onto the DSS bands (it assumed that some of this is uplink traffic). The database 903 is queried at 913 to determine the available channels and (in the case of the European regulatory framework) the maximum allowable transmit power on these channels. In this case, this request 913 also may include a request by the eNB 901 for the available channels and maximum allowable transmit power for the UE 905 (based on the UE's location, of which the eNB is aware). Alternatively, the information for the UE may be provided in an additional step performed subsequently.

The database 903 sends a response at 915 to the eNB 901 with the requested information. If the eNB 901 operates in sensing-only mode described by the FCC in FCC 10-174: Second Memorandum Opinion and Order, 2010 or in hybrid mode as described in Published Patent Application No. 2012/0134328, the eNB 901 performs sensing at 917 to determine the available and restricted channels and at 919 requests the UEs 905 to do the same. The UEs perform the requested sensing at 921 and transmit the sensing results to the eNB, as shown at 923. A candidate channel for uplink-only transmission is a channel that can support UE transmission, or has an advantage in supporting UE transmission, but not eNB transmission. The eNB 901 then configures potential UEs to transmit a SURS on these candidate channels as shown at 925 in FIG. 9B. The decision to enable UL-only transmission could also be based on inter-frequency measurements made by the UE, and sent to the eNB, in the case where the eNB is able to transmit in the downlink on the DSS band channels of interest. As described above, the request 925 for the UE to transmit the SURS can be sent through RRC signaling sent by the eNB to the UE, which happens on the licensed band. It can also be sent through a SIB on the licensed band. The UE 905, upon receipt of this request, sends a SURS signal 927 on the DSS channel. This SURS may have the following properties:
It may identify the UE by incorporating a special UE ID, or by having the UE send a special UE ID during a known subframe that is determined by the eNB in the SURS request
It may be robust enough to be received by the eNB despite potential frequency offset at the UE.

When the eNB has collected the SURS from one or more UEs, it may decide to configure a UL only cell for these one or more UEs, as shown at 928. It therefore sends a UL-only cell configuration message 929 to these UEs. The UEs then confirm the configuration, as shown at 931. During normal operation of the UL-only cell, the eNB will send an uplink grant 933 for resources to be used by the UE on the DSS band. This grant may be sent on another band where DL transmission by the eNB is possible (e.g., the licensed band). The UE will then use the information obtained in the grant to transmit data on the UL-only cell in the DSS bands (935).

It also should be noted that the UL-only cell configuration could take place prior to the transmission of the SURS. This would be the case, for example, if this configuration were to be sent using existing activation mechanisms. One case of the SURS in the context of configuring the initial transmit power of the UE is considered in detail in section 2.3.2.1 below entitled Initial Activation of UL-only Cell. The SURS, as described in this section and the information flows presented above, is used for the eNB to determine which UEs can transmit using a UL-only cell (e.g. their maximum power obtained from the geolocation database allows for proper communication in the UL direction). Because the UE may need to send its identity when transmitting the SURS, timing and frequency synchronization must be performed as part of the transmission/reception of the SURS. This timing and frequency synchronization may use the techniques described in section 2.2 and 2.4 below, which are more generic synchronization schemes being presented in this disclosure. On the other hand, the timing and frequency synchronization performed on the SURS may be more specific to the SURS procedure itself. Sections 2.1.4 and 2.1.5 below describe some specific embodiments in the case of LTE for both transmission of the SURS request by the eNB to the UE and transmission of the SURS by the UE, in addition to how timing and frequency synchronization and power control are performed in this case. These embodiments are specific to the SURS procedure.

The more generic embodiments described in section 2.2 and onwards may also apply to synchronization and power control applied to the SURS, but are more generally techniques that allow synchronization and power control in either a one-shot or periodic fashion when the UL-only cell has already been established for a particular UE.

2.1.2 UL-Only Transmission Resulting from Interference Mitigation

In the context of DSS, there is a high likelihood that many operators may operate in the same channels, especially in urban areas where the number of available channels can be limited. This creates a unique situation, where, for a given location, there may be many overlapping cells using the same frequency and different (Public Land Mobile Networks (PLMNs), or using the same frequency but different Radio Access Technologies (RATs), e.g., TDD-LTE and FDD-LTE. Different overlaps from another network could also occur. A full overlap from another LTE system or from a Wi-Fi system is possible. Partial overlaps with another network or with multiple other networks are also possible. When the cell size is in the range of 100 to 500 meters, partial overlaps can become a more frequent problem. This can be even more frequent when many smaller cells (such as AP and HeNB of 30-50 meters) are deployed in the same area as the DSM LTE small cells of 100-500 meters.

There are two potential subcases of interference that can be avoided by UL-only transmission. These subcases are the case of interference between overlapping LTE and Wi-Fi systems, and the case of interference between overlapping LTE systems that are synchronized but do not use the same RAT (TDD, FDD) or the same TDD UL-DL configuration.

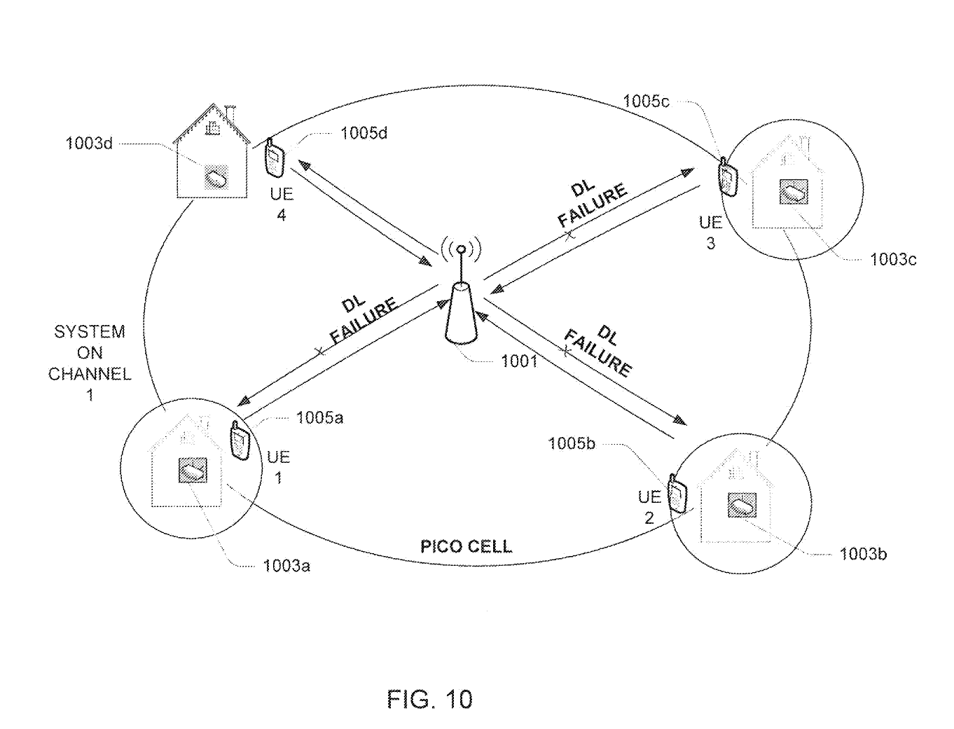

FIG. 10 illustrates a direct consequence of the partial cell overlap in the case of TDD-LTE to Wi-Fi interference. In this example,
A small cell Base Station 1001 (pico cell) operates on channel 1 from DSS.
Inside a few houses, Wi-Fi systems 1003a, 1003b, 1003c, 1003d are operating on channel 1, in which case the DL transmissions of the base station 1001 to any UE close to the house (such as UEs 1005a, 1005b, and 1005c) are subject to interference from the respective Wi-Fi systems 1003a, 1003b, 1003c. However, UL transmissions from UEs 1005a, 1005b, and 1005c may still be possible, as UE transmission close to the Wi-Fi network may force the Wi-Fi network to stop transmitting and backoff. Therefore, uplink transmission should work normally. In contrast, when the base station 1001 transmits to the UEs 1005a, 1005b, and 1005c, it is farther to the UE than the Wi-Fi network. Thus, the Wi-Fi network signal may dominate the channel from the UE perspective. Furthermore, the base station transmission level received by the Wi-Fi network may not be strong enough to force the Wi-Fi to stop transmission and to back-off. Therefore, the downlink signal may cause interference between the Wi-Fi and LTE systems trying to operate in the same channel.

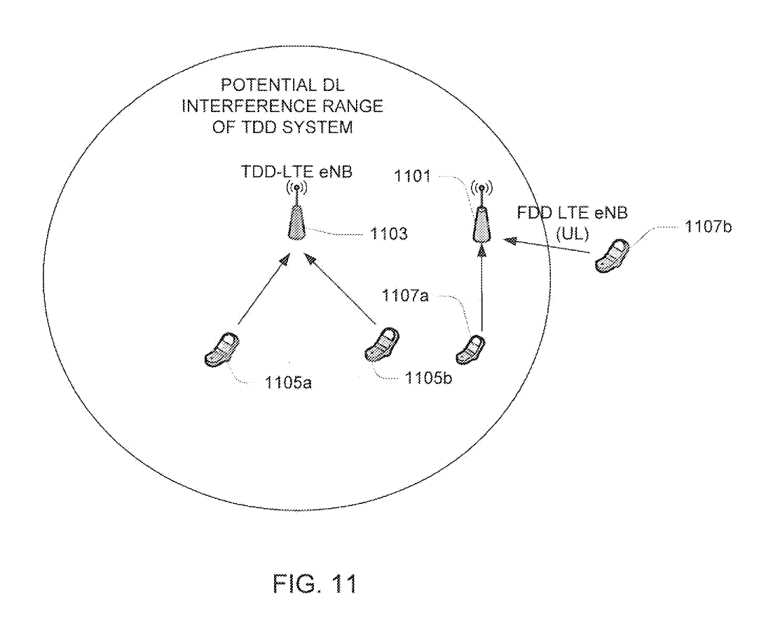

FIG. 11 illustrates a direct consequence of the partial cell overlap in the case of interference between two LTE systems. In this example:
An FDD-LTE system having base station 1101 and UEs 1107a, and 1107b and a TDD-LTE system having base station 1103 and UEs 1105a and 1105b have overlapping coverage
The FDD system uses Channel 1 as a UL channel
The two systems are able to follow some coexistence rules for sharing the UL resources such that they use different frequency ranges within the shared channel, or they avoid using the same UL resources
If the TDD system base station 1103 were to transmit in DL, this would cause interference to the eNB 1101 of the FDD system on the same channel (since there is no way to separate DL transmissions from an eNB from UL transmissions from a UE at the PHY layer)
If some coexistence mechanisms are used, the UL transmissions from TDD UEs 1105a, 1105b would not interfere with UL transmissions from the FDD system base station 1101 and vice versa (when considered at the eNB)
The scenario below also could be generalized to the case where the FDD LTE system is another TDD LTE system made to operate in UL-only

Given the two interference scenarios above (TDD-LTE to Wi-Fi Interference and TDD-LTE to LTE interference), in order to allow the TDD eNB 1103 to continue to use the channel, DL transmissions on that channel can be disabled. The UL subframes in the TDD UL/DL configuration will be used normally, while the DL subframes will be DTXed (or not used).

When an eNB using TDD is configured in UL-only mode, UL transmissions on those subframes that are UL subframes are scheduled from another carrier (either in another DSS band channel or in the licensed band) using cross-carrier scheduling. The UE in this case can be notified through either RRC or MAC signaling by the eNB that the DSS band carrier will operate in UL-only mode. As with the scenario described above under section 2.1.1, entitled UL-Only Transmission Enforced by Geo-Location Database or Sensing, the eNB will indicate to the UE how synchronization is to be performed and whether the UE must read synchronization and reference symbols from the UL-only channel. The RRC or MAC signaling may send the additional information about the synchronization mode or scheme to be used.

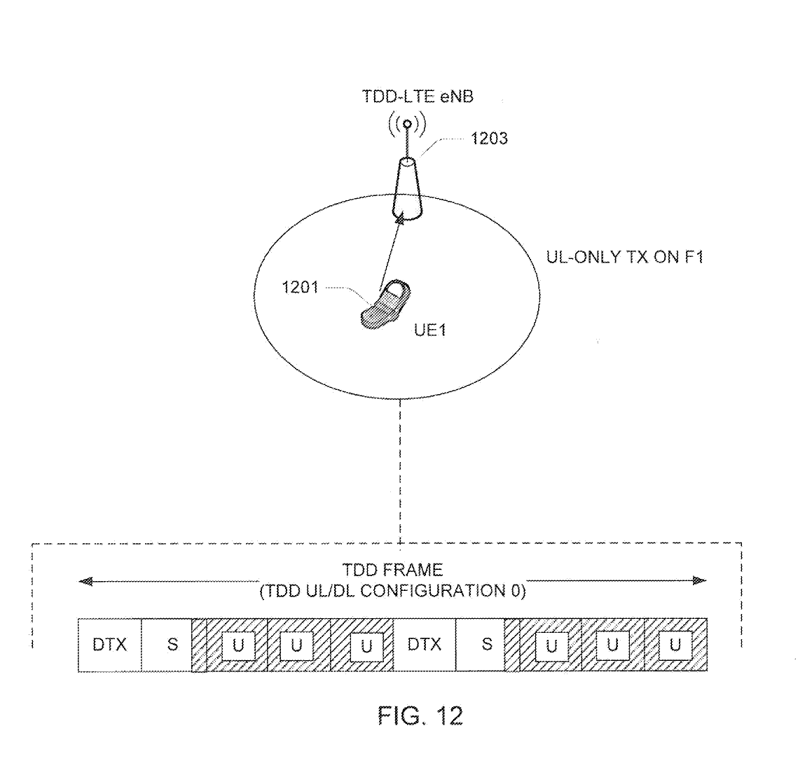

The concept of a TDD UL-only cell is illustrated in FIG. 12. As mentioned, UL-only operation in TDD is characterized by the UE 1201 utilizing only the UL subframes in the TDD UL/DL configuration. The DL subframes are unutilized and it is assumed that the eNB 1203 will not transmit during these DL subframes. As a result, the UE does not need to monitor these DL subframes in this mode. Alternatively, the UE may monitor these subframes only to receive synchronization and reference symbols for synchronization. However, as described below in section 2.4 concerning synchronization schemes when there is a downlink co-channel available, this can be minimized to specified DL sync periods.

2.1.3 UL-Only Transmission from Dynamic FDD UL-Only Mode

Dynamic FDD was described in detail in provisional Patent Application No. 61/440,288, which is incorporated in full herein by reference. In dynamic FDD, UL-heavy traffic could be dealt with by the eNB/HeNB by configuring a supplementary carrier in UL-only mode. A supplementary cell in UL-only mode could use one of the synchronization schemes in the following section to ensure frequency synchronization for the UEs.

2.1.4 Main Embodiments for the Timing of the SURS

In section 2.1.1, a procedure was defined whereby a UL-only cell could be established. This procedure, although described in the section as something required due to enforcement by a geolocation database and/or sensing, could also be applicable for the case of interference mitigation described in section 2.1.2.

In this section, are described some embodiments of the SURS in the context of LTE. Since the SURS is transmitted prior to the establishment of the cell (and therefore of the cell timing on the DSS band), the rough timing of transmission of the SURS could follow the frame timing on the licensed band (or the cell which is being used to transmit the SURS request).

SURS Via Transmission in a Specific Subframe:

The SURS could be transmitted by the UE on a specific subframe that corresponds to a UL subframe on the licensed band (if the licensed band is TDD) or to any subframe (if the licensed band is FDD). For instance, the SURS request (which could be sent through either RRC signaling or via SIB) could indicate the exact subframe number on which a UE must transmit the SURS to the eNB. As a result, the UE will read the timing details of the SURS in the RRC signaling or SIB and transmit the SURS as a signal during the subframe that corresponds to the subframe instructed by the eNB.

SURS Via RACH-Like Signaling:

The SURS could be transmitted by the UE using a procedure similar to the RACH. The UE could therefore transmit the SURS on the RACH opportunity defined from the timing of the licensed band. In this case, the UE would first read the RRC messaging or SIB signaling that instructs it to send the SURS on the DSS bands, would then wait for a RACH opportunity (as configured by the RACH configuration) on the licensed band, and then transmit the SURS on the DSS band according to the timing of the RACH opportunity on the licensed band. In this case, the RACH configuration for the UE on the licensed band is serving as the timing for sending the SURS on the DSS bands.

SURS Via Common UL Subframe:

In the case where the eNB requests a SURS after it has already transmitted downlink reference signals for inter-frequency measurement (case 1b in the procedure of section 2.1.1), and the transmissions on the DSS bands prior to the SURS are assumed to follow a TDD frame structure, the SURS can be transmitted via any UL signaling which respects the frame timing being employed on the DL. Since this timing may not be known in advance by the UE in the case of a TDD frame structure, for example, the UE could ensure transmission of the SURS on a subframe that is known to be a UL subframe (the subframe number in which all TDD UL/DL configurations have a UL subframe defined for it).

2.1.5 Main Embodiments for Structure of the SURS Request and SURS Transmission

When the SURS request is transmitted by the eNB, the UL-only cell has not yet been established. As a result, signaling for the SURS request by the eNB may need to come on another band. In one embodiment, the SURS request may be sent on a DL component carrier in another band. In the preferred embodiment, the SURS request to a particular UE could be sent on the Primary Component Carrier (PCC). However, the SURS request also could be sent on the Secondary Component Carrier (SCC).

The eNB may send the SURS request separately to each UE and perform the UL-only cell establishment for each UE sequentially. In this case, the eNB could employ a new RRC message or an RRC IE to send the SURS request to a target UE. The information element may contain the following data:
The band and channel and/or raster frequency on which the UE is to send the SURS. This could also be a list of channels as well, in which case the UE would transmit the SURS sequentially or simultaneously on multiple channels in a given band requested by the eNB, for example;
The transmit power with which the UE is to transmit the SURS. The transmit power could be the maximum transmit power with which the UE could transmit based on the information from the geolocation database. Alternatively, the power could be some value which is lower than the maximum value in order to avoid potential interference with other devices in the DSS band, or other UEs which are already communicating in UL-only on a given channel;
The timing for the transmission of the SURS by the UE, in the cases where the embodiment used in section 2.1.4 requires the eNB to send the timing;
Any configuration data associated with the SURS, which may include the maximum number of retransmissions of the SURS by a UE, the time interval between retransmissions, as well as potentially the increment in power to be applied between retransmissions of the SURS by the UE (in the case where the initial power is below the maximum power).

In another embodiment, the SURS request could be sent by the eNB to the UE via a MAC CE. In this case, the MAC CE would have the same information as given above.

A UE that receives a SURS request on the PCC or SCC will use the timing, frequency, and configuration information obtained in the SURS request to transmit a SURS or multiple SURSs as the case may be. In the case where multiple SURS requests are transmitted on different frequencies, the UE may transmit them sequentially in subsequent frames or subframes, as indicated by the configuration information in the SURS request. Alternatively, the sequence or time interval between transmissions of the SURS on different frequencies may be fixed and known apriori by both the eNB and the UE. In the case of retransmissions on the same frequency (with increment in power between transmissions), the UE may transmit a SURS and wait for a specific timeout. The timeout could be fixed or indicated in the SURS request. If the timeout expires without the UE receiving a UL-only cell configuration (message 929 in FIGS. 9A and 9B), the UE will retransmit the SURS by increasing its transmit power by an increment. The procedure then terminates when the SURS has been transmitted an agreed-on maximum number of times or when the UE receives a UL-only configuration (sent via RRC signaling on the PCC, for example). The UL-only cell configuration could also be preceded by a PDCCH message or a MAC CE to indicate to the UE that transmission of the SURS should be stopped.

As mentioned, the eNB could trigger the above procedure by sending the SURS request individually to each UE and sequencing the configurations of each UE in time. Alternatively, the eNB could trigger several parallel SURS message transmissions by sending a SURS request to all UEs or multiple UEs. For example, the eNB could send the SURS request to all UEs simultaneously if the SURS request were to be transmitted using a SIB. Also, a subset of UEs (which may, for instance, represent the set of UEs that would benefit from UL-only transmission in the DSS bands) could all receive the SURS request through RRC signaling at the same time or with little delay between each request, which could cause multiple SURS requests to be transmitted simultaneously. In this case, the eNB will need to be able to distinguish between SURS requests sent by different UEs. The SURS may contain a UE identity (e.g., the C-RNTI or related identifier) to allow the eNB to distinguish between the SURS messages sent by each UE.

### Structure of the SURS Message

The SURS may contain some information transmitted by the UE. For instance, it may contain the transmit power or the power headroom (relative to the maximum power, which could be derived from the geolocation database). It may also contain the C-RNTI or some other UE ID that allows the eNB to distinguish between two different transmissions of the SURS in the case where multiple UEs transmit the SURS at the same time. Because timing and frequency synchronization in the UL for a specific UE has not been performed at the moment when the SURS is transmitted, the information in the SURS cannot necessarily be transmitted directly. Instead, the UE may transmit one or several orthogonal ZC (Zadoff Chu) sequences where each ZC sequence corresponds to a potential UE ID, transmit power/power headroom, or a combination thereof. The ZC sequences could be obtained in a similar fashion as the 64 RACH preambles that may be transmitted during the RACH procedure. In other words, selection by a UE of a specific RACH preamble would correspond to a transmit power/headroom value, or a UE ID, or a combination of identity and power headroom. As a result, a UE could choose from a finite number (e.g., 64) of combinations for specifying the UE ID and/or power headroom.

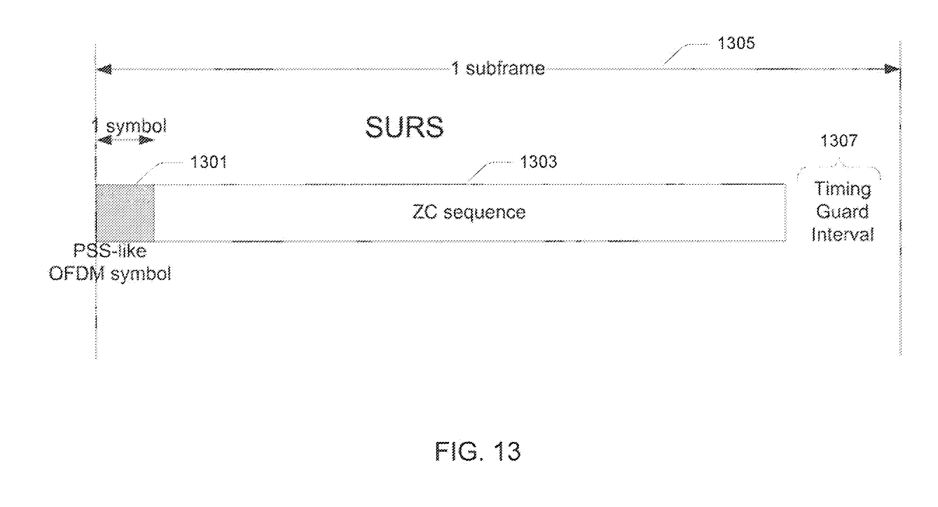

In the existing Rel-8/10 RACH procedure, the eNB is able to determine the RACH preamble transmitted and the uplink timing offset for that specific UE through a correlation operation with the known ZC sequences because it is assumed that the eNB and the UE are frequency synchronized. In this case, the UE has already performed frequency synchronization via the PSS/SSS. In fact, the absence of proper frequency synchronization (such as the case of frequency offset due to oscillator drift), the correlation peaks obtained from the ZC sequence may occur in the wrong interval, which would cause the eNB to detect the wrong ZC sequence transmitted [11]. Since the SURS transmitted by the UE will likely not be frequency synchronized with the eNB receiver in the DSS band, we propose that the SURS contains also a fixed well-known PSS-like signal that precedes the ZC sequence. The proposed SURS signal may therefore take the form shown in FIG. 13, where the PSS-like signal 1301 could span a single OFDM symbol while the ZC sequence 1303 would occupy the remainder of the subframe 1305. In addition, to avoid potential interference with other UEs that may already be transmitting in the same channel, the SURS signal could span less than a subframe to account for a timing guard interval 1307 to mitigate interference from UL timing offset in the UE when the SURS is transmitted. Alternatively, the SURS may span multiple subframes.

The eNB, upon receiving the SURS, uses the unique PSS-like signal (known) transmitted by the UE to determine the coarse frequency offset for that UE. In addition, it uses that information to help in decoding the ZC sequence and the resulting information that it carries (i.e., removes any ambiguity created by the frequency offset when decoding the ZC sequence in the SURS). If the eNB decides to configure a UL-only cell with that specific UE, it would then send a UL-only configuration message to the UE to establish the UL-only cell. The configuration may contain the following information:
The frequency offset the UE should apply to its oscillator, which was determined by the eNB from the PSS-like symbol;
The timing offset the UE should apply, determined from ZC sequence;
The initial transmit power the UE should use for transmission on the UL-only cell;
The cell ID associated with the UL-only cell;
UL grants for the UL-only cell would be made by the eNB using scheduling from the PCC or SCC using the cell ID of the UL-only cell (sent above in the configuration).

2.2 Non-Co-Channel Synchronization Schemes

In section 2.1, we have defined a SURS signal that is used to establish the need for UL-only transmission and to establish a UL-only cell. The problem of establishing and maintaining synchronization and power control for this UL-only cell is explored in this section for the case of non-co-channel synchronization. The schemes discussed in this section apply both to the cases where synchronization is done through a single (one-shot) transmission of a synchronization sequence, and where it is done periodically in order to address periodic frequency adjustment of frequency drift. The SURS defined in section 2.1 could serve the purpose of the one-shot signal that is described in this section.

The non-co-channel synchronization case is characterized by the scenario where traditional synchronization signals (PSS/SSS) cannot be sent by the eNB in the same band as the UE transmission. In the first embodiment, synchronization in this case is achieved by having the UE send a well know synchronization sequence such as a ZC sequence either in a burst fashion (during initial connection) or in a periodic fashion. This synchronization sequence could be destined for the eNB in the cases of UL-only operation between a UE and eNB or D2D communication where the eNB provides the frequency synchronization service. The synchronization sequence could also be destined for a peer UE in D2D communication when the synchronization service is provided by the peer UE. The synchronization sequence is received by either the eNB or a peer UE (in the case of D2D communications where frequency correction commands are sent by the peer UE). However, it would be impossible for the receiving device (the eNB or the peer UE in this case) to adjust its own frequency oscillator to match that of the UE for a specific reason. For instance, in the case of an infrastructure scenario (UE to eNB), the eNB cannot adjust its frequency offset to match that of the UE because it may receive data from multiple UEs on the DSS bands and it would be impossible for it to have its frequency adjusted simultaneously for each of these UEs. In the case of D2D communication, the peer UE that receives the synchronization signal may already be in a D2D communication with another UE on the same frequency, and also cannot change its current frequency to accommodate the new UE (which transmitted the synchronization symbol). As a result, the eNB or peer UE may compare the sync sequence received from the UE with its own local frequency reference and send feedback to the UE to allow it to readjust the UE's transmission frequency. As a result, it is the UE that sends the synchronization sequence, which then adjusts its own frequency oscillator to tune its frequency of transmission based on the feedback received from the eNB or peer UE. This feedback can be sent on a different band or different logical or physical channel directly to the UE. It can also be sent through an intermediary device or node. For example, in the D2D case, the peer UE may send the feedback directly to the UE that transmitted the synchronization sequence, or it may send it through the eNB, which relays it to the UE that transmitted the synchronization sequence.

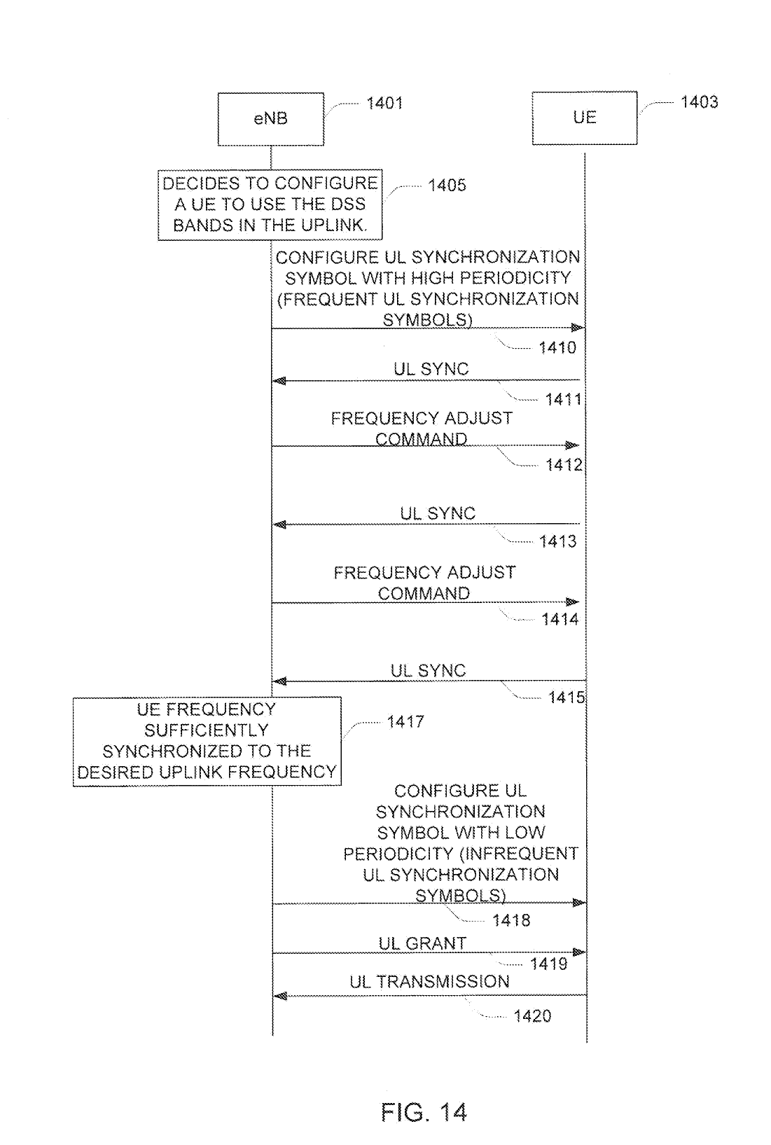

In the case of a UE transmitting using UL-only operation to an eNB, the eNB may send frequency adjustment commands to the UE on the PCell or on a different band than the UL frequency to change the uplink frequency based on the measured offset in the synchronization symbol received by the eNB. As a result, before any uplink grants are made to a specific UE, the eNB sends one or more frequency adjustment commands in order to have the UE synchronized on the appropriate frequency prior to sending the grant. Regular synchronization symbols (sent with some periodicity) could then be used to maintain frequency synchronization and avoid frequency drift of the UL oscillator at the UE with respect to the eNB. The flow diagram of FIG. 14 shows exemplary high-level information flow for this exchange of messages between the eNB 1404 and the UE 1403 in this case. In FIG. 14, the messages directed from the UE 1403 to the eNB 1401 are sent over the DSS bands while messages directed from the eNB 1401 to the UE 1403 are sent over the PCell (or the licensed band). Prior to actual data transmission, the UL frequency can be synchronized by the exchange of one or more UL sync transmissions by the UE (combined with the corresponding frequency adjust command). When data transmission starts, occasional or periodic UL sync transmissions can continue to be made by the UE, and the eNB can occasionally send a frequency adjustment command so that frequency synchronization is maintained and UL frequency drift is avoided.

At 1405, the eNB 1401 decides to configure a UE to use the DSS bands for UL-only communications. Thus, at 1410, the eNB sends a configuration message 1410 to the UE 1403 informing the UE to start sending sync signals to the eNB with high periodicity, i.e., relatively frequently. Thereafter, the UE 1403 will send sync signals, e.g., 1411, 1413, 1415, with the designated high periodicity, and the eNB 1401 will respond with appropriate frequency adjustment commands, e.g., 1412, 1414. When the eNB determines (as shown at 1417) that the UE is sufficiently frequency synchronized with the eNB, it sends another configuration message 1418 to the UE informing the UE to start sending sync signals to the eNB with a lower periodicity, relatively less frequently. At that point, the eNB 1401 sends a UL grant 1419 to the UE, after which the UE may start transmitting data in the uplink (1420).

Alternately, the synchronization signals sent by the UE could be sent following a request by the eNB, or can be sent at specific known instances. For example, the UE could send a synchronization symbol at the beginning of a UL transmission or burst of transmissions. This synchronization could be triggered by the eNB sending a command, or it could be implicit in the UL grant made on the UL-only component carrier. Because the UL-only carrier is used in conjunction with a licensed LTE cell, the eNB can instruct the UE as to when to send the synchronization signal, and therefore the need of sending this periodically (as well as the associated overhead) would then be reduced.

2.2.1 Possible Embodiments for D2D Communications

The aforementioned invention can be realized in several different ways for D2D communications, as described in more detail hereinbelow. In the case of D2D communications, two UEs that wish to communicate need to synchronize in both time and frequency prior to transmission of data to each other. In this case, one of the peer UEs transmits a synchronization symbol and in response to an adjustment command, will adjust its frequency of transmission (as well as potentially its transmission time) based on the adjustment command.

The following embodiments are possible for how these signals may be transmitted and received. It should be noted that the two frequency bands involved in the messaging in each of the embodiments below (assumed licensed and DSS bands for the purpose of the descriptions) could correspond to any two distinct frequency bands for the purposes of the procedure.

The subsections that follow give specific embodiments for the actual form of the synchronization signal transmitted by the UE for the case of LTE.

### eNB Serving as Synchronization Reference

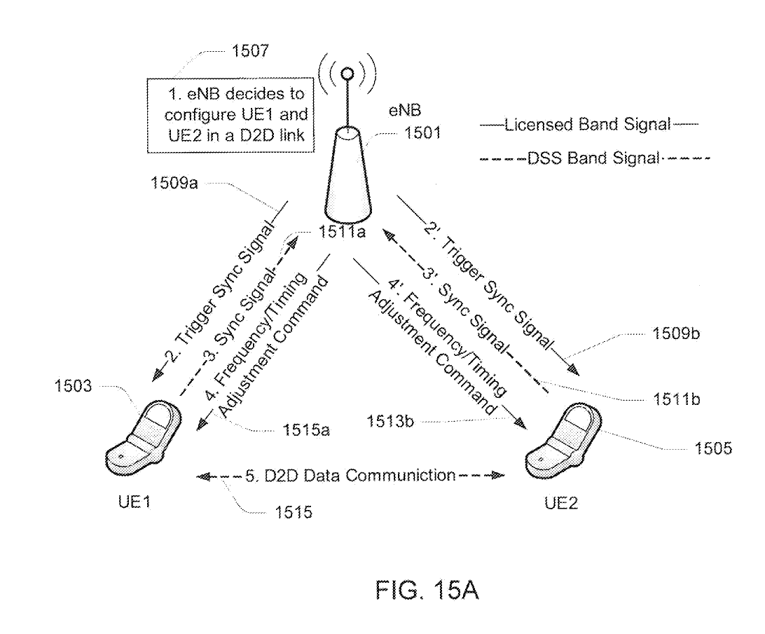

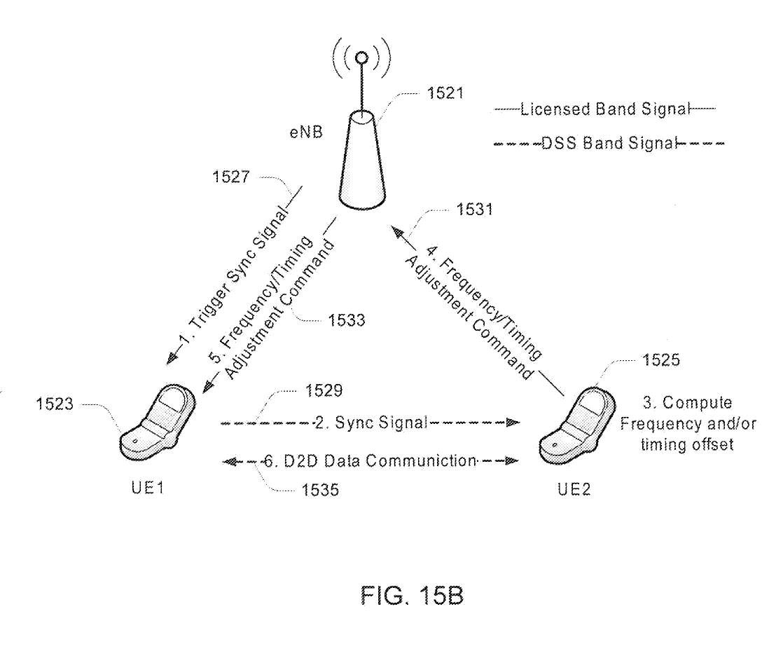

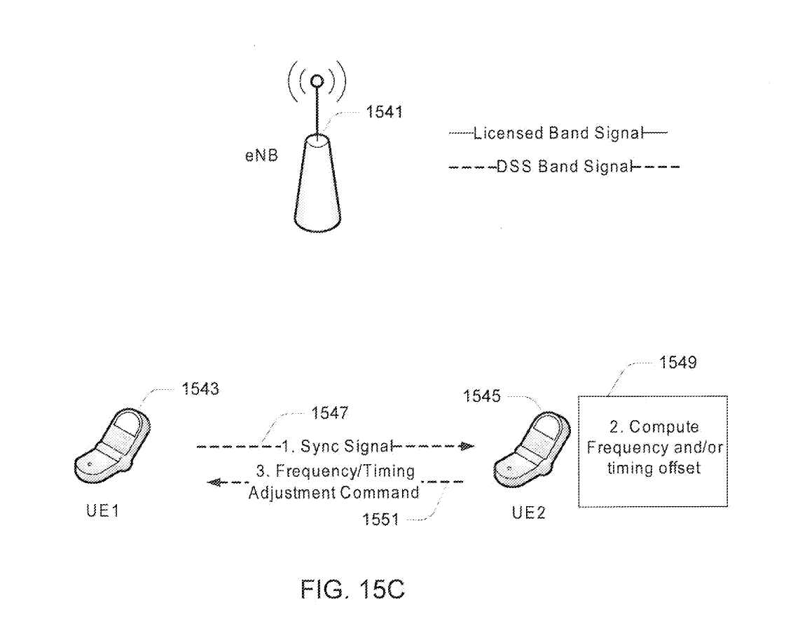

In the first embodiment illustrated by FIG. 15A, the eNB 1501 serves as the frequency reference for the UEs 1503, 1505 involved in the D2D communication, but it does not transmit on the band in which the D2D communication will occur. In that case, the adjustment command for both peer UEs is provided by the eNB on another band. The two peer UEs 1503, 1505 may be connected to an eNB 1501 on a specific band (in this case, assumed to be the licensed band). The eNB may decide (step 1507) to trigger D2D communication between two UEs on another band (in this case, assumed to be the DSS band). The eNB 1501 notifies the two UEs 1503, 1505 of the need to start D2D communication between them, and will trigger messages 1509a to UE 1503 and message 1503b to UE 1505 to send a synchronization signal to the eNB on the DSS band to initiate the frequency synchronization (message 1511a from UE 1503 to eNB 1501 and message 1511b from UE 1505 to eNB 1501).

The eNB, after computing the frequency offset, sends the frequency adjustment commands to the UE via the licensed band (message 1513a to UE 1503 and message 1513b to UE 1505). The DSS bands are not yet used in this case because the UEs themselves have yet to synchronize with the eNB on this band, or because the eNB is not allowed to transmit on this band due to potential interference that it may cause.

The above steps are repeated and performed for each of the peer UEs until proper synchronization is achieved for the peer UEs and the peer UEs can start D2D communication on the DSS bands (step 1515).

### eNB Serving as Relay for the Synchronization Reference Provided by the Peer UE

In a second embodiment, the synchronization signal transmitted on the DSS bands is sent to one the peer UE selected by the eNB, on a specific channel as indicated by the eNB and the peer UE computes the frequency offset or timing correction (as appropriate). In order to communicate the adjustment command to the UE that transmitted the synchronization signal, the eNB is used as a relay. In particular, the adjustment command is sent from UE2 (the UE that receives the synchronization signal) to the eNB through its link on the licensed band and the eNB sends the same adjustment signal on licensed band to UE1 (the UE that sent the synchronization signal). FIG. 15B illustrates the basic steps in this embodiment and indicates on which band each signal is sent.

The eNB 1521 decides to initiate a D2D communication between UE1 1523 and UE2 1525 on the DSS bands. This can be done by triggering a synchronization signal with UE1 (message 1527 from eNB 1521 to 1523).

UE 1523 transmits a synchronization signal 1529 over the air on the DSS bands. UE 1525 is expected to receive this signal (either it was notified by the eNB or it constantly listens for synchronization signals that may come from other UEs at specific time instants).

UE 1525 computes the frequency and timing offset based on the synchronization signal received from UE 1523.

Since UE 1525 may already have a D2D connection with another UE and thus be unable to adjust its own frequency, it transmits a frequency/timing adjustment signal 1531 or message via the licensed band to the eNB 1521 (using uplink resources it has available). This could consist of sending the message in the SRS, RACH, on dedicated PUCCH resources, or multiplexed with data intended for the eNB

The eNB 1521 recognizes the UE 1523 for which the adjustment command it has received is intended for, and forwards this information (received from UE 1525) to UE 1523 in the DL on the licensed band (message 1533). The eNB may use one of a number of resources in the DL to transmit this information to UE1 (e.g. PDCCH, ePDCCH, MAC CE, or multiplexed with data intended for UE1 in the PDSCH).

UE 1523 makes the appropriate adjustment to its frequency/timing of transmission on the DSS bands. If no further transmission of synchronization and adjustment commands is needed, D2D communication between UE1 and UE2 can commence (1535).

### Peer UE Serving as Synchronization Reference

The previous two embodiments are used for cases where initiation of the D2D link is required. In addition to this, timing and frequency offset need to be tracked periodically in steady-state of the D2D link. Because the D2D communication has already been initiated, any frequency or timing adjustment commands can also be transmitted on the D2D link (since the peer UEs are synchronized sufficiently to be able to communicate information over the DSS bands). As a result, this type of “closed-loop” synchronization procedure may be implemented as illustrated in FIG. 15C.

UE 1543 transmits periodically or occasionally a synchronization sequence (1547) to UE 1545.

UE 1545, which expects the transmission of synchronization sequence from UE 1543, receives the sequence and computes the required frequency and/or timing offset (1549).

UE 1545 transmits the frequency or timing adjust command (1551) directly to UE 1543 over the DSS bands as part of the D2D communication. The adjustment command 1551 can be transmitted using specific resources that UE2 has available when communicating to UE1. For example, this could be specific resources on the PUSCH or specialized SRS that UE 1543 is aware of and must decode to receive this signal, or it can transmit the signal multiplexed with other data on the PUSCH.

This embodiment can also be combined with a previous embodiment to yield a method for coarse and fine frequency and timing adjustment that can be used for D2D communication. For instance, upon initialization of the D2D communication, or following a large time where no D2D communication between the two UEs has occurred, a coarse synchronization is performed using one of the two previous embodiments and involving the eNB 1541. Once coarse synchronization has been completed, a fine synchronization can be performed during transmission or at periodic intervals, as illustrated in FIG. 15C.

2.2.2 UL Sync and Feedback Using SRS

In one embodiment, the UE uses the sounding reference signal (SRS) to send the frequency synchronization signal. In Rel-8 LTE, the SRS is transmitted regularly by the UE for the eNB to estimate the uplink channel quality at different frequencies. Because the SRS is transmitted to the eNB regardless of whether the UE has an uplink grant on a specific subframe, re-use of the SRS for synchronization is therefore preferred as it would allow each UE to be synchronized to the eNB or to its corresponding peer UE, regardless of the amount of uplink traffic being expected for the UE. The SRS could be used for frequency synchronization in the steady state of communication (i.e., frequency or timing tracking). In the case where synchronization by the UE that needs to operate in UL-only mode is not time critical, it could also be used for initial acquisition of the frequency sync.

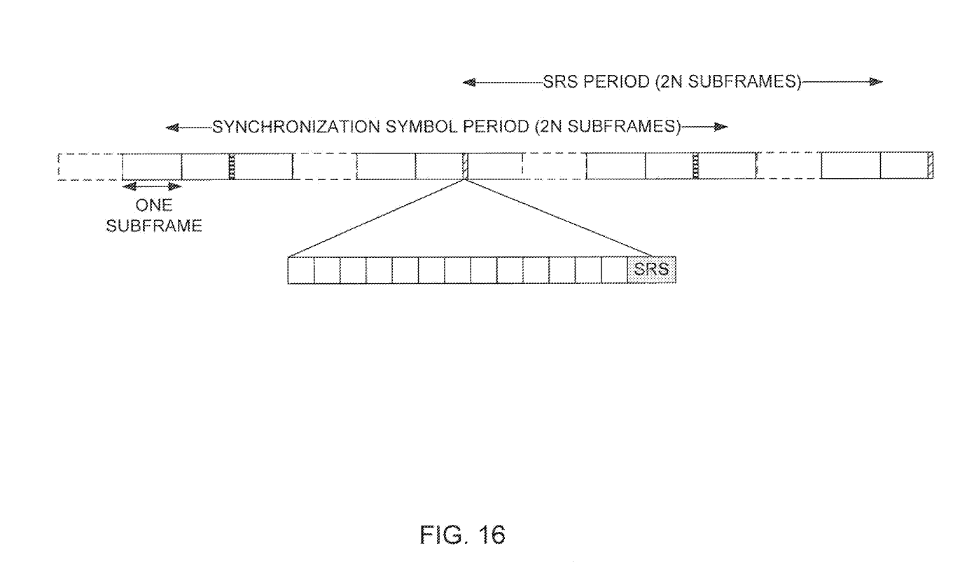

In one embodiment, the SRS is periodically replaced with an uplink synchronization sequence to be transmitted by the UE. Since the periodicity of the SRS signal is itself configurable by the eNB, the eNB also may configure the periodicity of the replacement of the SRS with a synchronization signal. In FIG. 16, the eNB configures SRS with a period of N subframes, and also indicates that every other occasion that would normally be used to send SRS should be used to send a synchronization signal to the eNB or to a peer UE. The advantage of a configurable periodicity for the synchronization signal is that the eNB can instruct a UE to transmit this signal more often for a UE that has recently joined and will start using the DSS bands, or that has recently lost synchronization due to a change of DSS band channel due to the presence of an interferer that has limited the use of DSS bands for some time.

The signaling involved in changing the periodicity of the uplink synchronization symbol will be sent by the eNB through the PCell or the licensed band so that availability of the channel is not an issue for sending this signaling.

2.2.3 UL Sync and Feedback Using RACH

In LTE release 10, uplink timing adjustments are made during the Random Access procedure. One approach to maintain proper UL timing is for each UE to perform the Random Access Procedure periodically. Embodiments include methods to synchronize at a single time, synchronize periodically, or synchronize aperiodically by control of the eNB.

In one embodiment, the frequency synchronization signal is included within the RACH preamble. The UE may use the existing RACH preamble, or the allowable RACH preambles may be modified to contain a sequence with which the eNB or the peer UE can determine the frequency offset. A longer sequence can be used, if needed, by having the RACH sequence extend over multiple RACH occasions or multiple consecutive subframes. For instance, the eNB could avoid scheduling of UL data by other UEs for the case where the RACH may occupy multiple consecutive subframes in order to avoid interference with transmissions by other UEs. Alternatively, the eNB may temporarily disable transmission of RACH by other UEs until the UE that needs to synchronize can transmit its RACH with the preamble containing the frequency synchronization signal. In this case, the synchronization sequence may occupy multiple (continuous or non-continuous) RACH occasions or resources.

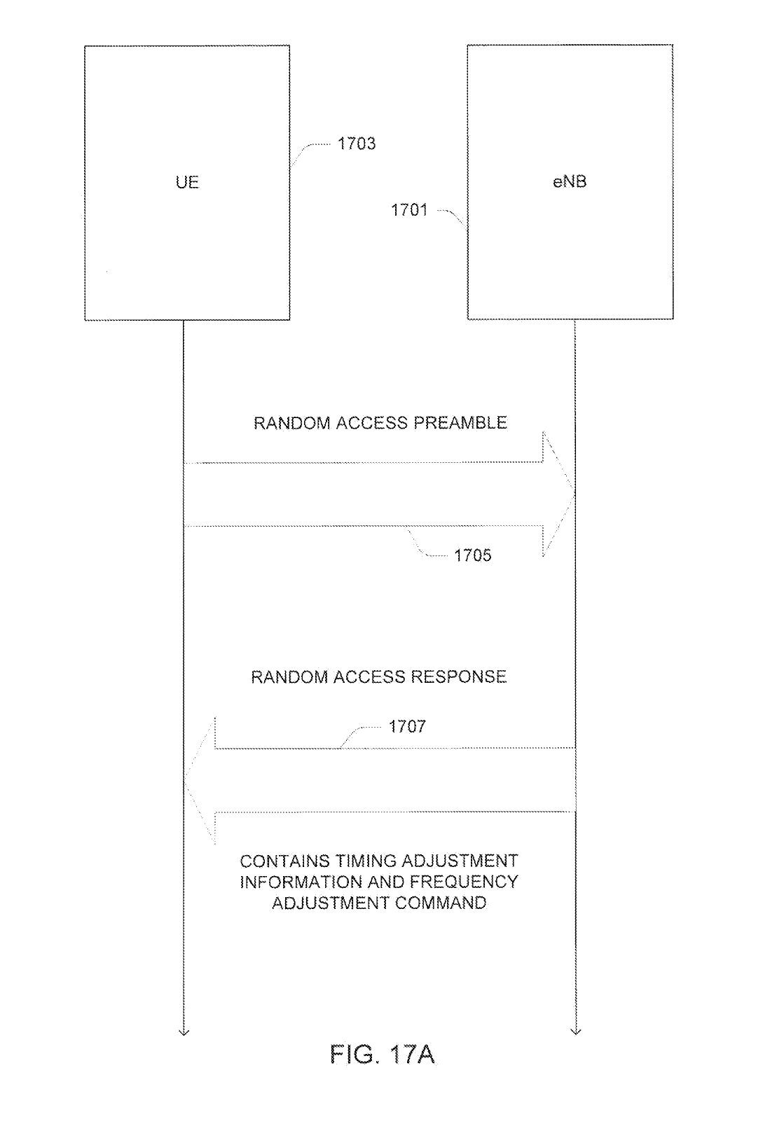

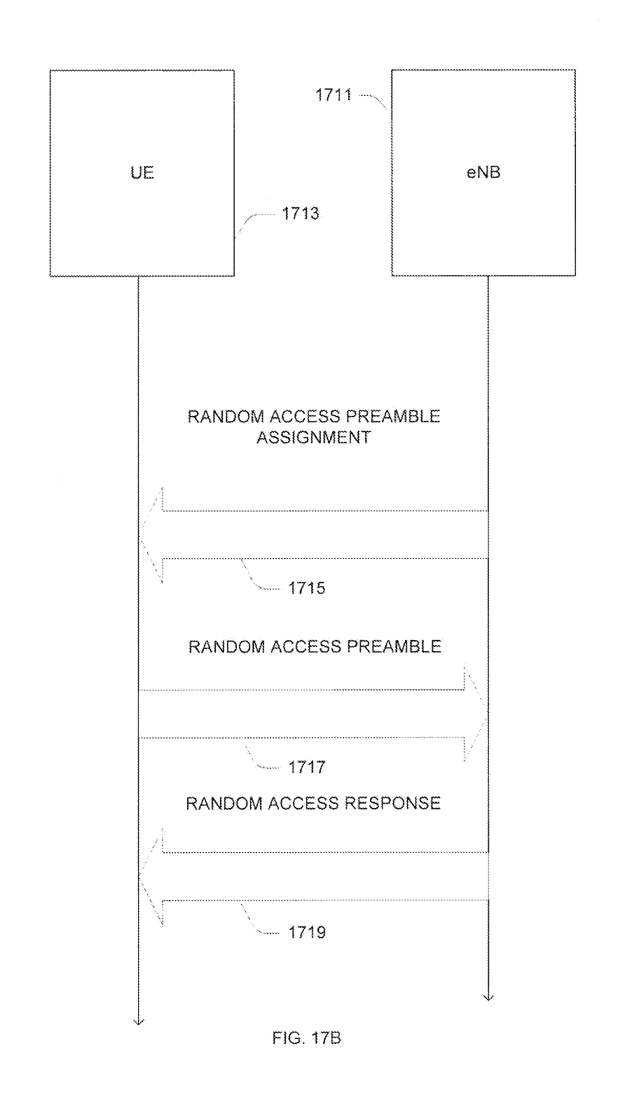

In one embodiment as illustrated in FIG. 17A, the UE 170B initiates the Random Access procedure by sending a Random Access Preamble 1705 in the uplink to the eNB 1701 using the Random Access Channel. The UE could use the existing format of the RACH preamble to transmit the sync signal to the eNB. In this case, the eNB 1701 would ensure a limited number of ZC sequences can be used when transmitting the synchronization signal and therefore, that only a few UEs are configured to potentially transmit the RACH preamble at a given time (to avoid collision given the reduced number of RACH preambles). As mentioned in [11], a frequency offset will limit the number of ZC sequences that the eNB can reliably decode. Given the reduced number of RACH preambles that can be received, the eNB will be able to determine the correct timing and sequence that was transmitted despite the frequency offset. The frequency offset could then be corrected separately (using perhaps another method mentioned in this disclosure) after completion of the RACH procedure.

Alternatively, the RACH preamble could be modified to allow both frequency synchronization and timing offset to be corrected simultaneously. One way would be to have a UE transmit a known PSS-like signal, which allows the eNB to determine the frequency offset between the UE and the eNB in the UL. This PSS-like signal could be transmitted within the RACH preamble (assuming different UEs could transmit orthogonal PSS-like symbols that would not collide). Alternatively, each UE could utilize the same PSS-like signal and the eNB would schedule the different UEs that are to perform the RACH procedure to send the PSS-like signal at different (known) times. The PSS-like signal could be scheduled by the eNB to be transmitted a number of OFDM symbols or a number of subframes prior to the RACH preamble. This number would be specific to each UE, so that there is no risk of collision between the PSS-like signals transmitted by different UEs. Alternatively, a new combined SynchRACH signal could be sent using two consecutives subframes where the selection of the first subframe is done randomly as per current RACH procedure, where, in the first subframe, a PSS-like signal is sent, followed in the second subframe by a regular RACH preamble.

The eNB 1701 responds with a Random Access Preamble Response 1707 that includes an uplink timing adjustment as well as the frequency adjustment command. To maintain synchronization, the UE may do this periodically as needed to maintain synchronization and compensate for any drift. Another way would be for the eNB to signal the timing information using PHY signaling, MAC CE, or RRC signaling, etc.

In LTE release 10, the next step in the RACH involves the L2/L3 Message, which contains, among other things, an RRC connection request. Some information may not be needed in the case of UL-only synchronization if an RRC connection already exists. The spare bit on the L2/L3 message may be used to indicate that this is a synchronization and not a normal Random Access Procedure. The RRC information fields may be re-used to indicate the timing of the next synchronization or set the periodicity. There also may be a bit indicating that the rest of the Random Access Procedure messages are not needed. Thus, the eNB may save resources by not finishing the LTE Release 10 random access procedure.

Since it is expected that the eNB could make the decision to activate UL-only operation, it may be useful for the eNB to initiate the synchronization. For example, in the case of D2D communication, the eNB may initiate the D2D link between the two UEs, and therefore, it will trigger one of the two UEs (or both UEs, depending on the scenario given in section 2.2.1) to transmit RACH in order to start the synchronization procedure. Thus, in an alternate embodiment illustrated in FIG. 17B, the eNB can initiate the timing adjustment using what is called a Contention Free Random Access Procedure. When the eNB 1711 wants one or more UEs to synchronize, it can send a Random Access Preamble Assignment 1715 instructing the UE(s) 1713 to synchronize. The UE 1713 responds with a Random Access Preamble 1717 as in a normal random access procedure and is followed by the Random Access Response 1719 with the timing adjustment, frequency adjustment and power control. Thus, the eNB can aperiodically control the synchronization of a UE. The timing of the Random Access Preamble Assignment may be standardized to accommodate coexistence gaps.

In LTE release 10, the Random Access Procedure is followed by a Message for Contention Resolution. Since this message and later messages may not be needed, the Message for Contention Resolution can be re-used to send either the period of the synchronization, or an allocation timing of the next synchronization.

In addition, to allow for frequency synchronization in addition to (or in lieu of) timing advance information, the RACH response from the eNB can be modified so that it contains frequency synchronization adjustment information (rather than just timing adjustment information as in LTE today).

2.2.4 Use of a New Synchronization Procedure for UL Sync and Feedback

The RACH procedure in LTE is used specifically to address timing alignment. In particular, a RACH is triggered when the timing alignment timer has expired, in which case an RRC connection needs to be re-established.

For the case of frequency synchronization in UL, it may be advantageous to define a new procedure for UL sync and feedback that is different from the RACH procedure. In particular, it would allow the UE to trigger this procedure independently of the RACH procedure.

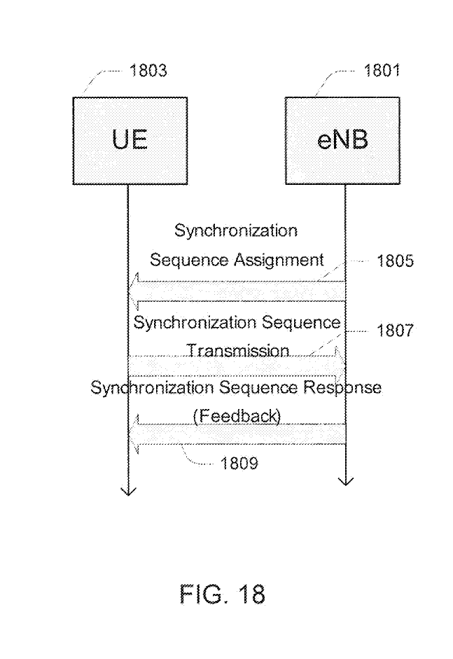

In the new synchronization procedure as shown in FIG. 18, the eNB 1801 would make some assignment of the synchronization sequence to be used (message 1805). This assignment could be done through RRC signaling or through a mechanism similar to the RACH preamble assignment, and could be done on a separate band (i.e., it would not use the UL-only cell). The assignment could specify particular subframes (and potential resource blocks) which each UE could use to transmit the synchronization sequence to the eNB. When the UE 1803 needs to transmit the synchronization sequence (e.g., following expiry of a synchronization timer), the UE will transmit the synchronization sequence in the next available resource dedicated for the sequence on the UL-only cell (1807). The eNB 1801 will receive the synchronization sequence from a given UE and compute the frequency offset that specific UE would need to apply.

The synchronization sequence 1807 transmitted may be similar to the modified RACH preamble discussed in section 2.2.3 in order to allow both frequency and time synchronization to take place. In this case, it would consist of a PSS-like signal followed (immediately or after some specific delay) by a ZC-sequence. Alternatively, the eNB may decide to perform only synchronization of frequency or synchronization of time separately. In this case, the synchronization sequence assignment message could indicate which sequence (PSS-like or RACH-like) would need to be transmitted. The UE may use specific ZC sequences associated with the UE ID to avoid collision in the case of transmission by multiple UEs simultaneously. The PSS-like sequence may be unique and transmitted at non-overlapping times by the UEs. To ensure efficiency, the timing and frequency synchronization could be separated. The eNB could ensure proper timing alignment first (by transmission by the UE of a RACH-like signal and correction of the timing offset), and then have each UE transmit a PSS-like signal in subsequent OFDM symbols. Seeing that timing alignment has been achieved, 14 UEs could then theoretically transmit the synchronization sequence in a single subframe.

The eNB would then send the offset or feedback to the UE through a synchronization sequence response message (1809), which also would not be sent on the UL-only cell, but on the control cell (e.g., the licensed band). As it is assumed that the UE is still synchronized on the licensed band, the synchronization sequence response message 1809 could be sent on that band via a MAC CE, special PDCCH message, or higher layer signaling (e.g., RRC).

2.2.5 UL Sync Incorporated into Data

In order to avoid explicit transmission sync by all UEs that may use a UL-only operator, the UL sync signal could also be incorporated into the UE's data transmission. This allows more flexibility for the UE to use a larger amount of resources (more symbols or spanning the symbols over a greater number of PRBs) for the UL synchronization signal. It also avoids any potential interference between UL synchronization symbols sent by several different UEs. Finally, the eNB or peer UE does not need to identify the synchronization symbol sent by each UE, as the symbol will be sent along with the UL data (and so it will be identified by the grant).

In this embodiment, one or more OFDM symbols are dedicated to the UL sync signal and the remainder of the resources in the UL grant are used for data. In order to have the synchronization symbol span the maximum frequency band, the symbol can be defined over all RB's allocated to the UE. The actual number of OFDM symbols associated with the synchronization signal could be fixed (by specific rules) or could be configured as part of the UL grant sent by the eNB.

The UL grant sent by the eNB also could determine the amount of resource elements to be used for the synchronization symbol. For instance, following a long period of time where a particular UE has not transmitted in UL-only operator (and therefore, there is a larger risk of frequency offset), the eNB or peer UE could request a longer synchronization symbol to improve decoding of the symbol and determination of the frequency offset to be corrected. This long period of time could be implemented by a Frequency Alignment Timer (discussed in the next section).

The UE will insert a known synchronization sequence (for example, a sequence similar to the PSS/SSS in LTE today) into the resource element locations that are reserved or allocated for the synchronization sequence. The other resource elements associated with the UL grant may be populated with data. Upon reception of the UL transmission from the UE, the eNB or peer UE will decode the synchronization symbol to determine the frequency offset and send the adjustment command through the licensed band or the DSS band (depending on the use scenario (as documented previously)). In addition, the eNB may attempt to decode the data portion of the transmission and communicate the HARQ ACK/NACK as is currently done today. Although the probability of correct reception may be reduced due to frequency offset (especially in the case where the UE has not transmitted in the UL for quite some time), combining with future redundancy versions which have a smaller frequency offset could allow for correct reception overall. In some scenarios, the UE will need to send a very large synchronization sequence compared with the resources that can be permitted for a UL grant. In this case, it is also possible for the UL grant by the eNB to request a synchronization sequence that occupies the entire UL resource allocation. In this case, an ACK/NACK is not needed, or could be used to send the frequency offset correction, timing offset correction, or power control commands, as the case may be.

The transmission of the frequency offset correction by the eNB or peer UE could take several forms. The eNB or peer UE could transmit a MAC CE on the licensed band with the frequency offset correction, or a MAC CE that contains both the timing advance correction (TAC) and the frequency offset correction. Alternatively, the eNB could send the frequency offset correction with the ACK/NACK to the data sent along with the synchronization symbol (encoded with the PHICH or with the next UL grant that requests a retransmission of the UL data in question). A peer UE could send the frequency offset correction with its own data transmission destined for the other UE using the PUSCH. Finally, a completely separate PDDCH message (similar to power control commands sent using DCI format 3) can be sent by the eNB following the reception of a synchronization signal in order to correct the frequency offset.

After a particular number of UL transmissions by the UE, the frequency offset should be small enough that correction is not needed, or can be provided with a minimal amount of synchronization information sent by the UE. In this case, the eNB can instruct the UE to stop sending dedicated synchronization information as part of the UL data. Instead, the eNB or peer UE could rely on the demodulation reference symbols (DM RS) sent by the UE for channel estimation to perform any residual frequency offset. In this case, the frequency offset correction may be sent less often than the case where dedicated synchronization symbols are needed, in which case, a dedicated signal (such as a MAC CE or DCI format) to perform the frequency correction may be most applicable. The frequency in which DM RS is sent by the UE, or the type of signal sent in the DM RS also could be modified to allow for better frequency synchronization in this “steady-state” mode.

2.2.6 Transmission of the Frequency Adjustment by the eNB

This section addresses different options for the transmission and structure of the frequency correction message that is sent by the eNB to the UE after the eNB receives the synchronization signal from the UE. The frequency correction message may take on different forms depending on how the synchronization signal was transmitted by the UE (e.g., one shot sequence in a RACH-like procedure or continuous transmission of the synchronization sequence in the data).

### Transmission of the Frequency Adjustment in a MAC CE

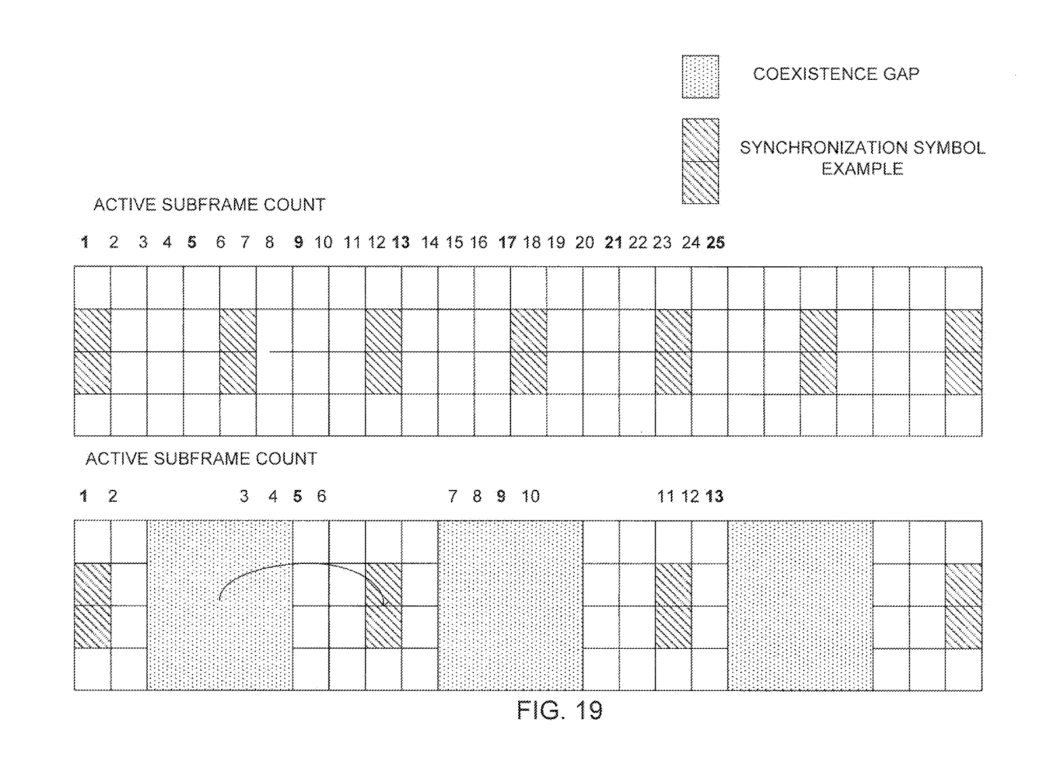

The eNB may send a frequency adjustment command using a MAC CE command containing a new Logical Channel Identification (LCID) value, as shown in the table of FIG. 19. The MAC CE command could be a one octet message representing the adjustment step in Hz. For example, if the UE receives a MAC CE command with the corresponding LCID of the Frequency Adjustment command, the octet contained in the MAC CE could represent a shift in frequency, from −127 Hz to 128 Hz, where the shift in frequency in Hz equals the binary value of the octet minus 127 Hz. For example, 11111111 represents 255 Hz-127 Hz or a shift of 128 Hz. A UE receiving such a MAC CE command would readjust local clock to increase the transmitting center frequency by 128 Hz. Alternatively, the MAC CE command include a scaling factor in Hz in a second octet. For example, if octet 1 is 11111111 and octet 2 is 00000011, the UE would increase its operating frequency by 128 Hz times 4 or 512 Hz.

| Index | LCID values |
|---|---|
| 00000 | CCCH |
| 00001-01010 | Identity of the logical channel |
| 01011-11001 | Reserved |
| 11010 | Frequency Adjustment |
| | Command |
| 11100 | UE Contention Resolution |
| | Identity |
| 11101 | Timing Advance Command |
| 11110 | DRX Command |
| 11111 | Padding |

### Transmission of the Frequency Adjustment in the PDCCH

Another approach is to modify grants used for UL carriers such as DCI format 0 or 4, to include a new field, referred to hereinafter as Frequency Shift Control—typically a two bit field that could order the UE to decrease or increase the operating frequency. The shift could be scaled through semi-static configuration RRC. For example, an RRC message may inform the UE that a+1 shift means that the operating frequency must increase by 50 Hz.

### Transmission of the Frequency Adjustment in a DL Data Allocation

Yet another approach would be to include or “piggyback” frequency adjustment messages with DL data. The eNB could indicate in the PDCCH (or use a special DCI format to signal this) that the data allocation will contain a special field for the frequency adjustment to be applied by the UE. Alternatively, this field could be always contained within the data allocation and the UE would then simply apply the frequency adjustment in the case the transmitted Frequency Shift Control is non-zero. The shift control could be scaled through semi-static RRC configuration as mentioned. In addition, the actual shift control could represent the actual frequency shift (in kHz for example) using a binary two's complement representation of this shift.

2.2.7 Validity of the Frequency Alignment

The eNB may ensure the validity of the frequency offset for each UE through the use of a frequency alignment timer (FAT). In this case, each UE will maintain a frequency alignment timer, which is started or restarted upon reception by the UE of a frequency offset adjustment command. This timer can be used to ensure that transmissions made by the UE when the frequency offset has drifted by a large amount are made without causing interference and can be corrected. For instance, the UE may be allowed to transmit in UL-only operation when the FAT (as well as the timing alignment timer) has not expired. Alternatively, if the FAT has expired, the UE may be required to transmit only a synchronization sequence upon its next grant in order to obtain initial frequency synchronization. In this way, the format of the SURS or the synchronization sequence transmitted by the UE could depend on whether the FAT has expired or not. For example, in the case of UL sync incorporated into data (described in the previous section), a non-expired FAT could result in sending only sync in the DMRS or using a limited number of reference symbols, while an expired FAT could cause the UE to transmit only synchronization data in the uplink transmission, or a relatively large number of resource elements associated with the synchronization data.

Alternatively, the UE may use the existing timing alignment timer. In this case, frequency offset adjustment commands are sent by the eNB at the same time as timing alignment or timing advance commands. When the UE's timing alignment timer has expired, the UE will transmit a synchronization sequence that could be transmitted in addition to the RACH sequence required at the expiring of the timing alignment timer today.

Finally, the UE may apply a larger power backoff to transmissions, or use more stringent out of band emission mask for the transmission when the FAT has expired in order to avoid potential out-of-band interference that could be caused by a large frequency offset.

2.2.8 Synchronization Scheduling Methods

In the presence of coexistence gaps, the uplink reference symbols need to be managed in order to maintain synchronization for all UEs.

The eNB can schedule reference symbols using an uplink grant on the PDCCH. This may be done aperiodically if direct control over the timing is needed. Alternatively, a semi-persistent schedule can be defined such that the UEs will know when to transmit the reference symbols. This method has the advantage of saving PDCCH resources once the initial uplink grant is defined. If there is a change in the duty cycle for the coexistence gaps, then the scheduling may need to be changed. The following solution for coexistence gap adaptation may be implemented:
1. The eNB can reschedule all affected UEs with a new semi-persistent duty cycle via an uplink grant on the PDCCH.
2. The UEs may dynamically adapt to the coexistence gaps if they have knowledge of the gap scheduling. UEs may use the same scheduling except delayed by the gap timing. An example of this is illustrated in FIG. 19:

The UE may need to know which of the two options is being used. An RRC configuration could be defined or the method used could be standardized, etc.

2.2.9 UL Sync and Feedback Using SRS in the Presence of Coexistence Gaps

In LTE release 10, the Sounding Reference Symbols (SRSs) are constructed using Zadoff-Chu sequences, which have autocorrelation properties that can be exploited to maintain synchronization once initial synchronization is achieved. These may be sent periodically as configured using RRC signaling. However, in the case of DSS band aggregation, there may exist gap periods whereby a UE would not be able to send SRSs and thus there is a risk of losing synchronization in such scenarios.

One solution is for the eNB to schedule the SRSs with an uplink grant on the PDCCH when an SRS will be missed due to this gap. When there will be a gap, the eNB observes UEs that will miss their SRSs. The eNB will schedule these SRSs with an aperiodic SRS when the next opportunity arises. The eNB may schedule the UE who has waited the longest to send an SRS or who has the highest QoS requirement, etc.

2.3 UL Power Control for Cases of No DL Transmission in the Same Band

This scenario, where there is no DL Transmission on the same band, UL power control may not be able to rely on the presence of DL transmissions by the eNB on the same band (there could be DL cells defined on other channels, in which case the current LTE procedures are sufficient).

In this and the following sections, the UL power control for scenarios where there is no DL cell (or DL transmission by the eNB on any TDD cells) in the DSS bands is described. However, it should be understood that these scenarios also are applicable to a D2D embodiment. As a result, UL power control must be performed without a corresponding DL component carrier or cell in the same band.

2.3.1 Calculation and Consideration of the DL Path Loss for Open Loop Power Control for the Case of UE Transmission to an eNB

As mentioned in the background, power control in LTE today relies on an estimate of the DL path loss on DL component carrier to give a reliable estimate of the path loss that the UL transmission would exhibit. To address, the lack of this assumption in the context of a UL-only cell in the DSS bands, we consider solutions that use both open and closed loop power control as well as solutions which use only closed loop power control.

2.3.1.1 Using Both Open Loop and Closed Loop Power Control

The UL transmit power of a UE contains a component that is the DL path loss as computed by the UE based on the reference symbols transmitted on a reference cell (signaled by the pathLossReferenceLinking parameter in RRC). Depending on the path loss relation between the licensed and DSS bands, such a definition would be inadequate due to the differences in the path loss exhibited between the bands.

In order to account for the inter-band path loss differences, the UE applies an offset to the computed path loss in order to derive a modified path loss to be used in the calculation of the UL transmit power. As a first approach, the UE adds a frequency dependent offset to the path loss. This frequency dependent path loss can be configured by the eNB through RRC signaling and can be calculated by the UE based on the frequency offset between the cell chosen as the reference cell (assumed to be in the licensed band) and the UL cell in the DSS bands. In particular, the parameter PL_{C} used in the equations for PUSCH and PUCCH transmit power would then be given by:

[symbol]

_{C}=PL_{C}+Δ_{F}

where Δ_{F} is computed by the eNB (through known signal propagation models based on frequency) and then signaled to the UE. In the case of a simple frequency offset, this same calculation can be done by the UE based on the frequency of the reference (linking) cell and the UL cell on which the UE is to transmit.

In addition, the eNB may specify the calculation of the path loss to be based on other factors in addition to the frequency offset. If a UE previously had a connection to an eNB through an uplink-only cell in the DSS bands (whether on the same channel or on a different channel), the eNB could indicate that the UE use the path loss estimate used in that previous connection. In addition, if another UL-only cell exists at the time of creation of the new UL-only cell in the same band, the UE could use the same path loss used to calculate the UL transmit power in the existing cell.

The UE could also make use of potential knowledge of the environment to adjust the offset that is applied to the path loss. For instance, if the eNB is deployed indoors (an apartment complex), the difference in path loss between the licensed and DSS could be significantly different than the case where the eNB is deployed outdoors (due, for instance, to better penetration characteristics of signals in the UHF frequency bands).

The combination of the factors mentioned above that affect the calculation in the path loss could be accounted for by weighting (using weights w) each of the contributions of these (frequency difference between UL and DL, path loss on a previously used or other UL frequency, and environment) to yield a potential equation to calculate the path loss based on weights that would be signaled and controlled by the eNB:

[symbol]

_{C}=w₁PL_{C,DOWNLINK}+w₂Δ_{F}+w₃Δ_{E}+w₄PL_{C,UPLINK}

where
PL_{C,DOWNLINK} is the DL path loss on the reference cell in the licensed band
Δ_{F} is the expected offset in the path loss between the licensed and DSS bands due to the difference in frequency (calculated through signal propagation models)
Δ_{E} is the expected offset in the path loss due to differences in the signal penetration characteristics for the environment in which the UE operates
PL_{C,UPLINK} is the value of the path loss currently being used on another UL-only cell in the same band, or on a UL-only cell the UE had previously had a connection to

The weights in the above equation are controlled and set by the eNB and can be semi-statically configured through RRC signaling.

During measurements of the path loss made on the reference linked cell (in the licensed band), the UE may apply any changes to this path loss immediately in the path loss equation for the uplink transmit power in the DSS bands. Alternatively, if the correlation between changes in the path loss in the licensed and DSS bands is considered to be low, the eNB could force the UE to not take changes in the licensed band into account by modifying the associated weight in the above equation (w₁ in this case) so that the contribution of this component is much smaller.

2.3.1.2 Using Only Closed Loop Power Control

The eNB may consider that the estimate of the downlink path loss in the licensed band may not be a valid estimate of the path loss in the licensed band in the uplink. In this case, the UL power control may function using only closed loop power control mechanism of TPC commands. These TPC command would be sent by the eNB, or in the case of D2D communication, would be sent by the peer UE.

In such a mode of operation, the DL path loss in not considered in the calculation of the uplink transmit power, and the required transmit power required to overcome both interference and path loss is included in the received signal power PO_PUSCH,c. Details about this mode of operation are therefore considered in the sections below instead.

2.3.2 Uplink Power Control Using Only Closed-Loop Operation

In this section, we consider the UL power control procedures in the case that the UE must use only closed loop power control mechanisms. In this case, the open loop power control (specifically the downlink path loss from a reference cell or any estimates of the path loss between the peer UE's) is not available or reliable and the procedures for transmission UL-only operation will deviate considerably from the current release of LTE specifications. The sections that follow look at each of these procedure enhancements/deviations separately.

2.3.2.1 Initial Activation of a UL-Only Cell

A UE that is configured to operate on the DSS bands in UL-only operation will not have a reliable UL power initially due to the lack of a proper DL path loss (or path loss measurement from the peer UE in a D2D scenario). In one embodiment, an initial RACH procedure is triggered in UL-only operation immediately following the activation of the UL operation (which could include the use of a UL-only cell, or D2D communication). The RACH procedure may be triggered by a special PDCCH order sent on the licensed band. When this order is sent immediately following the activation of UL-only operation in the DSS bands, the UE will be aware that the order applies to the UL-only operation that was just activated.

The RACH sent initially can use a dedicated RACH resource, and, therefore, a collision resolution stage is not required in this case. Initial frequency and time synchronization will be based on the licensed band, and then be corrected using the mechanisms described in section 2.2. Also, as mentioned in that section, the RACH preamble may contain or be enhanced with an initial synchronization signal which allows the UE to perform frequency synchronization in addition to being synchronized with time.

The eNB will configure the target received power for the RACH preamble and RACH preamble power will be ramped up at each attempt of the RACH (as in LTE today) until the eNB or the peer UE replies to the RACH preamble with a RACH response (containing a timing offset, frequency adjustment command, and TPC command) or until the UE reaches the maximum transmit power allowable for the channel, as specified by the geolocation database.

In the case that it is the eNB that is expecting to receive the RACH, the eNB will wait for the RACH from the UE following a PDCCH order for a specific time window. If the RACH is not received by the eNB during that time window, the eNB will assume that the UL operation cannot be established for that particular cell based on the interference on that channel and/or the power limitations imposed on the UE on that particular channel.

In the case of D2D communication, in one embodiment, the RACH transmitted by the UE could be transmitted to the peer UE following the trigger by the eNB to initiate the D2D connection. The RACH could serve to perform both frequency and timing synchronization, as well as initial power control. In this case, the RACH response could be sent via the eNB using a sequence similar to the one in FIG. 15B. The peer UE will transmit the information relative to the RACH response on the UL link to the eNB first. The eNB will then transmit the normal RACH response to the initial UE and use the information obtained from the peer UE (power adjustment, frequency adjustment command, timing, etc) in order to create the RACH response. A high-level procedure could be described as follows:
The eNB will trigger the D2D communication by issuing a message to one UE to have it transmit a RACH. If a RACH response is not received, the UE will retransmit the RACH with an increase in power from the previous transmission;
The peer UE, upon receiving the RACH, will compute the frequency offset and any power adjustment and timing adjustment that need to be made. It will transmit this information to the eNB using UL resources such as PUCCH, PUSCH, or specialized RACH which allows the eNB to recognize this as a RACH response that needs to be relayed to the initial UE;
The eNB will take the information obtained by the peer UE and create a traditional RACH response message, which it will then send to the UE that initially transmitted the RACH preamble.

As an alternative embodiment, the UEs may already be frequency synchronized and the RACH could be used for timing and determination of the initial transmit power. In this case, the eNB or peer UE can send the RACH response directly to the UE to establish the UL-only or D2D link over the DSS bands. The RACH response would use the power level that the initial RACH used, and this initial power level could be contained within the preamble itself (whereby the chosen preamble sequence would be linked to a utilized transmit power level).

Finally, as a last embodiment, a RACH would not be used and data could also be transmitted immediately following the frequency and timing synchronization which could be achieved through the eNB using the mechanisms described in section 2.2.

In order to speed up the initial access to UL-only operation and avoid multiple RACH retransmissions, one or more of the following steps could be taken:
1) The eNB could configure power ramping values that are larger than the current values supported by the LTE standard today
2) To have a better value for the preamble initial received target power, the eNB could perform a sensing operation (similar to the sensing that is used for PU channels shown in FIGS. 9A and 9B but tailored to measure the amount of secondary user interference) to determine an estimate of the interference level from other secondary users currently using the channel.
3) The eNB could configure the initial transmit power for the RACH and potential ramping step based on knowledge of the location of the UE and measurements of interference taken from sensing or other measurements made by the UEs or the eNB. A similar approach could be used when two UEs are involved in UL-only operation.

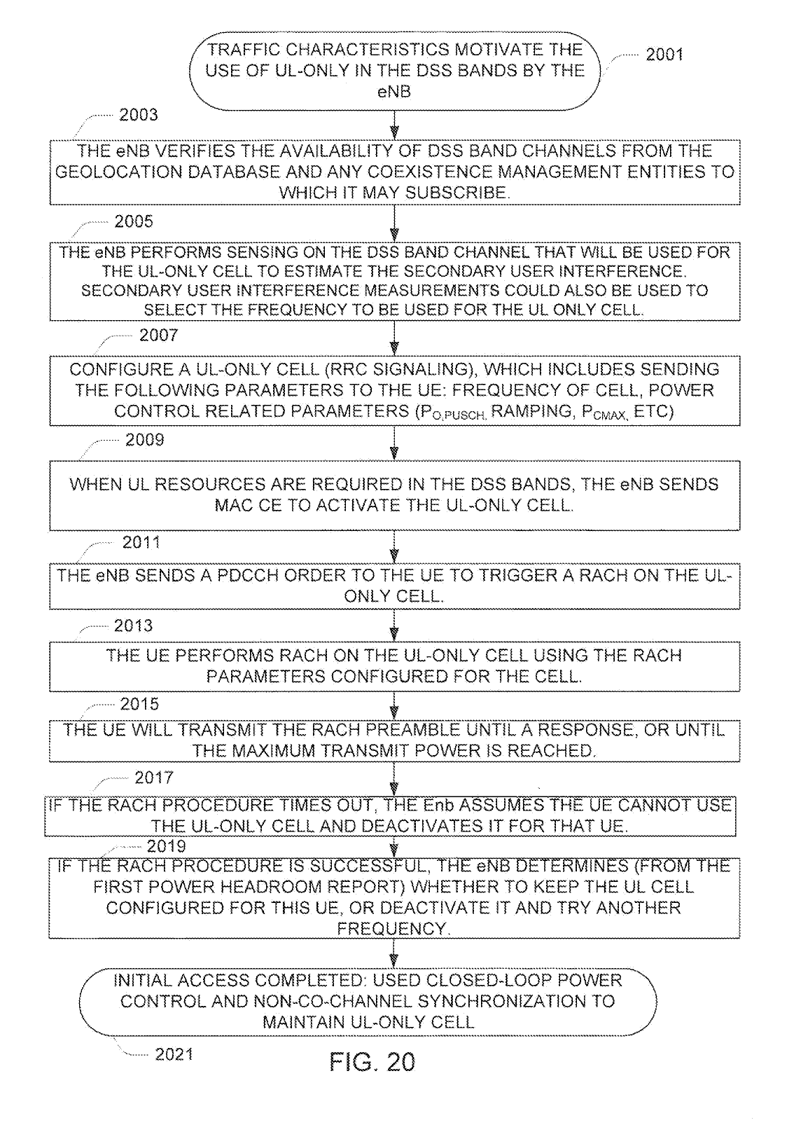

FIG. 20 shows at a high level the initial access procedure that would be required when UL-only operation is activated or triggered by the eNB, and the relationship of these steps with the UL transmit power used by the UE during and following the RACH procedure. The steps apply to either the case of transmission by a UE to an eNB in uplink, or the case of a UE establishing a D2D communication with a peer UE.

In step 2001, the eNB decides that traffic characteristics motivate the use of UL-only communications in a DSS band. Thus, the eNB verifies the availability of one or more DSS band channels from the geolocation database and any coexistence management entities to which it may subscribe (2003). Next, the eNB performs sensing on the DSS band channel(s) that will be used for the UL-only cell to estimate any secondary user interference (2005). Secondary user interference measurements also could be used to select the frequency to be used for the UL-only cell.

Assuming a channel is available, the eNB configures a UL-only cell, e.g., using RRC signalling (2007), which includes sending the UE the following parameters: frequency of cell, power control related parameters (P_{o,pusch}, ramping, P_{cmax}, etc.). When UL resources are required in the DSS band, the eNB sends a MAC CE to activate the UL-only cell (2009). The eNB also sends a PDCCH order to the UE to trigger a RACH on the UL-only cell (2011). Next, the UE performs RACH on the UL-only cell using the RACH parameters configured for the cell (2013).

The UE will then transmit the RACH preamble until a response is received or until the maximum transmit power is reached (2015). If the RACH procedure times out, the eNB assumes that the UE cannot use the UL-only cell and deactivates it for that UE (2017).

If, on the other hand, the RACH procedure is successful, the eNB determines (from the first power headroom report) whether to keep the UL-only cell configured for this UE or to deactivate it and try another frequency (2019).

At this point, the initial access completed and the eNB thereafter uses closed-loop power control and non-co-channel synchronization to maintain the UL-only cell (2021).

2.3.2.2 Invalidity of Power Control Adjustment State

Power control adjustment in the current LTE releases are based on measurement (by the eNB) of the uplink DMRS transmitted by the UE. Since a UE may not have UL transmissions for some time, and since the UE cannot rely on the open loop portion of the power control command when using only closed loop operation, the power control adjustment state of the UE may become invalid or ‘stale’ after some time. Two approaches proposed for addressing this case are discussed below. In both of these approaches, the UE will invalidate the power control adjustment state (accumulation of the TPC commands) following a period of inactivity and the uplink transmit power will be set through another mechanism, as discussed below. These mechanisms are applicable to all types of UL-only operation defined in this disclosure, including D2D communication.

2.3.2.2.1 Combined Approach of Ramping of HARQ Retransmissions and Initial RACH

We propose the use of one of the two following methods, depending on the length of time for which the UE has not transmitted anything in the UL or to the peer UE. We consider the value T1 to be a short inactivity timer, and the value T2 to be a longer inactivity time, and propose a different approach depending on whether the current value of the uplink inactivity time is larger than T1 or T2. Both T1 and T2 can be set by the eNB through RRC signaling.

If the period of time without UL transmission is longer than T1, but shorter than T2, the UE may perform a power ramping operation on a UL transmission following a grant by the eNB or known transmission timer to its peer UE. For instance, the initial transmission of a transport block can be done at the desired received target power (Po) set by the eNB, and subsequent retransmissions could then be sent with progressively higher power using a power ramping mechanism. For transmission of transport blocks following an inactivity time of T1, the maximum number of HARQ retransmissions could be set to a value that is larger than the default operation in order to allow the power ramping mechanism to properly take place.

Alternately, UL transmissions or transmissions to a peer UE immediately following the low inactivity timer could be made simultaneously on the DSS bands and on a UL carrier in the licensed band (if one is available). This embodiment would avoid the need for retransmissions, but would allow the eNB to control the transmit power on the UL-only cell through TPC commands until the correct UL transmit power is established on the DSS bands. In the case of D2D communication, the licensed band transmission would need to be forwarded to the peer UE by the eNB on the DL.

If the period of time without UL transmission is longer than T2, the eNB could precede a UL transmission with a PDCCH order for a RACH transmission destined for the eNB or the peer UE. The RACH transmission could also be issued automatically by the UE upon expiry of the timer, rather than waiting for a PDCCH order. The details for this would be similar to what was discussed in the case of initial access.

2.3.2.2.2 Use of SRS to Maintain the Power Control Adjustment State

In this case, we consider the use of the current SRS (with certain modifications described here) in order to set the value of the power control adjustment state for the PUSCH in the case the UE has not transmitted for a long period of time.

The eNB can configure an SRS for the UE that may be inactive for a period of time in UL-only operation in such a way that the SRS is sent often enough to maintain a correct power control adjustment state at the UE. Following a long period of time in which the UE has not transmitted on the UL PUSCH and once the eNB schedules a UL transmission for the UE on PUSCH, the UE can then use the power control adjustment state currently accumulated for the SRS as the power control adjustment state to be applied to the PUSCH transmission.

The power control adjustment state for the SRS can be maintained through TPC commands sent by the eNB or the peer UE in response to the SRS (the TPC commands will apply, in this case, only to the SRS). It may, however, be possible that the eNB or the peer UE does not receive the SRS if the interference or fading changes suddenly or drastically in UL-only operation. In this case, we propose to enhance the SRS with a power-ramping mechanism, whereby the UE would apply a power ramping to the SRS transmitted on the UL-only cell in the scenario where connection on the licensed band is maintained but the eNB or the peer UE does not send TPC commands related to the SRS for a long period of time. The ramping would continue on the SRS until the UE receives the TPC command for the SRS or the maximum transmit power for the UE is reached for the channel on which the UL-only cell is operating.

2.3.3 Power Headroom Reporting and Consideration of Geo-Location-Based Maximum Transmit Power

Power headroom reporting by the UE will be affected because the UE is now limited (in terms of uplink transmit power) both by the maximum transmit power configured by the eNB (as found in TS 36.101) and the maximum allowable transmit power based on the DSS band regulatory constraints imposed in the country where the LTE system is operating. While the maximum transmit power is fixed in the FCC regulatory domain (the UE only needs to know whether it is operating in a channel adjacent to a DTV broadcast, or whether it is functioning in sensing-only mode. This information is available upon connection to the database and selection of the channel.

In the case of the European regulatory framework, the UE must obtain its maximum transmit power from the database and operate based on this constraint. This results in two distinct cases.

Case 1: The UE is a Slave Device and the eNB is a Master Device

In this case, the eNB is responsible for querying the geo-location database and relating its information to the UE. In one embodiment, the eNB sends the UE the maximum transmit power for the uplink-only cell (PCMAX,C in the 3GPP specs) through signaling by the base station to the UE. In the case of a fixed eNB, this maximum transmit power will not change often and RRC signaling is sufficient to send the maximum transmit power. In addition, we propose that the maximum transmit power may also be sent through a MAC CE or PHY signaling (similar to a TPC command) in order to account for the scenario of a mobile eNB (for example, a small cell deployed on a train or subway car). In the case of a mobile eNB, the eNB will regularly consult the geo-location database and will therefore send regular updates to the UE whenever the value of PCMAX,C has changed.

Since a change in the maximum power will also generate a change in the headroom, the UE may trigger a Power Headroom Report (PHR) whenever the eNB sends a new value of the maximum power to the UE. This trigger would be added to the list of triggers of PHR that are specified in section 5.4.6 of 3GPP TS36.321, “Evolved Universal Terrestrial Radio Access (E-UTRA); Medium Access Control (MAC) protocol specification”

Case 2: The UE is a Master Device and Consults the Database Itself

In the case the UE is a master device and consults the database itself, it will control its own maximum transmit power based on the minimum of what is given by the database and what is required based on the LTE specs (36.101). In addition, the maximum power that is used by the UE in its calculation of the power headroom may be reported by the UE along with the power headroom. This maximum power can be reported with the power headroom report itself. Alternatively, it can be sent through a separate (new) MAC CE that is specific for reporting of the maximum power.

Since a change in the maximum power will also generate a change in the headroom, we propose that the UE will trigger a Power Headroom Report (PHR) whenever it learns of a change in the maximum power from the geo-location database. This trigger would be added to the list of triggers of PHR that are specified in section 5.4.6 of 3GPP TS36.321, “Evolved Universal Terrestrial Radio Access (E-UTRA); Medium Access Control (MAC) protocol specification.”

2.4 Co-Channel Synchronization Schemes

In some of the scenarios presented in section 1.6, the eNB can transmit in the downlink direction with limited power or for a small period of time. In this case, the synchronization symbol(s) can be transmitted co-channel with the uplink transmission coming from the UE. The subsections that follow describe different embodiments for this case.

2.4.1 UL-Only Operation with Periodic Downlink Sync and Coexistence Gaps

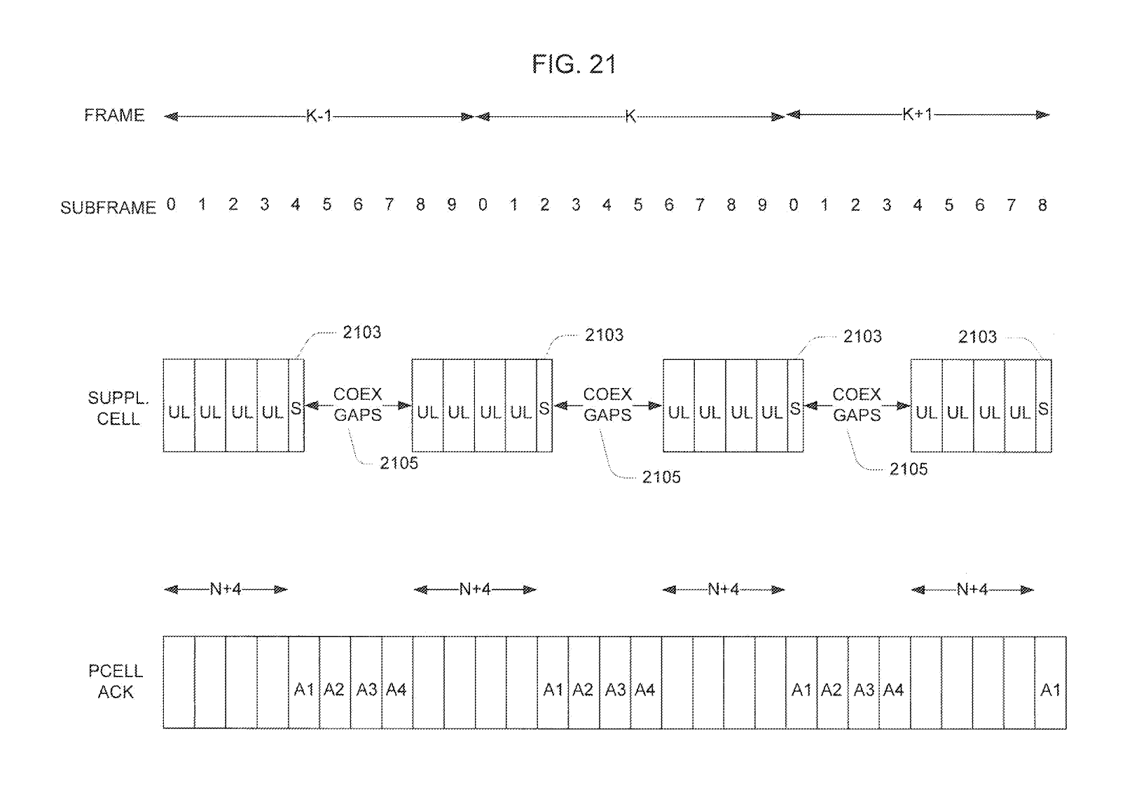

FIG. 21 provides an overview of one approach that comprises interrupting the UL-only operation in a periodic fashion to send a sync signal 2103 by the eNB that will be received and processed by the UE to initially acquire and maintain frequency synchronization. This invention can be enhanced by introducing periodic gaps 2105 after each sync channel. The figure illustrates the case where a sync signal 2103 is sent every eight subframes with a duty cycle of 50% where four subframes are used for uplink operation. More details on the sync signal are described in the following section. The duty cycle could be adjusted based on the coexistence parameters. For example, a higher duty cycle could be used if secondary user's activity is below a certain threshold and therefore using a shorter coexistence gap.

2.4.2 UL-Only Operation with Periodic Downlink Sync without Coexistence Gaps

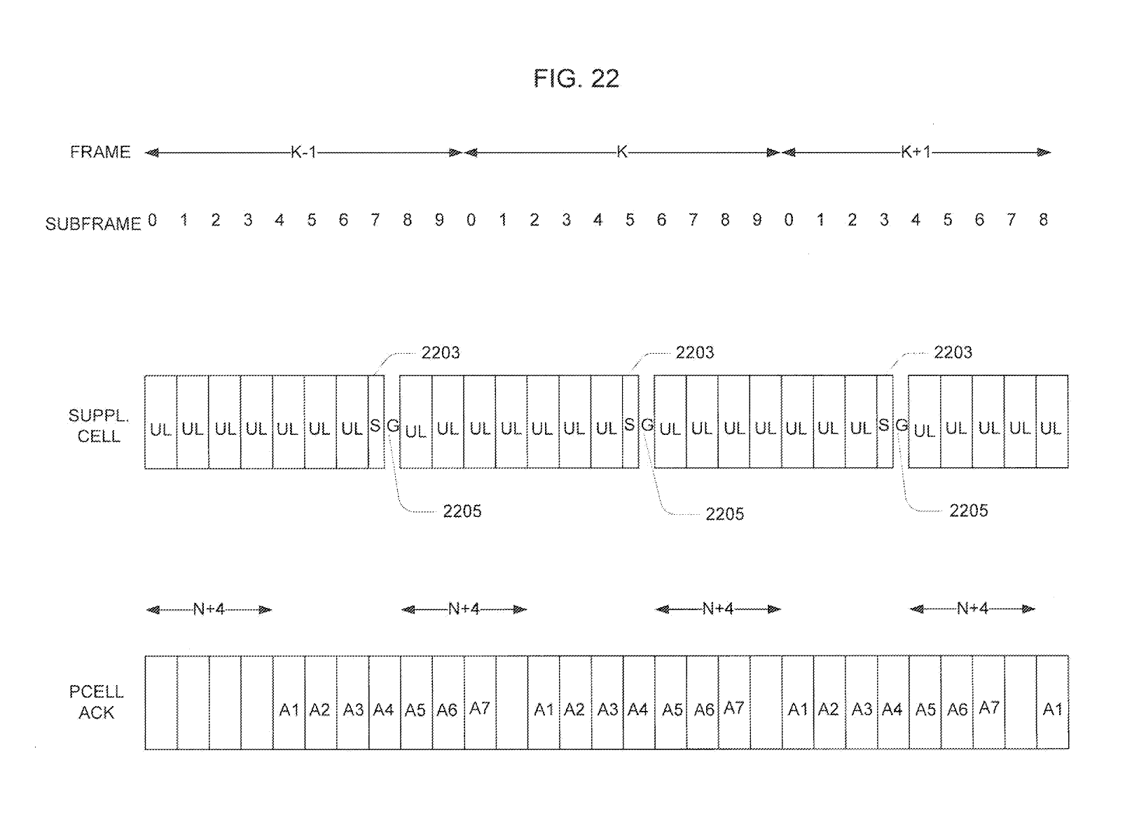

If no coexistence gaps are required, the Sync Signal 2203 could be sent followed by a small gap 2205 similar to a TDD gap and then resuming the UL operation, as illustrated in FIG. 22.

2.4.3 Sync Signal Description

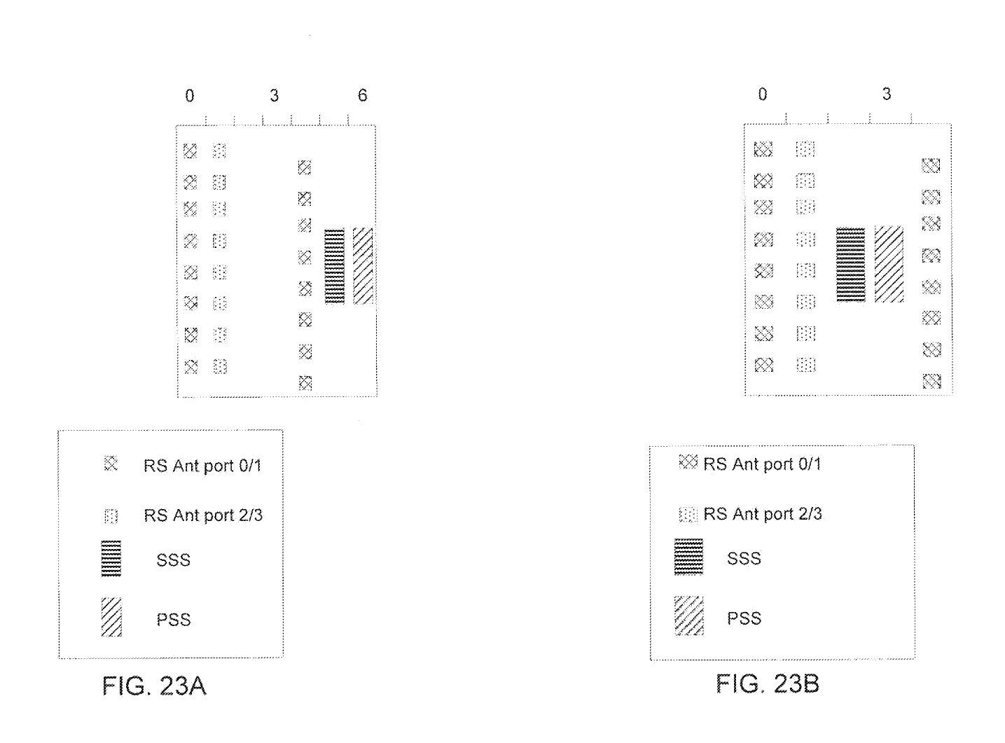

The Sync Signal would be a set of n consecutive symbols, which includes PSCH and SSCH to provide both coarse frequency synchronization and time synchronization. The set of consecutives symbols could include common Reference symbols to provide finer frequency synchronization. FIG. 23A illustrates a possible embodiment of this where a normal slot (½ ms) is used to send the Sync Signal. The remainder of the subframe (second slot in this case) could then be used for the guard period similar to what is done for UL/DL transitions in TDD, or could be part of the coexistence gap in the case where the coexistence gap is used in conjunction with the sync transmission.

Alternately, since Symbols 2 and 3 are never used for Cell specific Reference Signal, the SSS and PSS could be moved to Symbols 2 and 3, respectively, to compress the amount of time used for the Sync Signal, as illustrated in FIG. 23B.

2.4.4 Synchronization Signals in Dedicated/Reserved Subcarriers

In this scheme, we propose to send the synchronization scheme on certain specific subcarriers, which we call reserved subcarriers. In order to efficiently use the channel, the synchronization symbol(s) are sent on reserved subcarriers, and uplink transmission can continue simultaneously on the non-reserved subcarriers. In this scheme, the reserved subcarriers could be present in every OFDM symbol, in which case, the synchronization symbols and reference symbols are sent at all times. Alternately, specific known OFDM symbols in a subframe could have reserved symbols, while others could have none. The OFDM symbols without reserved subcarriers will therefore have all subcarriers available for uplink transmission.

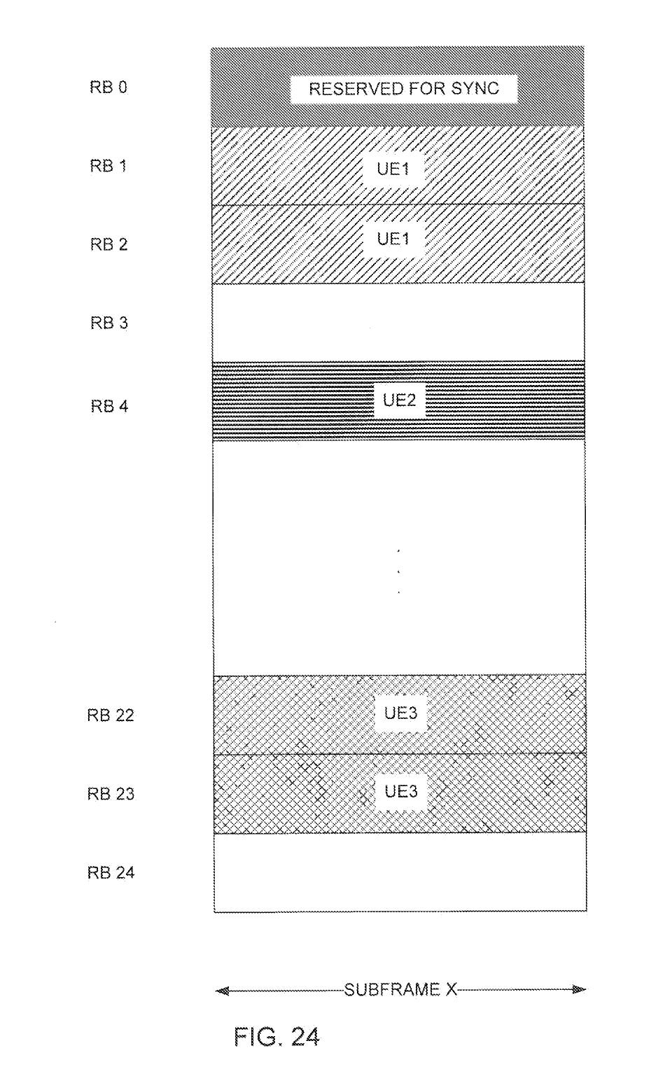

FIG. 24 illustrates the use of reserved subcarriers for sending reference and synchronization symbols. In the context of LTE, a single resource block (the resource block at the lowest frequency) is assumed to contain the reserved subcarriers, and so uplink grants cannot be made using this resource block. The reservation of a single resource block could occur every subframe, or could be limited to only specific subframes (e.g. subframe x in each frame will contain reserved subcarriers in the first resource block).

The eNB (and potentially the UEs) will be capable of simultaneous transmission and reception on the same channel. When transmitting the reference symbols, the eNB will use the reserved subcarriers and zero out all other subcarriers so that they do not interfere with the uplink transmission by the UEs. Similarly, the UEs will not utilize the reserved subcarriers when transmitting data in the uplink. Instead, they will be able to simultaneously (or during symbol times where they have no uplink grant) decode the reserved subcarriers sent by the eNB to continue frequency synchronization.

### Embodiments

In one embodiment, a method is implemented of initiating an uplink-only communication channel between a User Equipment (UE) and an LTE network comprising: an eNB determining whether a first frequency channel in an uplink-only cell is available for uplink-only communication between the eNB and at least one UE; if the first frequency channel is available for uplink-only communication, the eNB transmitting to the UE on a downlink of a frequency channel in a duplex cell a request for the UE to transmit to the eNB a Supplementary Uplink Reference Signal (SURS), the SURS request identifying the uplink-only frequency channel; responsive to receipt of the SURS request, the UE transmitting a SURS to the eNB in the first frequency channel, the SURS comprising information identifying the UE and enabling the eNB to determine whether the channel is feasible for uplink-only transmission; the eNB receiving the SURS from the at least one UE and determining if the at least one UE can operate in the first frequency channel; and commencing uplink-only communication between the at least one UE and the eNB on an uplink-only cell in the first frequency channel.

The preceding embodiment may further comprise wherein the eNB transmits the SURS request via RRC signaling.

One or more of the preceding embodiments may further comprise wherein the UE comprises a plurality of UEs.

One or more of the preceding embodiments may further comprise wherein the determining whether a first frequency channel is available for uplink-only communication comprises consulting a geo-location database.

One or more of the preceding embodiments may further comprise wherein the determining whether a first frequency channel is available for uplink-only communication comprises performing sensing of channel availability.

One or more of the preceding embodiments may further comprise the sensing of channel availability comprising: the eNB transmitting a sensing request to the UE; and, responsive to the sensing request, the UE performing sensing to determine availability of frequency channels in the uplink-only cell and transmitting sensing results to the eNB.

One or more of the preceding embodiments may further comprise the commencing of the uplink-only communication comprising: the eNB transmitting uplink-only cell configuration data to the UE; responsive to receipt of the uplink-only cell configuration data, the UE transmitting a configuration confirmation signal to the eNB; responsive to receipt of the configuration confirmation signal, the eNB transmitting an uplink grant signal to the UE; and responsive to receipt of the uplink grant signal, the UE transmitting data in the uplink-only cell.

One or more of the preceding embodiments may further comprise the (1) eNB transmitting uplink-only cell configuration data to the at least one UE, (2) the at least one UE transmitting a configuration confirmation signal to the eNB; and (3) the eNB transmitting an uplink grant signal to the at least one UE are performed in the duplex channel.

One or more of the preceding embodiments may further comprise wherein the eNB transmits the SURS request in a System Information Block (SIB).

One or more of the preceding embodiments may further comprise wherein the SURS request further indicates a transmit power for the UE to use for transmitting the SURS.

One or more of the preceding embodiments may further comprise wherein the eNB determines an initial transmit power for the UE to use to transmit the SURS from known uplink power in other bands and obtains a maximum transmit power for the UE to use to transmit the SURS from a geolocation database.

One or more of the preceding embodiments may further comprise wherein the sensing request comprises an inter-frequency (or inter-band) measurement configuration from the eNB.

One or more of the preceding embodiments may further comprise wherein the sensing request further comprises a limit to the number of channels to be searched and measured by the UE that is based on availability information in the geolocation database.

One or more of the preceding embodiments may further comprise wherein the measurement configuration contains a list or sub-band of channels on which the UE will perform measurements.

One or more of the preceding embodiments may further comprise: the at least one UE performing interfrequency measurements; and the at least one UE transmitting interfrequency measurement data to the eNB; wherein the determining by the eNB if the at least one UE can operate in the first frequency channel is based on the inter-frequency measurements received from the at least one UE.

One or more of the preceding embodiments may further comprise wherein the UE transmits the SURS in a subframe in the uplink-only channel that corresponds to a subframe on the duplex frequency channel.

One or more of the preceding embodiments may further comprise wherein the subframe corresponds to an uplink subframe in the duplex frequency channel if the duplex frequency channel is a TDD channel.

One or more of the preceding embodiments may further comprise wherein the SURS request indicates a subframe number on which the at least one UE must transmit the SURS to the eNB.

One or more of the preceding embodiments may further comprise wherein the UE transmits the SURS on a Random Access Channel (RACH) at a time based on timing in the duplex frequency channel.

One or more of the preceding embodiments may further comprise wherein the UE transmits the SURS within the RACH preamble.

One or more of the preceding embodiments may further comprise wherein SURS extends over multiple RACH occasions.

One or more of the preceding embodiments may further comprise wherein the eNB avoids scheduling of uplink data by other UEs while the at least one UE is transmitting the SURS.

One or more of the preceding embodiments may further comprise wherein the eNB temporarily disables transmission of RACH by other UEs until the at least one UE transmits its SURS.

One or more of the preceding embodiments may further comprise wherein the UE transmits the SURS after performing inter-frequency measurement during an uplink subframe in the UL-only frequency channel.

One or more of the preceding embodiments may further comprise wherein the SURS request comprises at least one of: at least one band and channel and/or raster frequency on which the UE is to transmit the SURS; a transmit power with which the UE is to transmit the SURS; timing for the transmission of the SURS by the UE; and configuration data associated with the SURS

One or more of the preceding embodiments may further comprise wherein the at least one band and channel and/or raster frequency comprises a list of multiple channels.

One or more of the preceding embodiments may further comprise wherein the UE transmits multiple SURSs to the eNB sequentially on one UL-only frequency channel.

One or more of the preceding embodiments may further comprise wherein the UE transmits each of multiple SURSs to the eNB simultaneously, each SURS transmitted on the UL-only channel corresponding to the SURS.

One or more of the preceding embodiments may further comprise wherein the configuration data associated with the SURS includes at least one of a maximum number of retransmissions of the SURS by a UE, a time interval between retransmissions, and an increment in power to be applied between retransmissions of the SURS.

One or more of the preceding embodiments may further comprise wherein the SURS request is a Medium Access Control (MAC) Control Element (CE).

One or more of the preceding embodiments may further comprise wherein the SURS comprises at least one of a transmit power, a power headroom, a UE ID, and at least one Zadoff-Chu (ZC) sequence.

One or more of the preceding embodiments may further comprise wherein each ZC sequence corresponds to a potential UE ID, transmit power/power headroom, or combination thereof.

One or more of the preceding embodiments may further comprise wherein the SURS further comprises a fixed Primary Synchronization Signal (PSS)-like signal preceding the ZC sequence.

One or more of the preceding embodiments may further comprise wherein the SURS spans less than a subframe.

One or more of the preceding embodiments may further comprise wherein, responsive to receipt of the SURS, the eNB uses the PSS-like signal to determine a coarse frequency offset for the corresponding UE.

One or more of the preceding embodiments may further comprise the eNB transmitting an uplink-only configuration message to the UE establishing the uplink-only cell.

One or more of the preceding embodiments may further comprise wherein the uplink-only configuration message comprises at least one of a frequency offset the UE should apply to its oscillator, a timing offset the UE should apply, an initial transmit power the UE should use for transmission on the UL-only cell; a cell ID associated with the uplink-only cell.

In another embodiment, a method of frequency synchronizing a UE to an eNB in an uplink-only cell of a wireless network comprises: the UE transmitting synchronization symbols to the eNB in the uplink-only cell; and, responsive to the receipt of the synchronization symbols by the eNB, the eNB transmitting frequency adjustment commands to the UE in a downlink channel of a duplex cell.

One or more of the preceding embodiments may further comprise the eNB transmitting requests for the transmission of synchronization symbols from the UE; and wherein the transmission of the synchronization symbols by the UE is performed responsive to receipt of the requests from the eNB.

One or more of the preceding embodiments may further comprise wherein the UE transmits the synchronization symbol in a Sounding Reference Signal (SRS) symbol slot of the uplink-only cell.

One or more of the preceding embodiments may further comprise wherein the synchronization symbol is transmitted periodically in a subset of the SRS symbol slots of the uplink-only cell.

One or more of the preceding embodiments may further comprise wherein the UE transmits the synchronization symbols in a Random Access Channel (RACH) and the eNB transmits the frequency adjustment commands in a Random Access response.

One or more of the preceding embodiments may further comprise wherein the UE transmits the synchronization symbols in a RACH preamble.

One or more of the preceding embodiments may further comprise: the eNB transmitting a Random Access Preamble Assignment instructing the UE to synchronize; and wherein the UE transmits the synchronization symbols to the eNB responsive to receipt of the Random Access Preamble Assignment.

One or more of the preceding embodiments may further comprise wherein the UE transmits the synchronization symbols within the data portion of uplink transmissions.

One or more of the preceding embodiments may further comprise the eNB transmitting an uplink grant signal to the at least one UE, the uplink grant signal including an instruction indicating a length of the synchronization symbol.

One or more of the preceding embodiments may further comprise wherein the frequency adjustment command is transmitted within a MAC CE.

One or more of the preceding embodiments may further comprise wherein the frequency adjustment command comprises a timing advance correction (TAC) and a frequency offset correction.

One or more of the preceding embodiments may further comprise wherein the frequency adjustment command comprises a PDDCH message.

In another embodiment, a method of effecting power control between an eNB and at least one UE in an uplink-only cell of an LTE wireless network in which the UE and the eNB also communicate in a duplex cell comprises: determining a path loss in the duplex cell; applying a frequency based offset to the determined path loss in the duplex cell as a function of the difference in frequency between the duplex cell and the uplink-only cell to generate an estimated path loss for the uplink-only cell; and adjusting transmit power of the UE as a function of the estimated path loss for the uplink-only cell.

In another embodiment, a method of effecting power control in an uplink-only cell of an LTE wireless network between a UE and an eNB in which the UE and the eNB also communicate in a duplex cell comprises: the eNB transmitting an order to the UE to initiate a RACH procedure by the UE in the uplink-only cell; responsive to the order, the UE transmitting a sequence of RACH preambles in the uplink-only channel, each RACH preamble in the sequence being transmitted with greater power than the preceding transmitted RACH preamble until the first to occur of (a) the UE receives a response to the RACH preamble from the eNB and (b) a predetermined maximum power is reached; and, responsive to receipt of a RACH preamble from the UE having a predetermined minimum target receive power, the eNB transmitting a RACH preamble response to the UE.

One or more of the preceding embodiments may further comprise wherein the order is transmitted on a downlink channel of the duplex cell.

In another embodiment, a method of effecting power control in an uplink-only cell of an LTE wireless network between a UE and an eNB in which the UE and the eNB also communicate in a duplex cell comprises: during periods when the uplink-only cell has been inactive for a predetermined period, the UE transmitting an Sounding Response Signal (SRS) to the eNB at predetermined intervals; and, responsive to receipt of an SRS from the UE during the periods when the uplink-only cell has been inactive for a predetermined period, the eNB transmitting to the UE a Transmit Power Control (TPC) command including a power control adjustment state.

One or more of the preceding embodiments may further comprise wherein the UE transmits each consecutive SRS with greater transmit power than the preceding SRS transmitted until the first to occur of (a) the UE receiving a TPC command from the eNB and (b) a predetermined maximum power being reached.

In another embodiment, a method of effecting power control in an uplink-only cell of an LTE wireless network between a UE and an eNB comprises: the UE transmitting data to the eNB in the uplink-only cell; interrupting the transmission of data by the UE in the uplink-only cell periodically; and transmitting synchronization data from the eNB to the UE during the interruptions.

One or more of the preceding embodiments may further comprise providing coexistence gaps immediately following the transmission of the synchronization data.

In another embodiment, a method of synchronizing a UE to an eNB in an uplink-only cell of an LTE wireless network between a UE and an eNB, the uplink-only cell comprising a plurality of subcarriers comprises: the UE transmitting data to the eNB on a first set of the sub-carriers in the uplink-only cell; and the eNB transmitting synchronization data to the UE in a second set of the sub-carriers in the uplink-only cell.

In another embodiment, a method of establishing device-to-device (D2D) communications between a first User Equipment (UE) and a second UE in a wireless network comprising at least one base station comprises: the base station determining to initiate D2D communications between the first UE and the second UE on an uplink-only channel; the base station transmitting on a channel of a duplex cell to each of the first and second UEs a configuration message informing the first and second UEs to transmit to the base station a synchronization signal on the uplink-only channel; responsive to the configuration messages, each UE transmitting a synchronization signal to the base station on the uplink-only channel; the base station determining a frequency offset for each of the first and second UEs based on the respective UE's synchronization signal; the base station transmitting a frequency adjustment command to each of the first and second UEs in the duplex band; and, upon attaining synchronization, the first and second UEs commencing communication with each other on the uplink-only channel.

In another embodiment, a method of establishing device-to-device (D2D) communications between a first User Equipment (UE) and a second UE in a wireless network comprising at least one base station comprises: the base station determining to initiate D2D communications between the first UE and the second UE on an uplink-only channel; the base station transmitting on a duplex channel to the first UE a configuration message informing the first UE to transmit to the base station a synchronization signal on the uplink-only channel; responsive to the configuration message from the base station, the first UE transmitting a synchronization signal; responsive to receipt of the synchronization signal transmitted by the first UE, the second UE calculating a frequency offset and a timing offset relative to the first UE based on the synchronization signal transmitted by the first UE; the second UE transmitting a first adjustment signal indicating the calculated frequency offset and timing offset relative to the first UE; the base station receiving the first adjustment signal transmitted by the second UE; responsive to receipt of the first adjustment signal from the second UE, the base station transmitting to the first UE on the duplex channel a second adjustment signal indicating the calculated frequency offset and timing offset received from the second UE in the first adjustment signal; and responsive to receipt of the second adjustment signal, the first UE adjusting its frequency and timing on the uplink-only channel.

One or more of the preceding embodiments may further comprise wherein the first UE transmits the synchronization signal to the base station on the uplink-only channel.

One or more of the preceding embodiments may further comprise the base station transmitting a message to the second UE instructing the second UE to listen on the uplink-only channel for the synchronization signal from the first UE.

One or more of the preceding embodiments may further comprise wherein the second UE periodically listens for synchronization signals from other UEs on the uplink-only frequency channel.

One or more of the preceding embodiments may further comprise wherein the second UE transmits the first adjustment signal in the duplex band.

One or more of the preceding embodiments may further comprise wherein the second UE transmits the first adjustment signal in one of (a) a Sounding Reference Signal (SRS), (b) a Random Access Channel (RACH), (c) on dedicated Physical Uplink Control Channel (PUCCH) resources, and (d) multiplexed with data intended for the base station.

One or more of the preceding embodiments may further comprise wherein the base station transmits the second adjustment signal to the first UE in the duplex band.

One or more of the preceding embodiments may further comprise wherein the base station transmits the second adjustment signal on one of (a) a Physical Downlink Control Channel (PDCCH), (b) an evolved Physical Downlink Control Channel (e-PDCCH), (c) a Medium Access Control (MAC) Control Element (CE), and (d) multiplexed with data intended for the first UE in the Physical Downlink Shared Channel (PDSCH).

In another embodiment, a method of establishing device-to-device (D2D) communications between a first User Equipment (UE) and a second UE in a wireless network comprising at least one base station comprises: the first UE transmitting a synchronization signal to the second UE; responsive to receipt of the synchronization signal from the first UE, the second UE, computing at least one of frequency offset information and timing offset information of the second UE relative to the first UE; and the second UE transmitting an adjustment signal to the first UE on the uplink-only channel, the adjustment signal comprising the frequency offset information and/or timing offset information.

One or more of the preceding embodiments may further comprise wherein the adjustment signal is transmitted using one of: resources on the Physical Uplink Shared Channel (PUSCH); a specialized Sounding Reference Signal (SRS); and multiplexed with other data on the PUSCH.

In another embodiment, a method of frequency synchronizing a User Equipment (UE) to a network in an uplink-only cell comprises a base station transmitting a frequency adjustment command to the UE using a Medium Access Control (MAC) Control Element (CE) command containing a (Logical Channel Identification (LCID) value.

One or more of the preceding embodiments may further comprise wherein the MAC CE command is an octet message representing an adjustment step in Hertz.

One or more of the preceding embodiments may further comprise wherein the frequency adjustment is represented by the binary value of the octet in hertz minus 127 Hertz.

One or more of the preceding embodiments may further comprise wherein the MAC CE command comprises first and second octets wherein the first octet is an adjustment value in hertz and the second octet is a scaling factor.

In another embodiment, a method of frequency synchronizing a User Equipment (UE) to a network in an uplink-only cell comprises a base station transmitting a frequency adjustment command to the UE in a grant used for uplink carriers comprising DCI format 0 or 4 including a Frequency Shift Control field ordering the UE to increase or decrease its operating frequency a fixed amount.

One or more of the preceding embodiments may further comprise wherein the shift is scaled through semi-static configuration Radio Resource Control (RRC).

In another embodiment, a method of frequency synchronizing a User Equipment (UE) to a network in an uplink-only cell, the method comprising a base station transmitting a frequency adjustment command to the UE in a Physical Downlink Control channel (PDCCH).

One or more of the preceding embodiments may further comprise wherein the PDCCH contains a field indicating that a data allocation will contain a special field for a frequency adjustment to be applied by the UE.

One or more of the preceding embodiments may further comprise wherein the PDDCH contains a Frequency Shift Control field within the data allocation containing a frequency shift value.

One or more of the preceding embodiments may further comprise wherein the frequency shift value is scaled through semi-static Radio Resource Control (RRC) configuration.

One or more of the preceding embodiments may further comprise wherein the frequency shift value is a binary two's complement representation of the frequency shift value.

In another embodiment, a method of frequency synchronizing a User Equipment (UE) to at least one of an eNB or another UE in an uplink-only cell of a wireless network comprises: the UE transmitting a synchronization sequence in the uplink-only cell; responsive to receipt of the synchronization sequence, the at least one of an eNB and another UE determining a frequency offset of the UE relative to its a local frequency reference; and the at least one of an eNB and another UE transmitting to the UE frequency adjustment commands that are based on the determined frequency offset.

One or more of the preceding embodiments may further comprise wherein the at least one of an eNB and another UE is an eNB and the frequency adjustment command is transmitted on a downlink channel of a duplex cell.

One or more of the preceding embodiments may further comprise wherein the UE transmits the synchronization sequence on a periodic basis after uplink-only communication is established.

One or more of the preceding embodiments may further comprise wherein the synchronization sequence comprises a Zadoff-Chu (ZC) sequence.

One or more of the preceding embodiments may further comprise wherein the at least one of an eNB and another UE is an eNB, and the method further comprises: the eNB transmitting requests for the transmission of the synchronization sequence from the UE; and wherein the transmission of the synchronization sequence by the UE is performed responsive to receipt of the requests from the eNB.

One or more of the preceding embodiments may further comprise wherein the UE transmits the synchronization sequence in a Sounding Reference Signal (SRS) symbol slot of the uplink-only cell.

One or more of the preceding embodiments may further comprise wherein the UE transmits the synchronization sequence periodically in a subset of the SRS symbol slots of the uplink-only cell.

One or more of the preceding embodiments may further comprise wherein the at least one of an eNB and another UE is an eNB, wherein the UE transmits the synchronization sequence in a Random Access Channel (RACH) and the eNB transmits the frequency adjustment commands in a Random Access response.

One or more of the preceding embodiments may further comprise wherein the UE transmits the synchronization sequence in a RACH preamble.

One or more of the preceding embodiments may further comprise: the eNB transmitting a Random Access Preamble Assignment instructing the UE to synchronize; and wherein the UE transmits the synchronization symbols to the eNB responsive to receipt of the Random Access Preamble Assignment.

One or more of the preceding embodiments may further comprise wherein the UE transmits the synchronization symbols within the data portion of uplink transmissions.

One or more of the preceding embodiments may further comprise wherein the at least one of an eNB and another UE transmits the frequency adjustment command within a MAC CE.

One or more of the preceding embodiments may further comprise wherein the frequency adjustment command comprises a timing advance correction (TAC) and a frequency offset correction.

One or more of the preceding embodiments may further comprise wherein the frequency adjustment command comprises a PDDCH message.

In another embodiment, a method of effecting power control of a User Equipment (UE) for communication between the UE and at least one of an eNB and another UE in an uplink-only cell of an LTE wireless network comprises: the User Equipment (UE) transmitting a Random Access CHannel (RACH) signal including data indicating the power level with which the RACH signal is transmitted; and the at least one of an eNB and another UE transmitting a RACH response inresponse to the RACH signal, the RACH response being transmitted at the power level indicated in the RACH signal.

In another embodiment, a method of effecting power control of a first User Equipment (UE) for communication between the first UE and a second UE in an uplink-only cell of an LTE wireless network comprises: the first User Equipment (UE) transmitting data including an indication of the power level with which the data is transmitted; and the second UE transmitting an ACK/NACK in response to the data, the ACK/NACK being transmitted at the power level indicated in the data.

### 3. CONCLUSION

The contents of the following 3GPP standards publications each are incorporated herein fully by reference:
[1] FCC 10-174: Second Memorandum Opinion and Order, 2010.
[2] CEPT: ECC Report 159—Technical and Operation Requirements for the Possible Operation of Cognitive Radio Systems in the ‘White Spaces’ of the Frequency Band 470-790 MHz.
[3] U.S. Patent Application No. 61/560,571
[4] ETSI RRS TR 102 907: Use Cases for Operation in White Space Frequency Bands (January 2011)
[5] U.S. Patent Application No. 61/373,706
[6] 3GPP TS 36.133: “Evolved Universal Terrestrial Radio Access (E-UTRA); Requirements for support of radio resource management”.
[7] 3GPP TR 36.213: “Evolved Universal Terrestrial Radio Access (E-UTRA); Physical Layer Procedures”.
[8] 3GPP TS 36.101: “Evolved Universal Terrestrial Radio Access (E-UTRA); User Equipment (UE) radio transmission and reception”.
[9] 3GPP TS 36.331: “Evolved Universal Terrestrial Radio Access (E-UTRA); Radio Resource Control (RRC); Protocol specification”.
[10] 3GPP TS36.321, “Evolved Universal Terrestrial Radio Access (E-UTRA); Medium Access Control (MAC) protocol specification”
[11] Erik Dahlman et al. “3G Evolution: HSPA and LTE for Mobile Broadband”.

Throughout the disclosure, one of skill understands that certain representative embodiments may be used in the alternative or in combination with other representative embodiments.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WRTU, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits.

The data bits may also be maintained on a computer readable medium including magnetic disks, optical disks, and any other volatile (e.g., Random Access Memory (“RAM”)) or non-volatile (“e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Further, as used herein, the term “set” is intended to include any number of items, including zero. Further, as used herein, the term “number” is intended to include any number, including zero.

Moreover, the claims should not be read as limited to the described order or elements unless stated to that effect. In addition, use of the term “means” in any claim is intended to invoke 35 U.S.C. §112, ¶ 6, and any claim without the word “means” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

A processor in association with software may be used to implement a radio frequency transceiver for use in a wireless transmit receive unit (WRTU), user equipment (UE), terminal, base station, Mobility Management Entity (MME) or Evolved Packet Core (EPC), or any host computer. The WRTU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

1. A method of frequency synchronizing a User Equipment (UE) to at least one of an eNB or another UE in of a wireless network, the method comprising:
the UE transmitting a synchronization sequence;
responsive to receipt of the synchronization sequence, the at least one of an eNB and another UE determining a frequency offset of the UE relative to a local frequency reference; and
the at least one of an eNB and another UE transmitting to the UE frequency adjustment commands that are based on the determined frequency offset.

2. The method of claim 1 wherein the frequency adjustment command is sent on a different band, channel, or connection than the synchronization sequence.

3. The method of claim 1 wherein the at least one of an eNB and another UE is an eNB and the frequency adjustment command is transmitted on a downlink channel of a duplex cell.

4. The method of claim 3 wherein the UE transmits the synchronization sequence on a periodic basis after uplink-only communication is established.

5. The method of claim 1 wherein the at least one of an eNB and another UE is an eNB, the method further comprising:
the eNB transmitting requests for the transmission of the synchronization sequence from the UE; and
wherein the transmission of the synchronization sequence by the UE is performed responsive to receipt of the requests from the eNB.

6. The method of claim 1 wherein the UE transmits the synchronization sequence in a Sounding Reference Signal (SRS) symbol slot of the uplink-only cell.

7. The method of claim 1 wherein the at least one of an eNB and another UE is an eNB, wherein the UE transmits the synchronization sequence in a Random Access Channel (RACH) and the eNB transmits the frequency adjustment commands in a Random Access response.

8. The method of claim 1 wherein the UE transmits the synchronization sequence in a RACH preamble.

9. The method of claim 8 further comprising:
the eNB transmitting a Random Access Preamble Assignment instructing the UE to synchronize; and
wherein the UE transmits the synchronization symbols to the eNB responsive to receipt of the Random Access Preamble Assignment.

10. The method of claim 1 wherein the UE transmits the synchronization symbols within the data portion of uplink transmissions.

11. The method of claim 1 wherein the at least one of an eNB and another UE transmits the frequency adjustment command within a MAC CE.

12. The method of claim 1 wherein the frequency adjustment command comprises a PDDCH message.

13. A method of initiating an uplink-only communication channel between a User Equipment (UE) and an LTE network, the method comprising:
an eNB determining whether a first frequency channel in an uplink-only cell is available for uplink-only communication between the eNB and at least one UE;
if the first frequency channel is available for uplink-only communication, the eNB transmitting to the UE on a downlink of a frequency channel in a duplex cell a request for the UE to transmit to the eNB a Supplementary Uplink Reference Signal (SURS), the SURS request identifying the uplink-only frequency channel;
responsive to receipt of the SURS request, the UE transmitting a SURS to the eNB in the first frequency channel, the SURS comprising information identifying the UE and enabling the eNB to determine whether the channel is feasible for uplink-only transmission;
the eNB receiving the SURS from the at least one UE and determining if the at least one UE can operate in the first frequency channel; and
commencing uplink-only communication between the at least one UE and the eNB on an uplink-only cell in the first frequency channel.

14. The method of claim 13 wherein the eNB transmits the SURS request via RRC signaling.

15. The method of claim 13 wherein the determining whether a first frequency channel is available for uplink-only communication comprises consulting a geo-location database.

16. The method of claim 13 wherein the determining whether a first frequency channel is available for uplink-only communication comprises performing sensing of channel availability.

17. The method of claim 13 wherein the commencing uplink-only communication comprises:
the eNB transmitting uplink-only cell configuration data to the UE;
responsive to receipt of the uplink-only cell configuration data, the UE transmitting a configuration confirmation signal to the eNB;
responsive to receipt of the configuration confirmation signal, the eNB transmitting an uplink grant signal to the UE; and
responsive to receipt of the uplink grant signal, the UE transmitting data in the uplink-only cell.

18. The method of claim 13 wherein the eNB transmits the SURS request in a System Information Block (SIB).

19. The method of claim 18 wherein the SURS request further indicates a transmit power for the UE to use for transmitting the SURS.

20. The method of claim 19 wherein the eNB determines an initial transmit power for the UE to use to transmit the SURS from known uplink power in other bands and obtains a maximum transmit power for the UE to use to transmit the SURS from a geolocation database.

21. The method of claim 20 wherein the sensing request comprises an inter-frequency (or inter-band) measurement configuration from the eNB.

22. The method of claim 21 wherein the sensing request further comprises a limit to the number of channels to be searched and measured by the UE that is based on availability information in the geolocation database.

23. The method of claim 22 wherein the measurement configuration contains a list or sub-band of channels on which the UE will perform measurements.

24. The method of claim 16 further comprising:
the at least one UE performing interfrequency measurements; and
the at least one UE transmitting interfrequency measurement data to the eNB;
wherein the determining by the eNB if the at least one UE can operate in the first frequency channel is based on the inter-frequency measurements received from the at least one UE.

25. The method of claim 17 wherein the UE transmits the SURS in a subframe in the uplink-only channel that corresponds to a subframe on the duplex frequency channel.

26. The method of claim 25 wherein the subframe corresponds to an uplink subframe in the duplex frequency channel if the duplex frequency channel is a TDD channel.

27. The method of claim 25 wherein the SURS request indicates a subframe number on which the at least one UE must transmit the SURS to the eNB.

28. The method of claim 13 wherein the UE transmits the SURS on a Random Access Channel (RACH) at a time based on timing in the duplex frequency channel.

29. The method of claim 25 wherein the UE transmits the SURS within the RACH preamble.

30. The method of claim 28 wherein SURS extends over multiple RACH occasions.

31. The method of claim 24 wherein the UE transmits the SURS after performing inter-frequency measurement during an uplink subframe in the UL-only frequency channel.

32. The method of claim 13 wherein the SURS request comprises at least one of:
at least one band and channel and/or raster frequency on which the UE is to transmit the SURS;
a transmit power with which the UE is to transmit the SURS;
timing for the transmission of the SURS by the UE; and
configuration data associated with the SURS

33. The method of claim 32 wherein the UE transmits multiple SURSs to the eNB sequentially on one UL-only frequency channel.

34. The method of claim 33 wherein the configuration data associated with the SURS includes at least one of a maximum number of retransmissions of the SURS by a UE, a time interval between retransmissions, and an increment in power to be applied between retransmissions of the SURS.

35. The method of claim 13 wherein the SURS request is a Medium Access Control (MAC) Control Element (CE).

36. The method of claim 13 wherein the SURS comprises at least one of a transmit power, a power headroom, a UE ID, at least one Zadoff-Chu (ZC) sequence.

37. The method of claim 36 wherein each ZC sequence corresponds to a potential UE ID, transmit power/power headroom, or combination thereof.

38. The method of claim 37 wherein the SURS further comprises a fixed Primary Synchronization Signal (PSS)-like signal preceding the ZC sequence.

39. The method of claim 13 further comprising:
the eNB transmitting an uplink-only configuration message to the UE establishing the uplink-only cell.

40. The method of claim 39 wherein the uplink-only configuration message comprises at least one of a frequency offset the UE should apply to its oscillator, a timing offset the UE should apply, an initial transmit power the UE should use for transmission on the UL-only cell; a cell ID associated with the uplink-only cell.

41. A method of establishing device-to-device (D2D) communications between a first User Equipment (UE) and a second UE in a wireless network comprising at least one base station, the method comprising:
the base station determining to initiate D2D communications between the first UE and the second UE on an uplink-only channel;
the base station transmitting on a duplex channel to the first UE a configuration message informing the first UE to transmit to the base station a synchronization signal on the uplink-only channel;
responsive to the configuration message from the base station, the first UE transmitting a synchronization signal;
responsive to receipt of the synchronization signal transmitted by the first UE, the second UE calculating a frequency offset and a timing offset relative to the first UE based on the synchronization signal transmitted by the first UE;
the second UE transmitting a first adjustment signal indicating the calculated frequency offset and timing offset relative to the first UE;
the base station receiving the first adjustment signal transmitted by the second UE;
responsive to receipt of the first adjustment signal from the second UE, the base station transmitting to the first UE on the duplex channel a second adjustment signal indicating the calculated frequency offset and timing offset received from the second UE in the first adjustment signal;
responsive to receipt of the second adjustment signal, the first UE adjusting its frequency and timing on the uplink-only channel.

42. The method of claim 41 further comprising:
the base station transmitting a message to the second UE instructing the second UE to listen on the uplink-only channel for the synchronization signal from the first UE.

43. The method of claim 42 wherein the second UE periodically listens for synchronization signals from other UEs on the uplink-only frequency channel.

44. The method of claim 43 wherein the second UE transmits the first adjustment signal in one of (a) a Sounding Reference Signal (SRS), (b) a Random Access Channel (RACH), (c) on dedicated Physical Uplink Control Channel (PUCCH) resources, and (d) multiplexed with data intended for the base station.

45. The method of claim 44 wherein the base station transmits the second adjustment signal on one of (a) a Physical Downlink Control Channel (PDCCH), (b) an evolved Physical Downlink Control Channel (e-PDCCH), (c) a Medium Access Control (MAC) Control Element (CE), and (d) multiplexed with data intended for the first UE in the Physical Downlink Shared Channel (PDSCH).
